(19) United States
(12) Patent Application Publication
(10) Pub. No.: US 2017/0242663 A1
(43) Pub. Date: Aug. 24, 2017

(54) SOFTWARE MODEL STABILITY METRICS

(71) Applicant: KING FAHD UNIVERSITY OF PETROLEUM AND MINERALS, Dhahran (SA)

(72) Inventors: Amjad Abu Hassan, Dhahran (SA); Mohammad Rabah Alshayeb, Dhahran (SA)

(73) Assignee: KING FAHD UNIVERSITY OF PETROLEUM AND MINERALS, Dhahran (SA)

(21) Appl. No.: 15/052,324

(22) Filed: Feb. 24, 2016

(51) Int. Cl. G06F 9/44

(52) U.S. Cl. CPC G06F 8/10

(57) ABSTRACT

Methods and computing devices are described for computing a structural model stability metric, a functional model stability metric, and a behavioral model stability metric. A first state of a diagram having a first plurality of actors or participants and a second state of the diagram having a second plurality of actors or participants are obtained. One or more properties for the first state and the second state are identified. A transformation is tracked in the properties from the first state to the second state. The stability metric is calculated for the second state as a ratio of a percentage of unchanged properties from the first state to the second state to a total number of the first plurality of actors or participants in the first state of the diagram.

### BACKGROUND

Software metrics are units of measurements that are useful for measuring quality, performance, debugging, management, and estimating costs. See W. Li, “Software product metrics,” Potentials, IEEE, vol. 18, pp. 24-27, 1999, incorporated herein by reference in its entirety. The collected measurements give an overview about the software project, and show a clear image about the current situations, which help in making quantitative/qualitative decisions during the software lifecycle.

Software systems are becoming more and more sophisticated. Writing newer versions has become complex due to stakeholders' changing demands, thus the maintainability is essential as it is a costly process. ISO 9126 characterizes maintainability with four sub-characteristics, one of which is stability.

Mitigating the evolved changes is very important for software developers in order to stabilize a system and preserve its design. Therefore, the need of stability measurements is very important. Many software metrics have been proposed to cover this area. Most of these metrics have been introduced to assess the stability at the code level. However, little research has been done to measure stability at the models level.

There are three diagrams that represent views of UML diagrams, which include a class diagram that represents a structural view, a sequence diagram that represents a behavioral view, and a use-case diagram that represents a functional view. See OMG, “OMG Unified Modeling Language™ (OMG UML), Superstructure,” ed., incorporated herein by reference in its entirety.

Stability in software development gives an overall assessment of a software system. ISO 9126 defines many quality characteristics and sub-characteristics that need a large number of metrics to cover these attributes. Six characteristics of ISO 912 include functionality, reliability, usability, efficiency, maintainability, and portability. Maintainability includes five sub-characteristics of analyzability, changeability, stability, testability, and maintainability compliance.

Maintenance emerged from a volatility of requirements and an increasing change in demands from customers and stockholders; which affects a software system. Development needs to keep up with requirement changes, as well as other implementation issues, such as technologies and different platforms. The software should be designed to accommodate these changes.

Stability is defined by Daskalantonakis as “a method of quantitatively determining the extent to which a software process, product, or project possesses a certain attribute”. See M. K. Daskalantonakis, “A practical view of software measurement and implementation experiences within Motorola,” Software Engineering, IEEE Transactions on, vol. 18, pp. 998-1010, 1992., incorporated herein by reference in its entirety. Azuma et al. define the metric as “a quantitative scale and method which can be used to determine the value a feature takes for a specific software product”. See M. Azuma, T. Komiyama, T. Miyake, S. Sakurai, A. Yamada, and T. Yonezawa, “Panel: the model and metrics for software quality evaluation report of the Japanese National Working Group,” in Computer Software and Applications Conference, 1990. COMPSAC 90. Proceedings., Fourteenth Annual International, 1990, pp. 64-69., incorporated herein by reference in its entirety.

Stability plays a major role in indicating and evaluating a maintenance process, its effort, and its cost. Unstable software can lead to high cost and effort of maintenance, user dissatisfaction, poor deliverables quality, and other issues.

Measuring stability, especially at the design level, provides an early estimation of the project. An early judgment about the software status and the next move towards enhancing performance, the development process, and mitigating the changes can be made.

Unified Modeling language (UML) is a standard notation for a modeling language. UML enables developers to visualize software systems artifacts. An objective of UML is to provide a standard way to visualize a system design. It was introduced in the early nineties by Grady Booch, Ivar Jacobson, and James Rumbaugh. In 1997, the Object Management Group (OMG) adopted UML as an object-oriented design and analysis language.

Since OMG developed and enhanced UML, many versions have been released. The latest version is UML 2.5, which is still under construction. Therefore, UML 2.0 has become the current standard industry modeling language.

The Object Management Group (OMG) defines UML as a graphical language for visualizing, specifying, constructing, and documenting the artifacts of a software-intensive system.” See OMG, “UML 2.0,” Object Management Group, 2005, incorporated herein by reference in its entirety. UML can be used to represent a structural, functional, and behavioral view of a system. Each view can be represented by different UML diagrams, as illustrated in FIG. 1.

Structural diagrams describe the static aspects of a system. They are frequently used in documenting the software architecture of software systems. Objects and classes are the basic building elements in an object-oriented design. These elements represent the system concepts, which include abstract and implementation concepts. The structural view has different diagrams used to capture the physical organization of the system elements.

UML structural diagrams include:
Class Diagram.
Package Diagram.
Deployment Diagram.
Component Diagram.
Composite Structure Diagram.
Object Diagram.
Profile Diagram.

Behavioral diagrams describe the behavior, dynamic features, and methods of the modelled structural objects of a system. UML behavioral diagrams include:
Sequence Diagram.
Timing Diagram.
State Machine Diagram.
Communication Diagram.
Interaction Overview Diagram.

Functional diagrams describe a system from a user's perspective. They show how the system is supposed to work by describing the system functionality from the user's perspective. Functional diagrams include:
Use-case Diagram.
Activity Diagram.

Class diagrams are a popular type of UML diagram. They are used to capture the static relationships of the object-oriented systems and represent its structural view. A class diagram includes a set of classes that represent the core of an object-oriented system. It also includes different types of relationships used to connect classes together.

A class diagram includes classes and relationships between these classes. Each class and relationship has its own properties and types. Classes are identified by name and have an access level, a set of variables, and methods. Variables have a name, access level, and data type. Methods have a name, access level, return type, and parameters, which also have their own properties. The relationship types include dependency, aggregation, composition, inheritance, realization, and association.

Class diagrams include a set of objects that share attributes and methods. Classes are represented by a rectangle that has three parts. The first part has the class name. The second part has the attributes, their names, visibility, and data types. The third part has the operations, their names, signature, visibility, and return type.

Relationships allow classes to interact. There are different types of relationships with different purposes and strengths. A strength pertains to the level of dependency on one of two classes involved in the relationship. There are six types of relationships, as illustrated in FIG. 2.

Dependency Relationship
Dependency between two classes, represented by a dotted line arrow declares that one class (target class) depends upon another class (source class). The relationship means that the target class needs information from the source class.

Association Relationship
An association between two classes, represented by a solid line, declares that objects of each class depend upon the objects of the other class. Association means that a class will actually contain a reference to an object or objects of the other class in the form of an attribute.

Aggregation Relationship
Aggregation between two classes, represented by an empty diamond, declares that one class (a whole class—a class with the diamond edge) is an aggregate of the other class (partial class) objects. Aggregation is a stronger version of association, thus it is a one-way association.

Composition Relationship
Composition between two classes, represented by a filled diamond, declares one class (whole-a class with the diamond edge) is composing the other class (part) objects. Composition is a stronger version of aggregation. In this relationship, the part class lifetime depends on the whole class lifetime.

Inheritance Relationship
Inheritance or generalization is a relationship between a class (super) and a subclass. In this relationship, the subclass inherits the parent class structure. Inheritance between two classes, represented by an empty triangle arrowhead, means that one class is a type of another class.

Realization Relationship
Realization between two classes, represented by a black triangle arrowhead, means that one class realizes another class.

Use-case diagrams represent a system's functionality and are used to model a functional requirement. Use case was introduced by Jacobson and later added to the UML group by OMG. See I. Jacobson, M. Christerson, P. Jonsson, and G. Overgaard, “Object-oriented software engineering: a use case driven approach,” 1992, incorporated herein by reference in its entirety. They describe the system's requirements from the user's point of view, by identifying the system deliverables to the users. See D. Pilone and N. Pitman, UML 2.0: in a nutshell. US: O'Reilly, 2005, incorporated herein by reference in its entirety. Use-case diagrams primarily include the use cases that represent the functionality and the actors who invoke these functionalities.

Use cases are used to describe a specific object-oriented system functionality. The use case name itself is used as a description of functionality. There are two ways to represent use cases in UML. One way is by using an oval, and the other way is by using a classifier notation.

An actor initiates a use case. Actors have different ways of being drawn. One way uses a stick-man figure. A classifier notation can also be used to represent the actor. The actor can have relationships with another actor or with use cases.

A system's boundaries are used to contain all system functionality (use cases). Anything else can be modeled out of the system as an actor. The boundaries are represented by a simple rectangle.

Relationships allow use cases to interact. Three primary relationships are illustrated in FIG. 3 and include:

Use-Case Generalization
A use-case generalization is similar to inheritance in class diagrams. It can be used to describe high level functionality.

Use-Case Inclusion
A use-case inclusion is used to share functionality by grouping several use cases to include a common one. However, this general use case is not complete on its own.

Use-Case Extension

A use-case extension is used to insert a further functionality to the base-use case if conditions are met. In this case, the original use case has to be complete on its own. Usually, the extending use case has a smaller scope.

Sequence diagrams are graphical representations of the control flow. They are particularly useful for describing executions that involve several classes. A sequence diagram is used to capture order of interactions between different system parts and describes which interaction will occur if a particular event is triggered. It also shows different information about the system interactions. A sequence diagram is made up of a collection of participants, lifelines, and messages.

Each participant has a corresponding lifeline, illustrated by a solid vertical line. The lifeline indicates the classifier location in the sequence. From FIG. 4, A represents a sequence participant.

A lifeline illustrates the time of the interactions order in the sequence diagram. Time starts at the top of the sequence diagram and progresses down in the sequence diagram.

Messages are the building blocks of the sequence diagram. They represent the interaction points. The interaction happens when a participant sends a message to another participant. Messages are expressed as an arrow from the Message Caller to the Message Receiver. They have no specific direction and they can be right to left, left to right, or from and to the same Message Caller.

Notes are used to describe the diagrams and hold some information about them, such as local variables' names, the values, and can state invariant information.

A sequence diagram has five types illustrated in FIG. 4, which include:

Synchronous Messages
A synchronous message is used in a waiting case when the Message Caller waits for the return values after the invocation of the Message Receiver. This can be implemented in the code as a simple method invocation.

Asynchronous Messages
When an asynchronous message is invoked, the Message Caller does not wait for the message invocation to return. It moves on with the rest of the interaction's steps. This means that the Message Caller will invoke a message on the Message Receiver and the Message Caller will be busy invoking further messages before the original message returns. It can be named as a “fire and forget” message.

Return Messages
A return message is an optional piece of notation that can be used at the end of an activation bar to show that the control flow of the activation returns to the participant that passed the original message.

A Participant Creation Message & a Participant Destruction Message
Participants do not necessarily live for the entire duration of a sequence diagram's interaction. Participants can be created and destroyed according to the messages that are being passed.

A description on software stability and similarity at the design and code levels is given herein. It highlights metrics that are used to evaluate software stability and the techniques used to assess software similarity. The stability metrics are distributed on three levels of architecture, class, and system.

Sethi et al. devised a metrics suite to measure software modularity and stability at the architecture level. The new metrics suite takes into consideration the environmental conditions. See K. Sethi, Y. Cai, S. Wong, A. Garcia, and C. Sant'Anna, “From retrospect to prospect: Assessing modularity and stability from software architecture,” in Joint Working IEEE/IFIP Conference on Software Architecture, 2009 European Conference on Software Architecture. WICSA/ECSA 2009, 2009, pp. 269-272.

Sethi et al. proposed the Decision Volatility metric to assess decisions that may be affected by the environmental conditions (Envr Impact). The metric's value indicates the amount of change on the software, wherein more changes lead to more impact on the stability.

Molesini et al. analyzed the influence of an aspect-oriented composition mechanism on a module's architectural stability. See A. Molesini, A. Garcia, C. von Flach Garcia Chavez, and T. V. Batista, “Stability assessment of aspect-oriented software architectures: A quantitative study,” Journal of Systems and Software, vol. 83, pp. 711-722, 2010/05//2010, incorporated herein by reference in its entirety. The authors investigated the extent to which an aspect-oriented architecture is stable and when a change occurs. They found that Aspect-Oriented (AO) architecture is more stable when a change targeted a cross-cutting concern. They used a conventional set of metrics to quantify change propagation in AO architecture. These metrics depend on collecting a number of components that had been added or changed, the connectors that had been added or changed, and the number of point cuts that had been added or changed.

Tonu et al. introduced an architectural stability approach. See A. Molesini, A. Garcia, C. von Flach Garcia Chavez, and T. V. Batista, “Stability assessment of aspect-oriented software architectures: A quantitative study,” Journal of Systems and Software, vol. 83, pp. 711-722, 2010/05//2010, incorporated herein by reference in its entirety. This approach makes use of metrics and combines retrospective and predictive evaluation. The retrospective approach evaluates architectural perspectives of stability by analyzing the successive releases of a software system. Predictive evaluation checks the potential changes. The metric-based approach has been used to make a late evaluation by extracting the architecture from the source code first, followed by applying retrospective and predictive analyses.

Jazayeri evaluated structural stability using retrospective analysis. See M. Jazayeri, “On Architectural Stability and Evolution,” in Reliable Software Technologies—Ada-Europe 2002, J. Blieberger and A. Strohmeier, Eds., ed: Springer Berlin Heidelberg, 2002, pp. 13-23, incorporated herein by reference in its entirety. Three kinds of retrospective analysis are applied: 1) an analysis using basic measurements, such as the number of modules changed, module size . . . etc., 2) an analysis indicating the coupling among system modules, and 3) an analysis by mapping out system evolution using color visualization.

Bansiya calculated the extent of change between two software versions. See J. Bansiya, “Evaluating Framework Architecture Structural Stability,” ACM Comput. Surv., vol. 32, 2000/03//2000, incorporated herein by reference in its entirety. He presented a methodology to assess framework architecture stability by using an Object-Oriented (OO) metrics suite that evaluates framework structural characteristics. These characteristics are: design size (in number of classes), number of class hierarchies, number of multiple inheritances, number of single inheritances, average depth of class inheritance hierarchies, average width of class inheritance hierarchies, number of parents, number of methods, and class coupling. After computing the metric values of these characteristics, the extent-of-change is identified by normalizing these values with respect to earlier versions' values, and calculating the difference between aggregate-change values between subsequent releases and the version i release. The aggregate-change is the sum of all characteristics' values in the same version. The extent-of-change values indicate that as the value increases, the system becomes more unstable.

Haohai et al. used Bansiya's approach. See H. Ma, W. Shao, L. Zhang, Z. Ma, and Y. Jiang, “Applying OO Metrics to Assess UML Meta-models,” in <<UML>>2004—The Unified Modeling Language. Modeling Languages and Applications, T. Baar, A. Strohmeier, A. Moreira, and S. J. Mellor, Eds., ed: Springer Berlin Heidelberg, 2004, pp. 12-26, incorporated herein by reference in its entirety. In addition, they proposed another six metrics and followed the same evaluation procedure. These metrics are: the average number of additional operations, average number of stereotypes, number of abstract meta-classes, average number of well-formed rules, number of concrete meta-classes, and the number of meta-classes which have no parent and no child in the meta-model.

Mattsson and J. Bosch also used the same methodology presented by Bansiya, but they applied it on a different suite of metrics. See M. Mattsson and J. Bosch, “Characterizing stability in evolving frameworks,” in Proceedings of Technology of Object-Oriented Languages and Systems, 1999, 1999, pp. 118-130, incorporated herein by reference in its entirety.

Moataz et al. introduced a way for measuring architectural stability by defining a release's similarity to the base version. See M. Mattsson and J. Bosch, “Characterizing stability in evolving frameworks,” in Proceedings of Technology of Object-Oriented Languages and Systems, 1999, 1999, pp. 118-130, incorporated herein by reference in its entirety. They proposed two similarity metrics of Shallow Semantic Similarity Metric (SSSM) and Relationship-Based Similarity Metric (RBSM), wherein a greater similarity leads towards better stability. SSSM computes the average similarity between two pairs of classes by comparing the architecture of successive releases with the base version architecture. The RBSM similarity measurements are based on comparing the existing inheritance relationships among two models classes.

Hassan proposed a metrics suite of an inter-package and an intra-package set of metrics to measure architecture stability. See Y. S. Hassan, “Measuring software architectural stability using retrospective analysis,” M. S., King Fahd University of Petroleum and Minerals (Saudi Arabia), Saudi Arabia, 2007, incorporated herein by reference in its entirety. The inter-package set of metrics considers the connections between elements of two different packages. The intra-package set of metrics considers the connections between elements in the same package. Metric calculation depends on an indication of an element's change. These change possibilities are: modification, no change, addition, and deletion.

Aversano et al. defined two metrics, Core Design Instability (CDI) and Core Calls Instability (CCI) to assess the architecture stability. See L. Aversano, M. Molfetta, and M. Tortorella, “Evaluating architecture stability of software projects,” in 2013 20th Working Conference on Reverse Engineering (WCRE), 2013, pp. 417-424, incorporated herein by reference in its entirety. CDI is used to indicate the changes that affect the core architecture. It is computed as follows:

CDI=(b+c)/m,

where,

m: number of packages that belong to the extended core of release N,

b: number of new packages that are added to the extended core,

c: sum of packages that belong to extended core N, and which do not belong to extended core N+1.

CCI was proposed to evaluate the change of the package's interactions. It is calculated as follows:

CCI=(x+y)/z,

where,

z: the total number of calls between packages that belong to the extended core of release N,

x: the total number of new calls between packages that belong to the extended core of release N+1,

y: the total number of calls between packages of the extended core of release N and which are not present in the extended core of the release N+1 after the executed changes.

Grosser et al. proposed a metric to assess class stability based on case-based reasoning (CBR). See D. Grosser, H. A. Sahraoui, and P. Valtchev, “Predicting software stability using casebased reasoning,” in 17th IEEE International Conference on Automated Software Engineering, 2002. Proceedings. ASE 2002, 2002, pp. 295-298, incorporated herein by reference in its entirety. The authors used CBR to identify quality challenges and evaluate them using several metrics related to four categories of complexity, inheritance, cohesion, and coupling. The evaluation results are compared to other nearest-known software items in order to predict the stability.

Grosser et al. included another factor called stress, which results from a primary change in the requirements. See D. Grosser, H. A. Sahraoui, and P. Valtchev, “An analogy-based approach for predicting design stability of Java classes,” in Software Metrics Symposium, 2003. Proceedings. Ninth International, 2003, pp. 252-262, incorporated herein by reference in its entirety. The stress factor is computed at the class level between two software versions.

Rapu et al. presented an approach that depends on historical information to detect class problems, such as God Classes and Data Classes. See D. Rapu, S. Ducasse, T. Girba, and R. Marinescu, “Using history information to improve design flaws detection,” in Eighth European Conference on Software Maintenance and Reengineering, 2004. CSMR 2004. Proceedings, 2004, pp. 223-232, incorporated herein by reference in its entirety. Rapu et al. indicated that the class is stable if there is no difference in measurements between version i−1 and version i. The authors did not take into account the class changing size; they considered the class to be changed if a method was added or removed.

Li et al. introduced three metrics of Class Implementation Instability (CII), System Design Instability (SDI), and System Implementation Instability (SII) to assess Object-Oriented (OO) stability at the implementation level. See W. Li, L. Etzkorn, C. Davis, and J. Talburt, “An empirical study of object-oriented system evolution,” Information and Software Technology, vol. 42, pp. 373-381, 2000/04/15/2000, incorporated herein by reference in its entirety. CII was introduced to measure changes from design N to design N+1 during OO implementation at the class level. The preceding is computed by calculating the percentage of lines of code (LOC) changes between the two versions.

Alshayeb et al. proposed a Class Stability Metric (CSM) to assess stability at the class level. See M. Alshayeb, M. Naji, M. O. Elish, and J. Al-Ghamdi, “Towards measuring object-oriented class stability,” IET Software, vol. 5, pp. 415-424, 2011/08//2011, incorporated herein by reference in its entirety. The authors selected eight different class properties to evaluate stability, in lucinb the class access-level, the class interface name, the method access-level, the inherited class name, the method signature, the class variable, the class variable access-level, and the method body.

CSM follows property change (addition, deletion, modification, and unchanged) between the two versions i+1 and i. If there is no change, the class is stable. Alshayeb subsequently introduced a minor modification to CSM by considering the changes between the n+1 and n versions, instead of the base version. See M. Alshayeb, “On the relationship of class stability and maintainability,” IET Software, vol. 7, pp. 339-347, 2013/12/I 2013, incorporated herein by reference in its entirety.

Elish and Rine investigated process-related and product-related indicators that affect structural stability measures. See M. O. Elish and D. Rine, “Indicators of Structural Stability of Object-Oriented Designs: A Case Study,” in Software Engineering Workshop, 2005. 29th Annual IEEE/NASA, 2005, pp. 183-192, incorporated herein by reference in its entirety. Elish and Rine selected several metrics suites to gather data about version i of the software and used these data to predict structural stability in version i+1. Elish and Rine measured stability from two perspectives. The first perspective considered how much of the base design structure remained unchanged, while the second perspective considered how long the structure remained invariant. Sixteen metrics were proposed to define the number of classes that were modified, added, deleted, and unchanged. In addition, they are used to specify the relationship types of the classes, which can be generalization, aggregation, dependency, or association.

Mattsson and Bosch introduced a relative-extent-of-change metric and used Bansiya's stability assessment method in order to evaluate software systems. See M. Mattsson and J. Bosch, “Stability assessment of evolving industrial object-oriented frameworks,” Journal of Software Maintenance: Research and Practice, vol. 12, pp. 79-102, 2000/03/01/2000, incorporated herein by reference in its entirety. They used different sets of metrics suites to evaluate structural, functional, and relational characteristics.

Elish and Rine investigated the relationship between the C&K metrics and the logical stability. See M. O. Elish and D. Rine, “Investigation of metrics for object-oriented design logical stability,” in Seventh European Conference on Software Maintenance and Reengineering. 2003. Proceedings, 2003, pp. 193-200; and S. R. Chidamber and C. F. Kemerer, “A metrics suite for object oriented design,” IEEE Transactions on Software Engineering, vol. 20, pp. 476-493, 1994/06//1994, each incorporated herein by reference in their entireties. Their investigation found a good correlation between CBO and RFC metrics with logical stability. They also found a negative coloration of WMC, DIT, CBO, RFC, and LCOM metrics with logical stability, and no correlation in the NOC case. Elish and Rine used an algorithm to compute the program's logical stability. The algorithm applies all potential class level changes to the other design classes and calculates the ratio of the number of times the class is impacted by the total number of possible changes. Class level changes are Data type, Delete, Scope (protected to private), Scope (public to private), Scope (public to protected), and Return data type. Class methods are Delete, Scope (protected to private), Scope (public to protected), and Scope (public to private).

System Implementation Instability (SII) was proposed by Li et al. to measure changes from design N to design N+1 during OO system implementation. SII is computed by calculating the percentage of LOC changes between two versions in the entire system.

Raemaekers et al. proposed four metrics to evaluate implementation and public interface in order to indicate library stability. See S. Raemaekers, A. van Deursen, and J. Visser, “Measuring software library stability through historical version analysis,” in 2012 28th IEEE International Conference on Software Maintenance (ICSM), 2012, pp. 378-387, incorporated herein by reference in its entirety. These four metrics include Weighted Number of Removed Methods (WRM), which is used as a measure for interface stability; the Amount of Change in Existing Methods (CEM), which indicates the amount of change in existing methods; Ratio of Change in New to Old Methods (RCNO), which indicates the amount of work achieved, and Percentage of New Methods (PNM), which computes the percentage of the new added methods.

Kelly investigated software systems in order to indicate the systems that have been maintained actively. See D. Kelly, “A study of design characteristics in evolving software using stability as a criterion,” IEEE Transactions on Software Engineering, vol. 32, pp. 315-329, 2006/05//2006, incorporated herein by reference in its entirety. Kelly proposed a method for inspecting such systems by using stability as an indicator of the design characteristics that affect the maintainability. The author used different metrics to assess design characteristics and to find the difference between two software versions. These metrics included total number of common blocks (CB), total lines of code (LOC), total number of common block variables (VAR), and total number of modules (MOD).

Yau and Collofello measured program and module logical stability. See S. S. Yau and J. S. Collofello, “Some Stability Measures for Software Maintenance,” IEEE Transactions on Software Engineering, vol. SE-6, pp. 545-552, 1980/11//1980, incorporated herein by reference in its entirety. The logical stability is a measure of the change impact of a module to the other modules in the program. The authors calculated the logical ripple effect of a primitive modification to a program. Their formula depends on computing the modification probability that equals one divided by the number of variable definitions in the module, and the sum of McCabe's Cyclomatic number.

Li et al. proposed the System Design Instability (SDI), specified for assessing OO at the implementation level. SDI is used to capture changes of software design by measuring the percentage of change from design N to design N+1. SDI considers the change percentage of newly added classes, classes with changed names, and deleted classes.

SDI is computed as follows:

SDI=[(a+b+c)/m]×100,

where:

a: change in classes' name,

b: added classes,

c: deleted classes,

m: number of classes in design N.

The SDI value is greater than or equal to zero, where zero means that the design is stable.

Alshayeb and Li redefined SDI considering a fourth aspect of change, which is the percentage of change in inheritance hierarchy. See M. Alshayeb and W. Li, “An Empirical Study of System Design Instability Metric and Design Evolution in an Agile Software Process,” J. Syst. Softw., vol. 74, pp. 269-274, 2005/02//2005, incorporated herein by reference in its entirety.

The new formula is computed as follows:

SDI=[(a+b+c+d)/m]×100,

where,

d represents change in inheritance hierarchy.

Olague et al. introduced the Entropy-based SDI (SDIe) metric by recasting the SDI proposed by Li et al. See H. M. Olague, L. H. Etzkorn, W. Li, and G. Cox, “Assessing design instability in iterative (agile) object-oriented projects,” Journal of Software Maintenance and Evolution: Research and Practice, vol. 18, pp. 237-266, 2006/07/01/2006, incorporated herein by reference in its entirety. SDIe is based on maximum system entropy, and considers some different aspects of input, which included the added classes, the deleted classes, changed classes, and the unchanged classes. The SDIe is computed as follows:

$${SDI}_{e} = - {\sum }_{i = 1}^{j} \frac{{C}_{i}}{N} {log}_{2} \frac{{C}_{i}}{N}$$

j: the total number of categories of SDIe, which include added, deleted, changed, and unchanged.

Ci: the classes' count in category i, and N represents the total number of system classes.

Martin and Martin proposed a metric to evaluate the components' stability based on the total number of dependencies that enter or leave the component. See R. C. Martin and M. Martin, Agile Principles, Patterns, and Practices in C#, incorporated herein by reference in its entirety. It is computed as follows:

Instability=(Ce)/(Ca+Ce),

where,

Ca: the total number of classes in other components that depend upon classes within the component, and

Ce: the total number of classes in other components that the classes in the component depend upon.

The metric values range from 0 to 1, wherein 0 indicates the component is stable. Thus, the system will be stable if the maximum number of components is stable.

Table 1 provides an overview of the surveyed metrics. The first column lists the reference. The second column lists the metrics assessment level (class, system, or architecture). The third column lists the artifact used to compute the metrics. The fourth column lists the number of properties used in calculation. The fifth column lists the validation techniques. The last column gives a brief description of the metric.

TABLE 1
Stability Survey Summary

| | | | | Set of | | |
|---|---|---|---|---|---|---|
| | Metric | | Language | properties | | |
| Reference | Level | Artifact | Independent | or metrics | Validation | Metric Description |
| Grosser et al. | Class | Code | Yes | 22 old | Experimental | Evaluating stability using several metrics |
| [19] | | | | metrics | | related to the four categories: coupling, |
| | | | | | | cohesion, inheritance and complexity |
| Grosser et al. | Class | Code | Yes | 14 old | Experimental | Evaluating stability using several metrics |
| [20] | | | | metrics | | related to the four categories: coupling, |
| | | | | | | cohesion, inheritance and complexity |
| Rapu et al | Class | Code | Yes | 9 old | Case Study | Checks if class is stable or not |
| [21] | | | | metrics | | |
| Li et al. [22] | Class | Code | Yes | 1 property | Theoretical & | Calculates the percentage of LOC changes |
| | | | | | Experimental | between two versions |
| Alshayeb et | Class | Code | Yes | 8 properties | Theoretical & | CSM metric follows the change in properties |
| al. [23], | | | | | Experimental | (addition, deletion, modification, and |
| Alshayeb | | | | | | unchanged) between two versions |
| [24] | | | | | | |
| Elish and | Class | Code | Yes | 17 new | Case Study | Investigates product-related and process- |
| Rine [25] | | | | metrics and | | related indicators that affect structural stability |
| | | | | 16 old | | measures |
| | | | | metrics | | |
| Li et al. [22] | System | Code | Yes | 1 property | Theoretical & | Calculates the percentage of LOC changes |
| | | | | | Experimental | between two versions |
| Raemaekers | System | Code | Yes | 4 properties | Experimental | Indicates library stability, by calculating |
| et al. [29] | | | | | | stability of implementation and public |
| | | | | | | interface of the library |
| Kelly [30] | System | Code | Yes | 4 properties | Case Study | Computes stability by finding the difference |
| | | | | | | between two software versions |
| Yau and | System | Code | Yes | 2 properties | Theoretical | Computes the modification probability |
| Collofello | | | | | & Case | |
| [31] | | | | | Study | |
| Sethi et al. | Architecture | Code | Yes | 6 properties | Case Study | Calculates stability by taking into |
| [9] | | | | | | consideration the environmental conditions |
| Molesini et | Architecture | Code | Yes | 5 properties | Experimental | Quantifies change propagation in AO |
| al. [10] | | | | | | architecture |
| Tonu et al. | Architecture | Code | Yes | 4 old | Experimental | Combines retrospective and predictive |
| [11] | | | | metrics | | evaluation |
| Jazayeri [12] | Architecture | Code | Yes | 3 properties | Case Study | Evaluates structural stability using |
| | | | | | | retrospective analysis |
| Mattsson and | Class | UML | Yes | 20 old | Case Study | Introduces relative-extent-of-change |
| Bosch [26] | | | | metrics | | |
| Elish and | Class | UML | Yes | 10 | Experimental | Computes the logical stability |
| Rine [27] | | | | properties | | |
| Li et al. [22], | System | UML | Yes | 1 property | Theoretical & | Capture changes of software design by |
| Alshayeb and | | | | | Experimental | measuring the percentage of changes from |
| Li [32], | | | | | | design N to design N − 1 |
| Olague et al. | | | | | | |
| [33] | | | | | | |
| Martin and | System | UML | Yes | 1 property | — | Measures the component stability based on |
| Martin [34] | | | | | | dependencies |
| Bansiya [13] | Architecture | UML | Yes | 9 old | Case Study | Introduces a methodology to assess framework |
| | | | | metrics | | architecture stability based on extent-of- |
| | | | | | | change |
| Ma et al. [14] | Architecture | UML | Yes | 6 old | Experimental | Uses Bansiya [13] methodology |
| | | | | metrics | | |
| Mattsson and | Architecture | UML | Yes | 20 old | Experimental | Uses Bansiya [13] methodology |
| Bosch [15] | | | | metrics | | |
| Moataz et al. | Architecture | UML | Yes | 2 properties | Case Study | Measures stability by defining the similarity of |
| [16] | | | | | | the releases to the base version |
| Hassan [17] | Architecture | UML | Yes | 20 property | Theoretical & | Measures stability using the inter-package and |
| | | | | | Experimental | intra-package metrics |
| Aversano et | Architecture | UML | Yes | 6 properties | — | Proposes CDI and CCI metrics to assess |
| al. [18] | | | | | | architecture stability |
| The | Class | UML | Yes | 9 | Theoretical | Propose Structural Stability metric to |
| proposed | Diagram | | | properties | & Case | assess UML class diagram |
| Metric | | | | | Study | |
| The | Sequence | UML | Yes | 7 | Theoretical | Propose Functional Stability metric to |
| proposed | Diagram | | | properties | & Case | assess UML sequence diagram |
| Metric | | | | | Study | |
| The | Use Case | UML | Yes | 9 | Theoretical | Propose Behavioral Stability metric to |
| proposed | Diagram | | | properties | & Case | assess UML use case diagram |
| Metric | | | | | Study | |

Table 1 summarizes the investigated stability metrics and reveals that no metrics exist to measure the software model's stability. Metrics are used to evaluate code stability. Assessment covers three levels, which are the architecture, the class, and the system. Most of the surveyed metrics were validated empirically using case studies or experiments. However, few of them were validated theoretically.

Mayrand et al. used several metrics to compare functions in order to identify duplication and cloning level, based on computing four points of name, layout, expressions, and control flow. See J. Mayrand, C. Leblanc, and E. Merlo, “Experiment on the Automatic Detection of Function Clones in a Software System Using Metrics,” 1996, incorporated herein by reference in its entirety.

Patenaude et al. extended the Bell Canada Datrix tool to find Java clones. See J. F. Patenaude, E. Merlo, M. Dagenais, and B. Lague, “Extending software quality assessment techniques to Java systems,” in Seventh International Workshop on Program Comprehension. 1999. Proceedings, 1999, pp. 49-56, incorporated herein by reference in its entirety. The authors used several complexity metrics to evaluate methods. Methods with similar metrics values are clones.

Kontogiannis et al. introduced two techniques for clone detection. See K. A. Kontogiannis, R. Demori, E. Merlo, M. Galler, and M. Bernstein, “Pattern matching for clone and concept detection,” Automated Software Engineering, vol. 3, pp. 77-108, 1996/06/01/1996, incorporated herein by reference in its entirety. In the first technique, they selected five well-known metric suites that capture code information and applied them on the two code fragments to compare their values. In the second technique, they used dynamic programming (DP) to compare two code segments to compute a distance, based on insertion, deletion, and operation comparison.

Balazinska et al. applied a similar method in their similar methods classifier (SMC) tool. See M. Balazinska, E. Merlo, M. Dagenais, B. Lague, and K. Kontogiannis, “Measuring clone based reengineering opportunities,” in Software Metrics Symposium, 1999. Proceedings. Sixth International, 1999, pp. 292-303, incorporated herein by reference in its entirety. The authors represented the code in abstract syntax tree (AST) and performed code segmentation, and subsequently applied DP.

Qiu et al. introduced a metric to assess software similarity by quantifying the nodes and edges of the class diagrams. See D. H. Qiu, H. Li, and J. L. Sun, “Measuring software similarity based on structure and property of class diagram,” in 2013 Sixth International Conference on Advanced Computational Intelligence (ICACI), 2013, pp. 75-80, incorporated herein by reference in its entirety. The authors calculated software similarity by computing structural similarity and property similarity. They constructed class diagrams from the source code. The class is represented by a node and the relationship is represented by an edge, wherein the authors assigned a weight to the edges based on coupling metrics. The similarity between the nodes and edges was computed using the iterative method.

Krinke extracted a program dependency graph from the source code, and detected the similarities between the subgraphs using the iterative approach. See J. Krinke, “Identifying similar code with program dependence graphs,” in Eighth Working Conference on Reverse Engineering, 2001. Proceedings, 2001, pp. 301-309, incorporated herein by reference in its entirety. The nodes represent the expressions and the statements, while data dependencies are represented by edges.

Liu et al. proposed a plagiarism detector based on a program dependency graph (PDG). See C. Liu, C. Chen, J. Han, and P. S. Yu, “GPLAG: Detection of Software Plagiarism by Program Dependence Graph Analysis,” 2006, pp. 872-881, incorporated herein by reference in its entirety.

Johnson used fingerprinting to find matches in source code text. See J. H. Johnson, “Identifying Redundancy in Source Code Using Fingerprints,” 1993, pp. 171-183, incorporated herein by reference in its entirety. Fingerprinting methodology converts a substring of the code to hash, where the hash values of each of the two code segments are matched.

Li et al. introduced the CP-Miner tool, which is a token-based tool used to find copy and paste in source code. See Z. Li, S. Lu, S. Myagmar, and Y. Zhou, “CP-Miner: Finding Copy-Paste and Related Bugs in Large-Scale Software Code,” IEEE Trans. Softw. Eng., vol. 32, pp. 176-192, 2006/03//2006, incorporated herein by reference in its entirety. The token-based tool finds the similar sequences that appear in the same order in the code using repeated subsequence data mining.

The literature described herein presents many metrics that have been used to compute software similarity and code clones. The surveyed literatures declared five main techniques to measure software similarity. These techniques were distinguished using the analysis methodology. The five techniques are:

Text-based approach, which depends on natural language processing to find a repeated fingerprint to use in code segments matching.

Token-based approach, which converts the source code into a sequence of tokens and scans them for repeated subsequences.

Tree-based approach, which transforms the source code program into an abstract syntax tree (AST) and uses tree-matching to find similar sub-trees.

Graph-based approach, which extracts a program dependency graph from the source code and detects similarities of sub-graphs using the iterative approach.

Metric-based approach, which applies a number of metrics on the code, where they are used to compare different code segments.

Table 2 provides a high-level overview of the surveyed techniques, tools, and metrics. The first column shows the citation(s), while the second column shows the approach used and the last column shows a brief description of the citation. Table 2 shows the different techniques used to evaluate the similarity between software systems, which are text-based approach, token-based approach, tree-based approach, graph-based approach, and metric-based approach.

TABLE 2
Similarity Techniques Summary

| | | Metric | |
|---|---|---|---|
| Reference | Techniques | Extraction Level | Metric Description |
| Qiu et al. [39] | Tree-based | Code | Constructs class diagram, and use iterative method to |
| | | | compute similarities |
| Krinke [40] | Graph-based | Code | Uses program dependency graph to detect similarities |
| Mayrand et al. [35] | Metrics-based | Code | Identifies software functions clone level |
| Patenaude et al. [36] | Metrics-based | Code | Identifies software method clones |
| Kontogiannis et al. [37] | Metrics-based | Code | Detects clones using structure based metrics and dynamic |
| | | | programming (DP) techniques |
| Balazinska et al. [38] | Tree-based | Code | Uses dynamic programming (DP) on abstract syntax tree |
| | | | (AST) |
| Liu et al. [41] | Graph-based | Code | Uses program dependency graph to detect plagiarism |
| Johnson [42] | Text-based | Code | Fingerprints to find matches in source code text |
| Lu et al. [43] | Token-based | Code | Finds copy and paste in source code |

The “background” description provided herein is for the purpose of generally presenting the context of the disclosure. Work of the presently named inventors, to the extent it is described in this background section are neither expressly nor impliedly admitted as prior art against the present invention. In addition, aspects of the description which may not otherwise qualify as prior art at the time of filing are neither expressly nor impliedly admitted as prior art against the present invention.

### SUMMARY

The cited literature presents many metrics that are used to assess software stability, which focus primarily on assessing code stability. The surveyed approaches show that none of the research investigated measures stability for individual design models. An objective herein is to propose a set of metrics to measure the stability of UML class, sequence, use case, and the integrated model.

Embodiments herein describe a spectrum of stability metrics which cover different UML views. Stability metrics described herein measure the stability of different UML models. Embodiments herein describe stability in terms of forming a revised version of a software product from an original or previous version of the software product. However, embodiments described herein are not restricted to this meaning and use of stability. Any transition from a first state to a second state is contemplated by embodiments described herein.

One diagram from each UML model was investigated.
A class diagram describes the structure of a system by showing the system's classes, their attributes, variables, methods, and the relationships among objects.
A sequence diagram is an interaction diagram that represents the sequence of messages exchanged between objects to implement a specific scenario.
A use-case diagram is used to represent system functionality. Use cases describe the interaction between customers and the system by providing a graphical representation of what the system does.

Contributions include the following.
A structural-stability metric is a metric to assess the UML class diagram's stability that covers structural properties.
A functional-stability metric is a metric to assess stability of the UML use case diagram that covers functional properties.
A behavioral-stability metric is a metric to assess the stability of the UML sequence diagram that covers behavioral properties.

In an embodiment, a method of computing a structural model stability metric includes obtaining, using circuitry, a first state of a class diagram including a first plurality of classifiers and a second state of the class diagram including a second plurality of classifiers. The method also includes identifying, using said circuitry, one or more classifier type properties and one or more relationship properties for the first state of the class diagram and the second state of the class diagram. The method also includes tracking, using said circuitry, a transformation in the one or more classifier type properties from the first state of the class diagram to the second state of the class diagram, and tracking a transformation in the one or more relationship properties from the first state of the class diagram to the second state of the class diagram. The method also includes calculating, using said circuitry, the structural model stability metric for the second state of the class diagram as a ratio of a percentage of unchanged classifier type properties from the first state to the second state plus a percentage of unchanged relationship properties from the first state to the second state to a total number of the first plurality of classifiers in the first state of the class diagram. The method also includes transmitting, using said circuitry, an alert message to a user when the structural model stability metric is equal to or less than a predetermined threshold.

In further embodiments to the method of computing a structural model stability metric, the identifying the one or more relationship properties can include identifying a dependency relationship when a client classifier depends upon a master classifier, and a change to the master classifier causes a change to the client classifier.

The identifying the one or more relationship properties can also include identifying an association relationship when one or more objects within a first classifier depend upon one or more objects of a second classifier and when the one or more objects within the second classifier depend upon the one or more objects of the first classifier, and the first classifier and the second classifier are both a client classifier and a master classifier at a same time.

The identifying the one or more relationship properties can also include identifying an aggregation relationship when a client classifier aggregates an object from a master classifier, and a change to the client classifier does not cause a change to the master classifier.

The identifying the one or more relationship properties can also include identifying a composition relationship when a first classifier aggregates an object of a second classifier and when the object of the second classifier cannot be aggregated by another classifier, and the first classifier and the second classifier are both a client classifier and a master classifier at the same time.

The identifying the one or more relationship properties can also include identifying an inheritance relationship when a client sub-classifier is a type of a master super-classifier, and a change to the master super-classifier causes a change to the client sub-classifier.

The identifying the one or more relationship properties can also include identifying a realization relationship when a client classifier realizes an object of a master classifier, and a change to the client classifier does not cause a change to the master classifier.

The method of computing a structural model stability metric can further include assigning a master role and a client role to each of the first plurality of classifiers, and tracking, using said circuitry, a change to the client role for each of the first plurality of classifiers from the first state of the class diagram to the second state of the class diagram, wherein the master role does not change when the client role changes and the client role changes when the master role changes.

The method of computing a structural model stability metric can further include transforming the second state of the class diagram from a model level to a source code level.

In another embodiment, a method of computing a functional model stability metric includes obtaining, using circuitry, a first state of a use-case diagram including a first plurality of use cases and a first plurality of actors. The method also includes obtaining, using said circuitry, a second state of the use-case diagram including a second plurality of use cases and a second plurality of actors. The method also includes identifying, using said circuitry, one or more use-case properties for the first state of the use-case diagram and the second state of the use-case diagram, and identifying one or more actor relationships for the first state of the use-case diagram and the second state of the use-case diagram. The method also includes tracking, using said circuitry, a transformation in the one or more use-case properties from the first state of the use-case diagram to the second state of the use-case diagram, and tracking a transformation in the one or more actor relationships from the first state of the use-case diagram to the second state of the use-case diagram. The method also includes calculating, using said circuitry, a total number of unchanged use-case properties based on the transformation in the one or more use-case properties from the first state of the use-case diagram to the second state of the use-case diagram, and calculating a total number of unchanged actor relationships based on the transformation in the one or more actor relationships from the first state of the use-case diagram to the second state of the use-case diagram. The method also includes calculating, using said circuitry, a percentage of unchanged use-case properties based on the total number of unchanged use-case properties and a total number of the use-case properties, and calculating a percentage of unchanged actor relationships based on the total number of unchanged actor relationships and a total number of the actor relationships. The method also includes calculating, using said circuitry, the functional model stability metric for the second state of the use-case diagram as a ratio of the percentage of unchanged use-case properties from the first state to the second state plus the percentage of unchanged actor relationships from the first state to the second state to a total number of the first plurality of use cases plus a total number of the first plurality of actors in the first state of the use-case diagram. The method also includes transmitting, using said circuitry, an alert message to a user when the functional model stability metric is equal to or less than a predetermined threshold.

In further embodiments to the method of computing a functional model stability metric, the identifying the one or more relationship properties can include identifying a generalization relationship when a client use case is a specialization of a master use case, and the client use case uses the master use case and a change to the master use case causes a change to the client use case.

The identifying the one or more relationship properties can also include identifying an include relationship when a master use case object is inserted into a client use case, and the master use case can be accessed without a need for the client use case.

The identifying the one or more relationship properties can also include identifying an extend relationship when a function is extended from a first use case to a second use case, and the first use case and the second use case are client use cases and a change to one of the first use case or the second use case affects another of the first use case or the second use case.

In further embodiments to the method of computing a functional model stability metric, the tracking the transformation in the one or more use-case properties and the tracking the transformation in the one or more actor relationships are implemented via tracking changes to a client role of the first plurality of use cases and a client role of the first plurality of actors, respectively, from the first state of the use-case diagram to the second state of the use-case diagram, and a change to one of the master roles causes a change to a respective client role.

The method of computing a functional model stability metric can further include transforming the second state of the use-case diagram from a model level to a source code level.

In another embodiment, a method of computing a behavioral model stability metric includes obtaining, using circuitry, a first state of a sequence diagram including a first plurality of message participants and a second state of the sequence diagram including a second plurality of message participants. The method also includes identifying, using said circuitry, one or more message properties for the first state of the sequence diagram and the second state of the sequence diagram, and tracking a transformation in the one or more message properties for a message type, a message order, and a message caller from the first state of the sequence diagram to the second state of the sequence diagram. The method also includes calculating, using said circuitry, a total number of unchanged message properties for the message type, the message order, and the message caller from the first state of the sequence diagram to the second state of the sequence diagram. The method also includes calculating, using said circuitry, a combined percentage of unchanged message properties as a ratio of the total number of unchanged message properties per a total number of the message properties from the first state of the sequence diagram to the second state of the sequence diagram. The method also includes calculating, using said circuitry, the behavioral model stability metric for the second state of the sequence diagram as a ratio of the combined percentage of unchanged message properties from the first state to the second state to a total number of the first plurality of message participants in the first state of the sequence diagram. The method also includes transmitting, using said circuitry, an alert message to a user when the behavioral model stability metric is equal to or less than a predetermined threshold.

In further embodiments to the method of computing a behavioral model stability metric, the identifying the one or more message properties can include identifying a synchronous message when a client message participant sends a message to a master message participant and waits for a return message invocation from the master message participant, and a change to the master message participant causes a change to the client message participant.

The identifying the one or more message properties can also include identifying an asynchronous message when a client message participant sends a message to a master message participant and does not wait for a return message invocation from the master message participant, and a change to the client message participant does not cause a change to the master message participant.

In further embodiments to the method of computing a behavioral model stability metric, the tracking a transformation in the message property is implemented via tracking a change to a client role of the first plurality of message participants from the first state of the sequence diagram to the second state of the sequence diagram, and a change to a master role of the first plurality of message participants does not cause a change to the client role and the client role of the first plurality of message participants changes when the master role changes.

The method of computing a behavioral model stability metric can further include transforming the second state of the sequence diagram from a model level to a source code level.

The foregoing paragraphs have been provided by way of general introduction, and are not intended to limit the scope of the following claims. The described embodiments, together with further advantages, will be best understood by reference to the following detailed description, taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates UML diagrams according to an embodiment;

FIG. 2 illustrates class diagram relationships according to an embodiment;

FIG. 3 illustrates use-case diagram relationships according to an embodiment;

FIG. 4 illustrates an exemplary sequence diagram according to an embodiment;

FIG. 5 is an exemplary flowchart of a research methodology according to an embodiment;

FIG. 6 illustrates an exemplary class diagram according to an embodiment;

FIG. 7 illustrates an exemplary classifier according to an embodiment;

FIG. 8 illustrates exemplary classifiers according to an embodiment;

FIG. 9 illustrates an exemplary dependency relationship according to an embodiment;

FIG. 10 illustrates an exemplary implementation code for a dependency relationship according to an embodiment;

FIG. 11 illustrates an exemplary association relationship according to an embodiment;

FIG. 12 illustrates an exemplary implementation code for an association relationship according to an embodiment;

FIG. 13 illustrates an exemplary aggregation relationship according to an embodiment;

FIG. 14 illustrates an exemplary implementation code for an aggregation relationship according to an embodiment;

FIG. 15 illustrates an exemplary composition relationship according to an embodiment;

FIG. 16 illustrates an exemplary implementation code for a composition relationship according to an embodiment;

FIG. 17 illustrates an exemplary inheritance relationship according to an embodiment;

FIG. 18 illustrates an exemplary implementation code for an inheritance relationship according to an embodiment;

FIG. 19 illustrates an exemplary realization relationship according to an embodiment;

FIG. 20 illustrates an exemplary implementation code for a realization relationship according to an embodiment;

FIG. 21 illustrates as exemplary association class according to an embodiment;

FIG. 22 illustrates an exemplary implementation code for an association class according to an embodiment;

FIG. 23 is an exemplary flowchart for computing a structural model stability metric according to an embodiment;

FIG. 24 illustrates changes to a classifier type property according to an embodiment;

FIG. 25 illustrates changes to a classifier relationship property according to an embodiment;

FIG. 26 illustrates an exemplary class diagram version i according to an embodiment;

FIG. 27 illustrates an exemplary class diagram version i+1 according to an embodiment;

FIG. 28 illustrates an exemplary use case with an extension point according to an embodiment;

FIG. 29 illustrates an exemplary actor-actor relationship according to an embodiment;

FIG. 30 illustrates an exemplary actor use-case relationship according to an embodiment;

FIG. 31 illustrates an exemplary use-case generalization relationship according to an embodiment;

FIG. 32 illustrates an exemplary use-case inclusion relationship according to an embodiment;

FIG. 33 illustrates an exemplary use-case extended relationship according to an embodiment;

FIG. 34 is an exemplary flowchart for computing a functional model stability metric according to an embodiment;

FIG. 35 illustrates changes to a use-case type property according to an embodiment;

FIG. 36 illustrates changes to a use-case relationship property according to an embodiment;

FIG. 37 illustrates changes to an actor relationship according to an embodiment;

FIG. 38 illustrates an exemplary use-case diagram version i according to an embodiment;

FIG. 39 illustrates an exemplary use-case diagram version i+1 according to an embodiment;

FIG. 40 illustrates an exemplary description of a participant according to an embodiment;

FIG. 41 illustrates exemplary sequence diagram participants according to an embodiment;

FIG. 42 illustrates an exemplary description of a message according to an embodiment;

FIG. 43 illustrates an exemplary description of a message argument according to an embodiment;

FIG. 44 illustrates an exemplary synchronous message according to an embodiment;

FIG. 45 illustrates an exemplary implementation code for a synchronous message according to an embodiment;

FIG. 46 illustrates an exemplary asynchronous message according to an embodiment;

FIG. 47 illustrates an exemplary implementation code for an asynchronous message according to an embodiment;

FIG. 48 illustrates an exemplary return message according to an embodiment;

FIG. 49 illustrates an exemplary creation message according to an embodiment;

FIG. 50 illustrates an exemplary destruction message according to an embodiment;

FIG. 51 illustrates an exemplary implementation code for a creation message according to an embodiment;

FIG. 52 is an exemplary flowchart for computing a behavioral model stability metric according to an embodiment;

FIG. 53 illustrates changes to a message receiver property according to an embodiment;

FIG. 54 illustrates changes to a message caller property according to an embodiment;

FIG. 55 illustrates changes to a message type property according to an embodiment;

FIG. 56 illustrates changes to a message order property according to an embodiment;

FIG. 57 illustrates an exemplary sequence diagram version i according to an embodiment;

FIG. 58 illustrates an exemplary sequence diagram version i+1 according to an embodiment;

FIG. 59 illustrates an exemplary Automated Teller Machine (ATM) class diagram version i according to an embodiment;

FIG. 60 illustrates an exemplary ATM class diagram version i+1 according to an embodiment;

FIG. 61 illustrates an exemplary ATM StartUp sequence diagram version 1 according to an embodiment;

FIG. 62 illustrates an exemplary ATM StartUp sequence diagram version 2 according to an embodiment;

FIG. 63 illustrates an exemplary deposit sequence diagram version 1 according to an embodiment;

FIG. 64 illustrates an exemplary deposit sequence diagram version 2 according to an embodiment;

FIG. 65 illustrates an exemplary withdrawal sequence diagram version 1 according to an embodiment;

FIG. 66 illustrates an exemplary withdrawal sequence diagram version 2 according to an embodiment;

FIG. 67 illustrates an exemplary Supply Chain Management (SCM) class diagram version 1 according to an embodiment;

FIG. 68 illustrates an exemplary SCM class diagram version 2 according to an embodiment;

FIG. 69 illustrates an exemplary purchase sequence diagram version 1 according to an embodiment;

FIG. 70 illustrates an exemplary purchase sequence diagram version 2 according to an embodiment;

FIG. 71 illustrates an exemplary replenish sequence diagram version 1 according to an embodiment;

FIG. 72 illustrates an exemplary replenish sequence diagram version 2 according to an embodiment;

FIG. 73 illustrates an exemplary source sequence diagram version 1 according to an embodiment;

FIG. 74 illustrates an exemplary source sequence diagram version 2 according to an embodiment;

FIG. 75 illustrates an exemplary On Road Assistance (ORA) use-case diagram version 1 according to an embodiment;

FIG. 76 illustrates an exemplary ORA use-case diagram version 2 according to an embodiment;

FIG. 77 illustrates an exemplary Online Real Estate Directory (O-RED) class diagram version 1 according to an embodiment;

FIG. 78 illustrates an exemplary O-RED class diagram version 2 according to an embodiment;

FIG. 79 illustrates an exemplary Hajj Online Services System (HOSS) use-case diagram version 1 according to an embodiment;

FIG. 80 illustrates an exemplary HOSS use-case diagram version 2 according to an embodiment;

FIG. 81 illustrates an exemplary Electronic Students' Academic Portfolio (ESAP) use-case diagram version 1 according to an embodiment;

FIG. 82 illustrates an exemplary ESAP use-case diagram version 2 according to an embodiment;

FIG. 83 is a block diagram illustrating an exemplary computing device according to an embodiment;

FIG. 84 is a block diagram of an exemplary data processing system according to an embodiment; and

FIG. 85 is a block diagram of an exemplary CPU according to an embodiment.

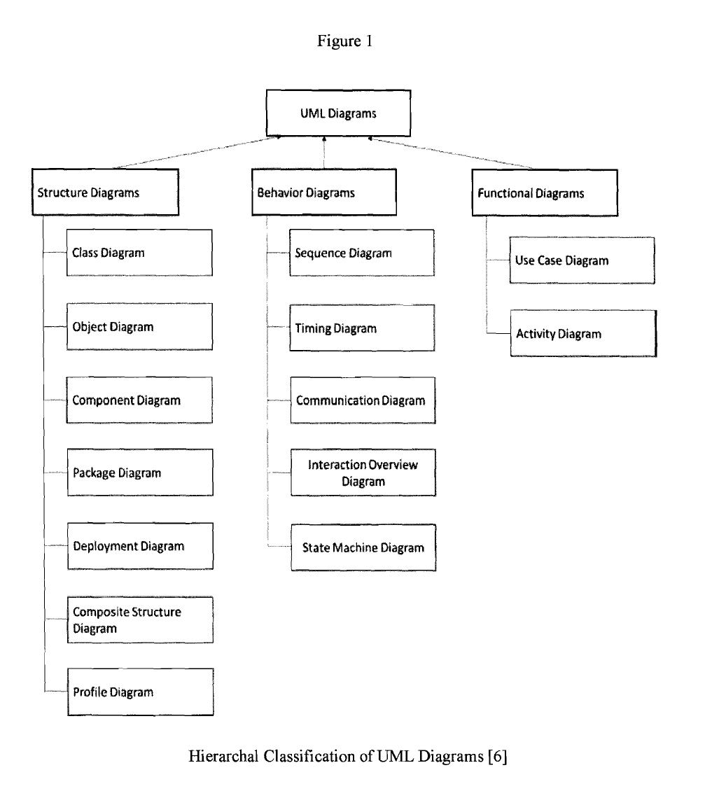

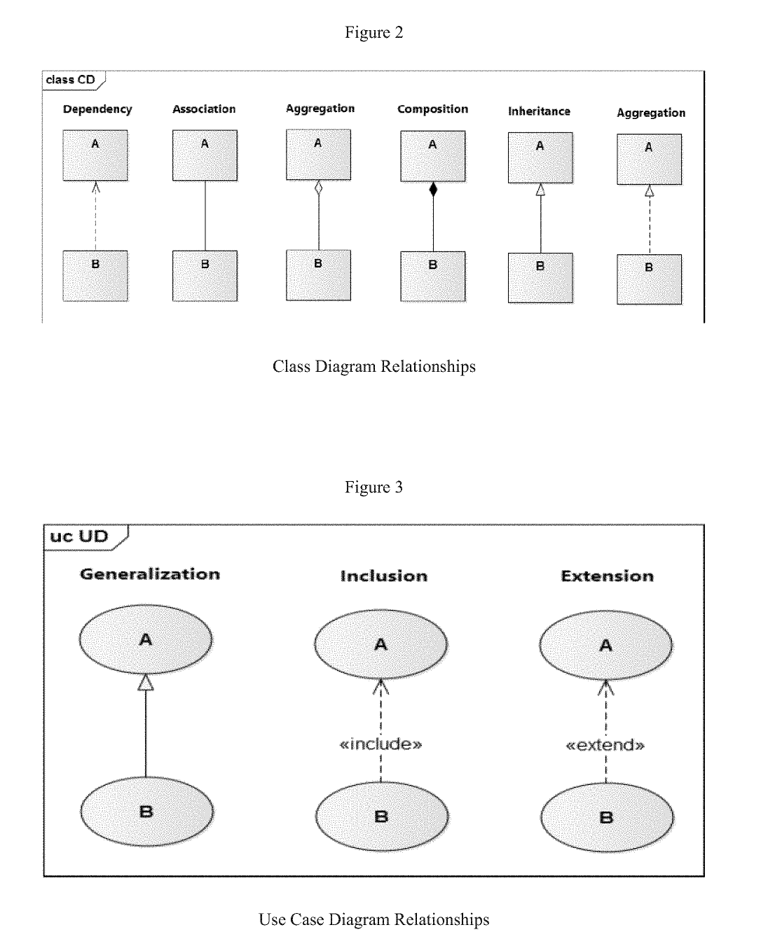

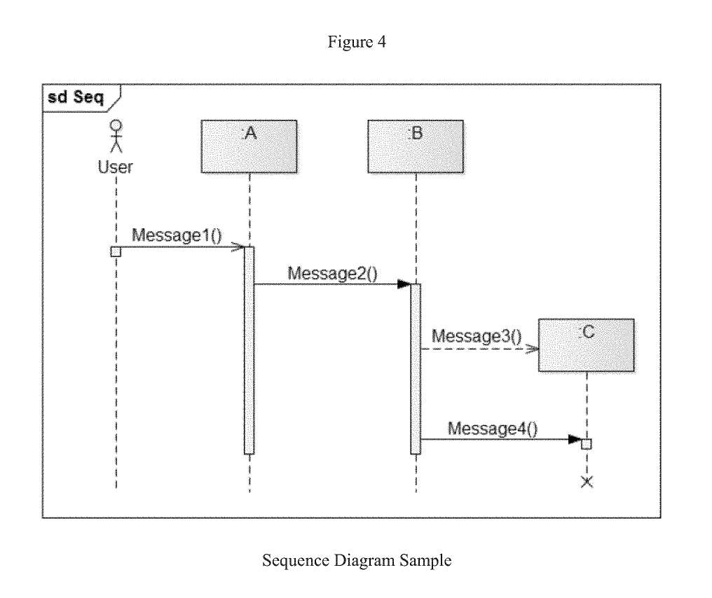

### DETAILED DESCRIPTION

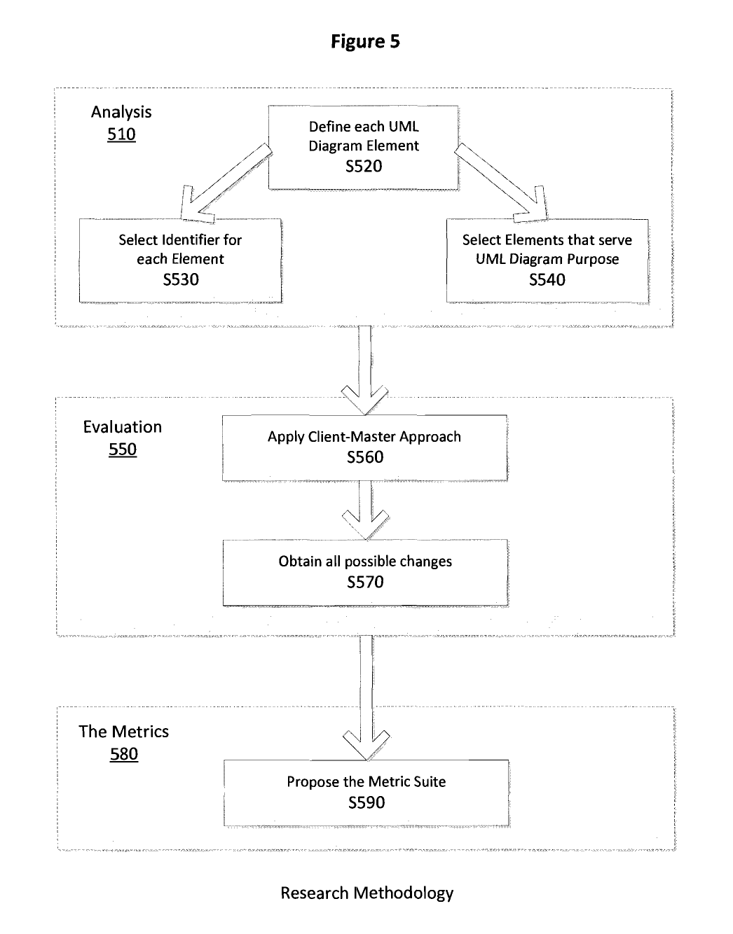

The methodology used to analyze and assess the stability of the UML diagrams is given herein. In accordance with a definition of stability, the unchanged percentage of the UML diagrams is computed. However, it can be difficult to determine which area of the UML has changed. On UML diagram elements, the decision process used to select which element is changed is dependent on the relationships with other elements. Therefore, there is a need to analyze each element and detect the parts that are affected by the external ones. The measurement process of UML diagrams uses three main steps: the analysis, the evaluation, and the proposal of a metric. FIG. 5 illustrates the assessment methodology.

The analysis 510 is the first part of the assessment methodology. Its purpose is to define each UML diagram element in step S520, such as identify the UML class diagram, the UML use-case diagram, and the UML sequence diagram. Each UML diagram element is selected along with an identifier for each UML diagram element in step S530.

All available information about each UML diagram is collected by identifying all the elements of the UML class diagram, the UML use-case diagram, and the UML sequence diagram, as well as the shapes of each element and the purpose behind that element.

The elements that serve the diagram's purpose are selected in step S540, and the elements that do not offer any meaningful information are skipped (not illustrated). All changes of the selected elements are tracked. The selection is based on:
Serving the meaning of the UML diagram.
No optional elements.

For example, in the UML class diagram, there is an element called comment. This element doesn't provide any structural meaning, so it is being skipped. The element's meaning was identified in order to decide whether to include them for assessment.

The UML diagram identifier is selected in step S530. This identifier enables tracking the changes from one version to another. The identifier of the elements is compared.

The evaluation 550 is the second part of the assessment methodology. An assessment approach called the client master approach was applied in step S560. This approach is used to precisely track changes in relationships.

A primary issue in following changes is to avoid computing the changes more than once, especially when the element has many relationships. This approach is used to indicate the client side and the master side of the relationship. The client element is the one that depends upon others and will be affected by them. The master element is a standalone element and is not affected by others. The purpose behind this approach is to avoid duplication or counting change twice. Change is counted for the client element.

An example of the UML class diagram is given for two classifiers A and B with an inheritance relationship, where B inherits A. If this relationship is changed or deleted, for example, what is the real effect that happened, which classifier is changed, and which classifier is unchanged? Based on a given approach, B represents the client side of the relationship and A represents the master side. If a deletion occurred, B is the affected element, and change is counted for it. A remains unchanged. Based on this approach, all possible change combinations are detected in step S570 to determine which UML diagram element is changed and which one remains unchanged.

The metrics 580 is the third part of the assessment methodology. A metric is proposed for the UML class diagram, the UML use-case diagram, and the UML sequence diagram in step S590. The metric is based on the assessment results and the selected identifier for each one of them. To measure a UML diagram stability, the property of each element is handled separately. Change to the base version is monitored.

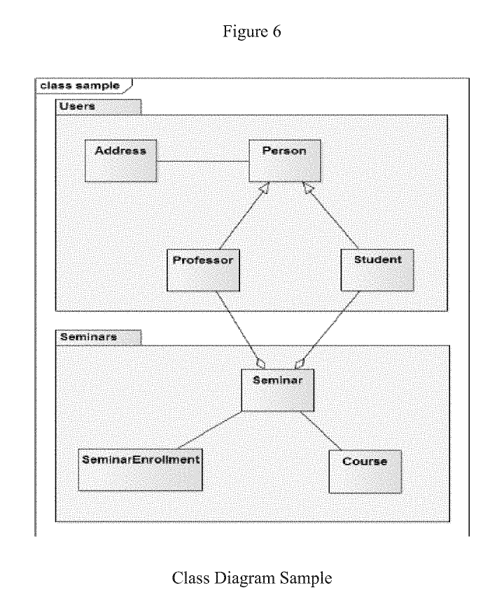

The evaluation and assessment of the UML class diagram and its structural stability metric are given herein. An example of a class diagram is illustrated in FIG. 6. A class diagram is made up of a collection of classifiers and the relationships among them. The client master approach is applied to track changes. The client role for each relationship property is tracked in a transition from a first state to a second state. In an example, a first state is an original version of a software product and a second state is a subsequent version of the software product. The classifier name is used as the identifier. The total amount of stability for a class diagram can be calculated as a function of the number of unchanged properties to the total number of classifiers.

A class diagram is used to express the system structure; therefore, all changes that may have any effect on the structure are tracked. A structural diagram gives a view of a system showing the structure of the objects, including their classifiers, relationships, attributes, and operations. Table 3 hereunder lists some of the possible relationship changes.

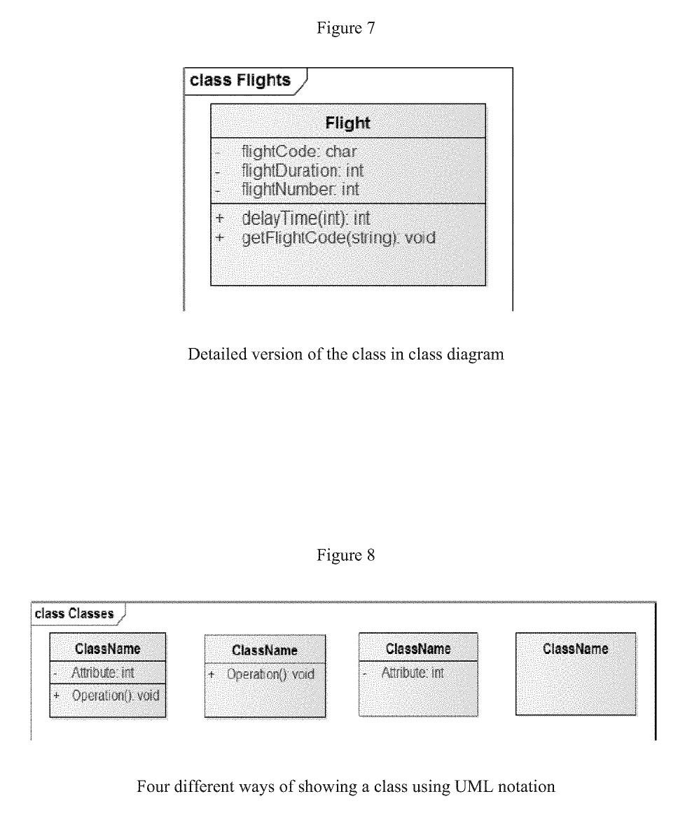

FIG. 7 illustrates an example of a classifier with the detailed design. The three blocks are a classifier name (for example, flight), attributes (for example, flightcode: char), and operations (for example, delayTime(int): int). A classifier is identified by its name. The name is the inference of the classifier existence. If version i has class name A, then in the next version there will only be two cases because either the class still exists or it is removed. The change is not captured in the class name. Renaming is not counted because it is uncertain whether the class has been renamed. It may be necessary to look into the methods and the attributes to determine if the classifier remains unchanged, or at least has the most attributes and methods. This process was not conducted for the following reasons.

Designers often use class as a word, and not as a classifier. However, a classifier is used herein as a general word to avoid dealing with two types of classifiers: the usual class and the interface. The change of a classifier type is tracked in order to avoid misunderstanding whether a classifier was used as a word.

Methods, variables, and parameters can give more details about a system. However, the detailed version of the classifiers in the class diagram is not always available. The second and third parts (i.e., the attributes and operations) of the classifier are optional sections, as illustrated in FIG. 8. System designers can hide these sections. If these sections are not shown, it does not necessarily imply that they are empty, but that the diagram is perhaps easier to understand with that information hidden. Thus, it cannot be assured that these parts are hidden or do not exist at all. Therefore, their treatment was omitted in order to be consistent with all diagram elements. Changes that may have occurred to these properties were not tracked.

Comment shapes are used to annotate class diagrams. Comment shapes exist only on the diagram surface, and they do not represent any structure or add any meaning to the class diagram. As implied by its name, it is just a comment to describe a class diagram and cannot exist in the code. There is no need to evaluate them, since they do not have any effect on the class diagram.

Grouping classifiers into packages gives meaning to the organization. Packages exist to manage the large systems by dividing them into a group of classifiers. Package classifiers usually represent a specific part of the system. However, this does not mean there is a change in class diagram structure before and after using packages. For example, as illustrated in FIG. 6, moving the Seminar classifier from the Seminars package to the Users package will not change the class diagram structure. Therefore, there is no need to evaluate the classifier according to the package name. When the class diagram stability is computed, the package content is normally dealt with, as if there were no packages.

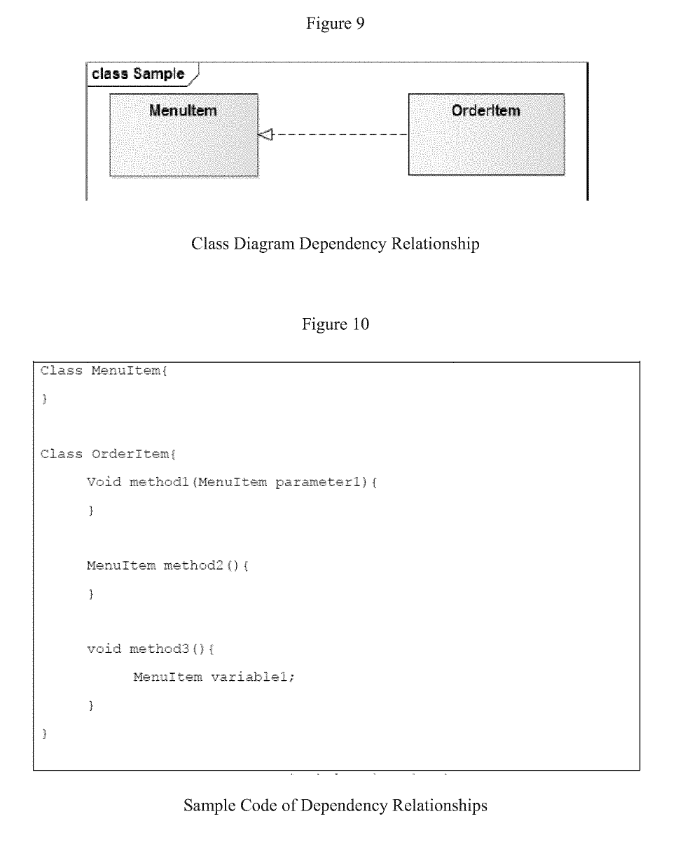

Dependency relationship declares that one classifier depends upon another classifier. FIG. 9 illustrates a sample diagram of a dependency relationship. The classifier MenuItem and the classifier OrderItem have a dependency relationship, if an object of one classifier might use an object of another classifier in the method definition. In this case, OrderItem uses MenuItem objects. The sample shows that the client classifier in this relationship is OrderItem, because it depends on MenuItem. And the master classifier here is MenuItem. MenuItem is a standalone classifier and does not depend on any other classifiers. Therefore, any change that may occur to the MenuItem will have a direct effect on OrderItem. In a dependency relationship, the client classifier is the one that depends on the other classifier.

FIG. 10 illustrates how this type of relationship can be converted into a code. The code shows that MenuItem is master because it is a standalone classifier. OrderItem uses MenuItem as a method parameter, as a method return type, or as a local variable. Therefore, it is a client in this case.

Table 3 illustrates the possible changes that may occur to the dependency relationship and their influence. The most affected one is classifier B in most cases. According to the approach, A is the master and B is the client. A will be affected if it is changed to depend on B, and this can happen in cases of a dependency relationship, an association relationship, if it aggregates or composes B's objects, or inherits or realizes B.

Since B is a client side, it is affected if any change occurs to A, such as if A is deleted or renamed, the relationship is deleted, or the relationship is changed to any type or any direction.

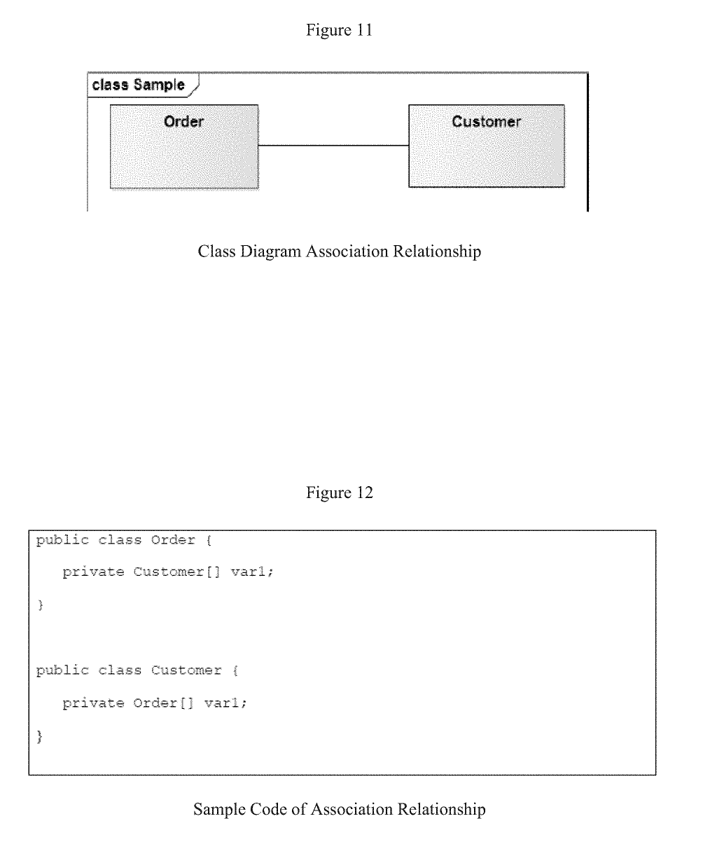

An association relationship declares that objects of each classifier depend upon the objects of the other. FIG. 11 illustrates a sample diagram of an association relationship. The classifier Order and the classifier Customer have an association relationship, if an object of one classifier might use an object of another classifier as a variable. In an association relationship case, the two classifiers are clients and masters at the same time. Order is a master because Customer uses its objects. It is a Client because it depends on Customer classifier objects. The same reasoning applies to the Customer. Any change that occurs to the Order will have a direct effect on the Customer, and vice versa. In an association relationship, the two classifiers are clients and masters at the same time.

FIG. 12 illustrates how this type of relationship can be converted into a code. Classifiers have a reference to an object of the other classifiers as attributes.

Table 4 illustrates the change possibilities of this relationship and their influence. The change of one classifier will affect the other, but the change that may happen to the relationship will affect the two classifiers.

Based on the approach, the two classifiers are clients A will be affected if the relationship is changed to a dependency, an inheritance, or realization, and if B aggregates or composes A's objects. B will be affected if the relationship is changed to dependency, inheritance, or realization, and if A aggregates or composes its objects.

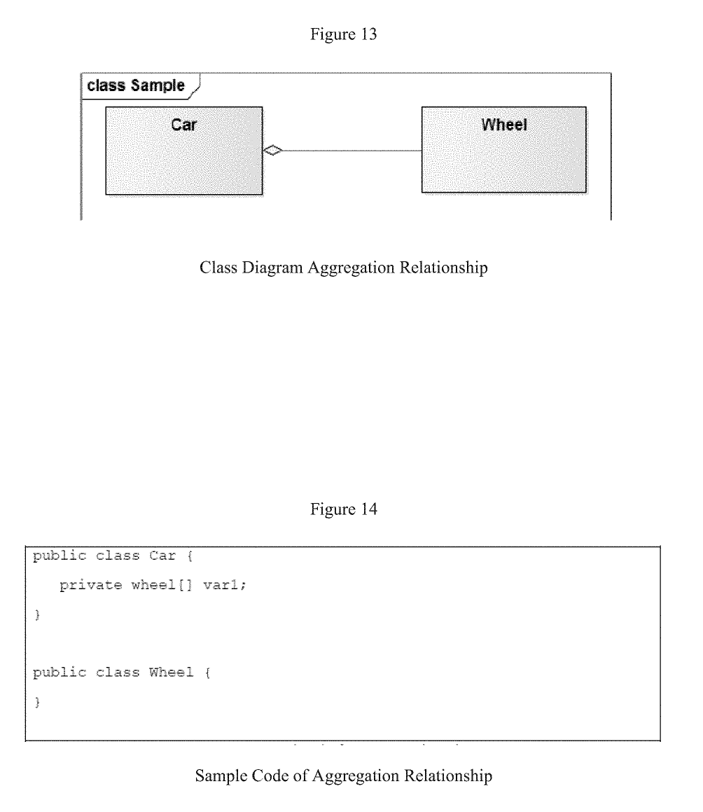

An aggregation relationship declares that one classifier (a classifier with the diamond edge) is aggregated by the other objects. FIG. 13 illustrates a sample diagram of an aggregation relationship. Classifier Car and classifier Wheel have an aggregation relationship if an object of Car aggregates an object of Wheel. Based on the client master approach, classifier Car (whole) is the client, and classifier Wheel (part) is the master. Car is the client because it uses Wheel objects. Wheel is a master class, because it does not depend on Car. The existence of Wheel does not depend on the classifier Car. Therefore, if any change occurs to the Wheel, this would affect the Car. In an aggregation relationship, the client classifier is the one that aggregates the other object; the other classifier is the master.

FIG. 14 illustrates how this type of relationship can be converted into a code. Classifier Car objects aggregate classifier Wheel objects, wherein Car owns Wheel objects. This is a one-way association, wherein the implementation code of the aggregation relationship is like the implementation code of the association relationship.

Table 5 illustrates the change possibilities of this relationship and their influence. According to the approach, A is the client, and B is the master. A will be affected in all change possibilities, except when the relationship is changed to composition.

Since B is in a master role, it is affected when it uses A's objects. This happens if the relationship is changed to a dependency, an inheritance, or a realizations, and it aggregates or composes A's objects.

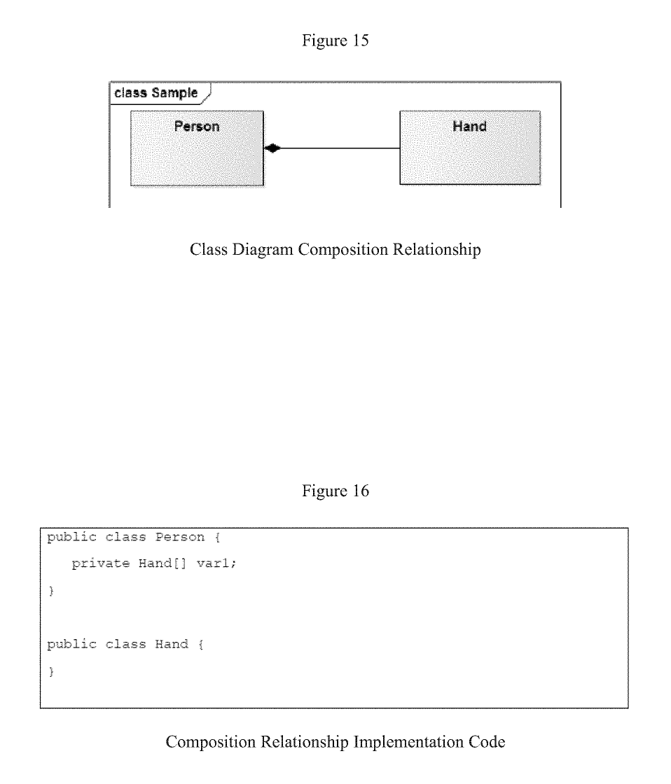

Composition declares that one classifier (a classifier with the diamond edge) composes the other objects. A composition is a stronger version of aggregation. FIG. 15 illustrates a sample diagram of a composition relationship. Classifier Person and classifier Hand have a composition relationship, if Person aggregates the Hand object. Hand objects cannot be aggregated by classifiers other than Person objects. The two classifiers are clients in this case. Person (a whole classifier) is a client because it uses Hand objects. Also, Hand (a partial classifier) is a client classifier because its existence depends on Person. The Hand is actually part of Person itself and will not usually be shared with other parts of the class diagram. Therefore, if Person is deleted, its corresponding parts are also deleted. Any change occurring to one of the classifiers would affect the other classifier. In a composition relationship, the two classifiers are clients and masters at the same time.

FIG. 16 illustrates how this type of relationship can be converted into a code. The main difference in this case is that Hand's existence depends on Person's existence. It is also a one-way association. The implementation code of the composition relationship is like the implementation code of the association relationship.

Table 6 illustrates the possible changes of this relationship. Based on the client master approach, A is the client and B is the master. A will be affected in all change possibilities, except when the relationship is changed to aggregation. Since B is in a master role, it is affected when it uses A's objects. This occurs if the relationship is changed to a dependency, inheritance, or realization, and aggregates or composes A's objects.

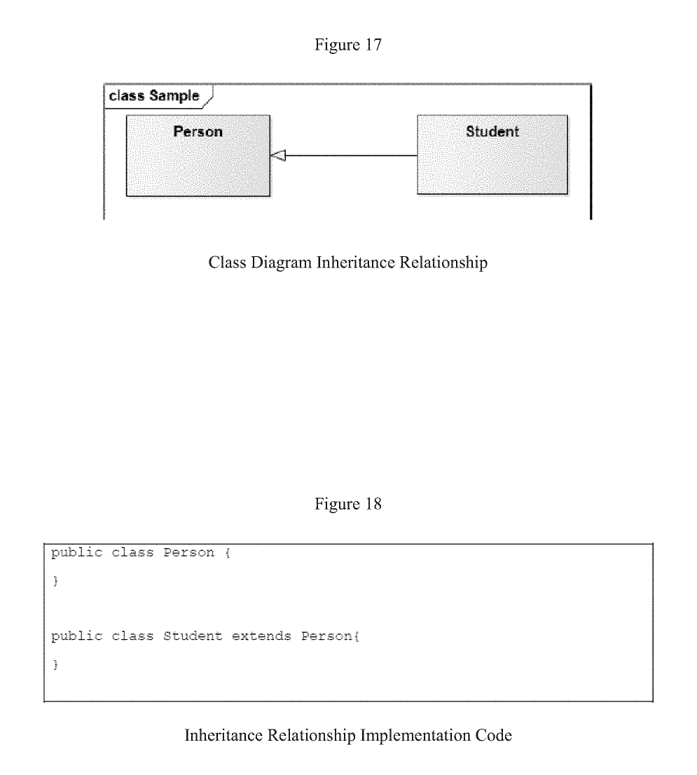

An inheritance relationship occurs when one classifier is a type of another classifier. FIG. 17 illustrates a sample diagram of an inheritance relationship. The Person classifier and the Student classifier have an inheritance relationship if one classifier is a type of the other classifier. Based on the client master approach, Person is the master classifier and Student is the client. The Student is a client classifier because it depends on Person. Therefore, if any change occurs to the Person classifier, this might affect the Student classifier. In an inheritance relationship, the super-classifier is the master, and the sub-classifier is the client.

FIG. 18 illustrates how this type of relationship can be converted into a code. Student extends the class Person. In other words, Student is a type of Person and inherits all its attributes and methods that are declared

Table 7 illustrates the change possibilities of this relationship and their influence. According to the approach, A is the master and B is the client. A will be affected if it is changed to depend on B. This can occur in cases of a dependency relationship or an association relationship, if A aggregates or composes B's objects, or if A inherits or realizes B. Since B is in a client role, it is affected if any kind of changes occur.

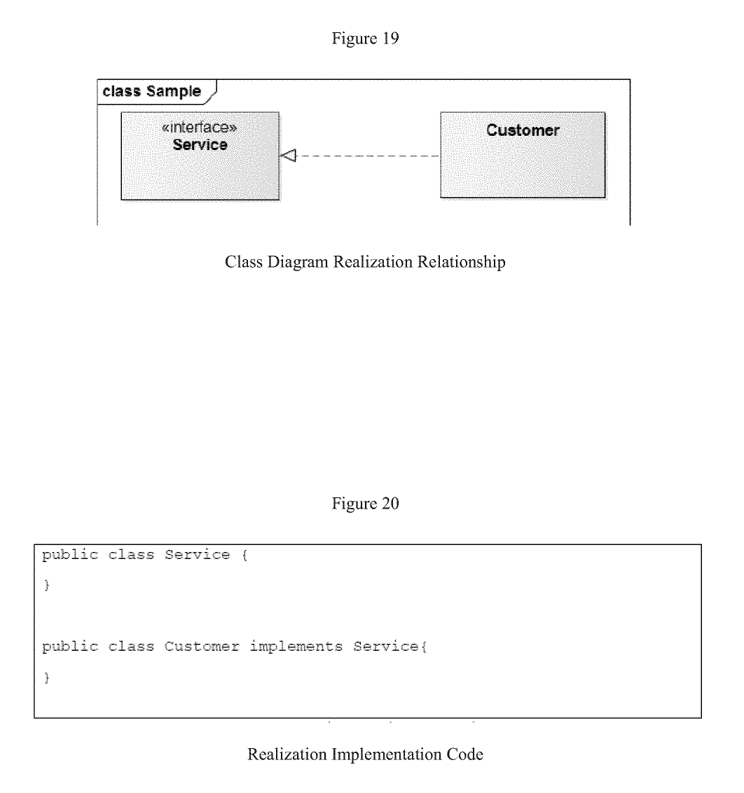

A realization relationship occurs when one classifier is realized by another classifier. FIG. 19 illustrates a sample diagram of a realization relationship. Classifier Service and classifier Customer have a realization relationship if one classifier has implemented the other classifier's methods. Using the client master approach, the master classifier is the one that others realize (a classifier with an arrowhead), which is called the interface classifier. The other classifier is the client. Any change occurring to the master classifier would affect the other classifier. In an example, Service is the master, and Customer is the client. Customer is a client because it realizes the Service classifier. Therefore, if any change occurs to the Service, it might affect the Customer. In a realization relationship, the client classifier is the one that realizes the other object. The other classifier is the master.

FIG. 20 illustrates how this type of relationship can be converted into a code. Service implements the Customer. In other words Service implements all the methods that are declared in the Customer classifier.

Table 8 illustrates the change possibilities of this relationship and their influence. Based on the approach, A is the master and B is the client. A will be affected if it is changed to depend on B. This occurs for a dependency relationship or an association relationship, or if A aggregates or composes B's objects, or if A inherits or realizes B. B is affected if any kind of change occurs.

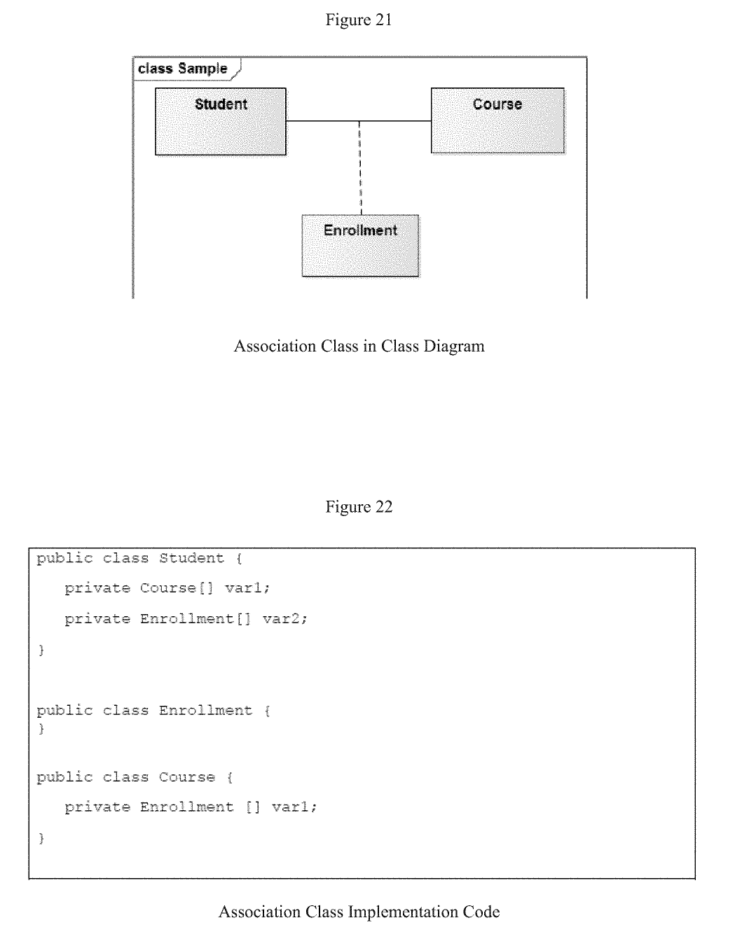

Classes can be introduced by an association itself. Association classes are particularly useful in complex cases to show that a class is related to two classifiers because those two classifiers have a relationship with each other. In FIG. 21, the association relationship between Student and Course results in an association relationship with a set of objects in classifier Enrollment. Based on the approach, Student and Course are still master and client at the same time. The new classifier is also a client and a master, Student and Course used it, and its existence depends on the relationship. In association classes, all the partners are clients and masters at the same time.

FIG. 22 illustrates how this type of relationship can be converted into a code. Classifiers have a reference to an object of the other classifier as an attribute.

Table 9 illustrates the change possibilities of this relationship and their influence. Classifier A is affected by this type of relationships if B is changed, deleted, or renamed, or if an association class is emerging. B is affected in the case of delete A or delete C, or an association class is emerging.

The classifier name was selected as an identifier since it is the most appropriate property. The possible changes in the identifier are deletion and renaming. Renaming cannot be detected. Therefore, only the unchanged aspect was addressed.

The following selected elements and attributes were evaluated and tracked for any changes:
Classifiers name.
Classifiers type.
Dependency relationship.
Association relationship.
Aggregation relationship.
Composition relationship.
Inheritance relationship.
Realization relationship.

The following terminologies and formalisms were used during stability computation.

Definition 1 (CLASSIFIER). Let the class diagram classifiers be denoted by C. The same classifier can have different versions based on different class diagram versions. Let Cᵢ denote the classifier C in the class diagram version i, where iε[1.n].

Definition 2 (CLASSIFIER PROPERTIES). Let P(Cᵢ) denote the set of all properties of the classifier C in the class diagram version i

Definition 3 (CLASSIFIER TYPE). Let the classifier type in the class diagram be denoted by CT. The same classifier can have different values based on different class diagram versions.

Definition 4 (NUMBER OF CLASSIFIERS OF CLASS DIAGRAM BASE VERSION). Let NC represent the number of classifiers in the class diagram base version.

Definition 5 (CLASSIFIER PROPERTIES CHANGE). Let changes that may happen to any classifier be denoted by Ch. Ch represents any change in classifier properties from the class diagram base version to any other class diagram version.

Definition 6 (CLASSIFIER CHANGES)

CC is the percentage of class diagram classifier changes.

Definition 7 (NUMBER OF UNIQUE PROPERTIES). The classifier in the class diagram has different properties. These properties represent the classifier type and its classifier relationships with other classifiers. Let the number of unique properties be denoted by NUP.

Definition 8 (CLASSIFIER RELATIONSHIPS).

Let classifier relationships be denoted by CR.

Definition 9 (NUMBER OF UNIQUE CLASSIFIER RELATIONSHIPS). Let the number of unique classifier relationships in the class diagram classifier be denoted by NUCR.

Definition 10 (STRUCTURAL STABILITY)

SS is the percentage of structural stability.

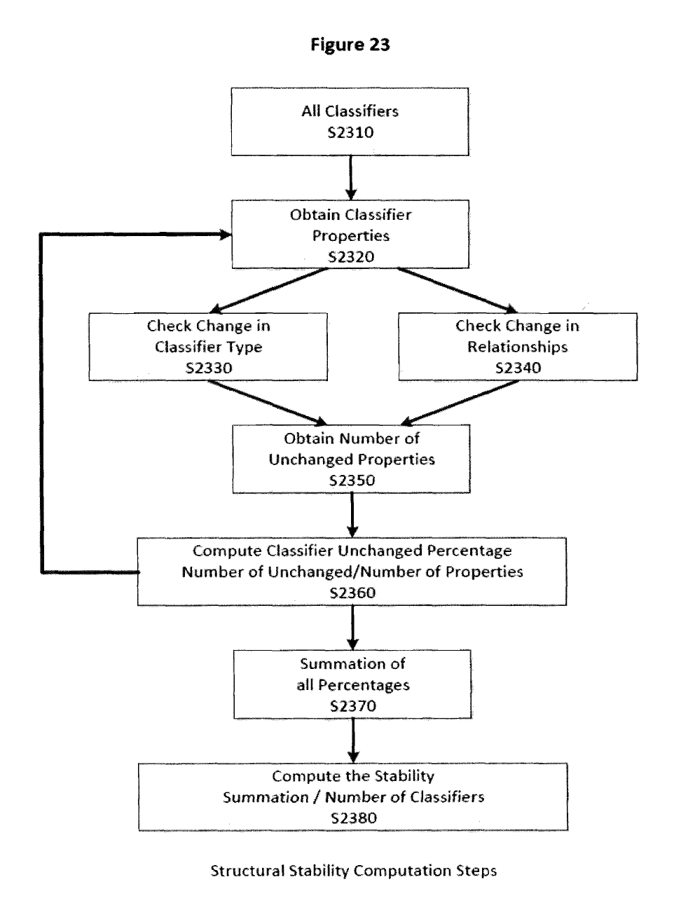

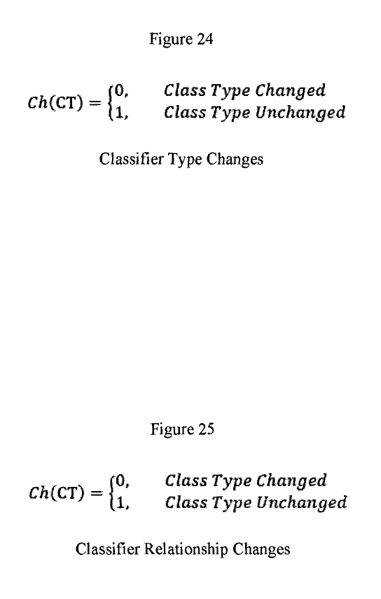

To measure class diagram stability, each classifier property was handled separately to look for a change in the base version. FIG. 23 illustrates the computation steps of computing a structural model stability metric. The measurement of the class diagram stability was implemented using the following steps.
1. A plurality of classifiers are obtained for a class diagram in step S2310, in which a first state of a class diagram including a first plurality of classifiers is obtained and a second state of the class diagram including a second plurality of classifiers is obtained. One or more classifier type properties and one or more relationship properties are identified for the first state of the class diagram and the second state of the class diagram in step S2320. A master role or a client role is assigned to each of the plurality of classifiers. A property change metric is developed that measures the transformations of each classifier property. Property transformation is tracked for classifier type changes in step S2330 and illustrated in FIG. 24. Property transformation is tracked for classifier relationship changes in step S2340 and illustrated in FIG. 25.
2. The number of unchanged properties is obtained in step S2350 based on the tracking of classifier type transformations and relationship transformations in steps S2330 and S2340, respectively. The summation of all property transformation metrics is counted and divided by the number of classifier unique properties, Equation 4.1 (given here under) in step S2360. Unique properties for each classifier are the number of unique classifier relationships plus one (one denoted for classifier type). Dividing by the number of unique classifier properties will normalize the classifier changes, wherein the result is between zero and one. One means all classifier properties have been changed from the i version to the i+1 version.
3. The summation of all classifier transformation metrics is counted in step S2370. The summation is divided by the number of class diagram base version classifiers in step S2380. Dividing by the number of base version classifiers will normalize the result to be between zero and one. One means all class diagram classifiers have been changed from the i version to the i+1 version.
4. The overall class diagram stability metric is computed using Equation 4.2 (given here under). The final value is also normalized. Zero means all classifiers have been changed from version i to version i+1. Thus, version i+1 is unstable. On the other hand, one means nothing has been changed. Therefore, version i+1 is completely stable.

In an embodiment, the class diagram stability metric could be used in an alert system, which alerts a user via a network or the Internet about the metric status, such as the metric being above or below an acceptable threshold. This would allow a user to instantaneously check the new state of the class diagram and make changes to the class diagram, if needed. An exemplary alert system could include a transmission server with a memory that receives the first state and the second state of the class diagrams from a data source. Further, a circuitry (for example, on the transmission server) may perform all the method steps described in FIG. 23 (i.e., determining the differences between the first state and the second state of the class diagram and calculating a metric). Afterwards, the transmission server generates an alert (that can include information regarding the calculated metric, the changes that were made to the second state of the class diagram, or any information relating to the class diagrams), formats the alert into data blocks according to a specific data format (possibly based on previously stored information regarding a user—for instance, the alert can be formatted differently based on which user is supposed to receive the alert), and transmits the formatted alert over a network to a wireless device associated with a user computer. The alert activates an application of the user computer to cause the alert to be displayed on the user computer. The alert also enables a connection via a URL to the data source over the Internet (or any other network) when the wireless device is locally connected to the user computer and the user computer comes online.

Further, the alert can also include a detailed report of the differences between the first state and the second state. Such differences can be presented to a user to allow the user to visually distinguish between the first state and the second state and make appropriate changes. In response to the alert, a user may make changes to the second state to generate a third state. The third state may then be compared with the first state to determine the differences between the third state and the first state and a corresponding stability metric can be calculated.

Additionally, the alert can be received as an electronic communication and can be stored in a memory. The alert can be parsed to extract the first state and/or the second state. The alert can also be parsed to extract only the differences between the first state and the second state. The extracting can further include scanning the electronic communication for a marker indicating the positions of the information contained in the alert (the alert can include any information relating to class diagrams). The extracting of the electronic communication can also include flagging each scanned byte between markers, and creating a new data file that includes some of the information contained in the electronic message. The markers can indicate demarcations between different pieces of information in the electronic message. The new data file can be created to include only some information from the alert (i.e., not all the information received in the alert), thereby allowing a user to focus on information that the user thinks is of particular importance. In other words, a user preference can be stored in a memory that determines the types of information to be included in the new data file. Alternatively, the new data file can be created based upon predefined rules. After the new data file has been created, the other information (i.e., information in the electronic message corresponding to the alert that was not included in the new data file) can be deleted.

Alternatively, the alert message (or the electronic communication) could include a hyperlink that, when selected by a user, directs the user, via the world wide web, to a website that includes a modeling application (i.e., application used to model the diagrams described in the present disclosure). In such a scenario, the user does not need to install a modeling application on his/her computer and can make any changes to the first state or the second state by accessing a modeling application through an Internet connection. By including a particular hyperlink, the method can make sure that all the users are accessing and making changes within a central area (for example, on the cloud).

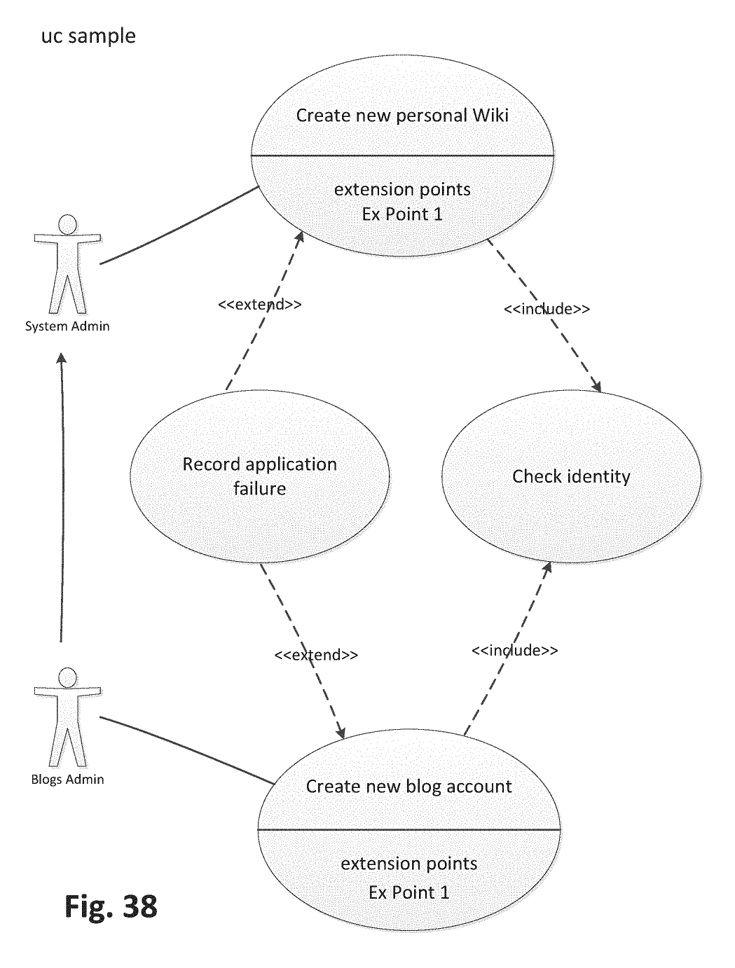

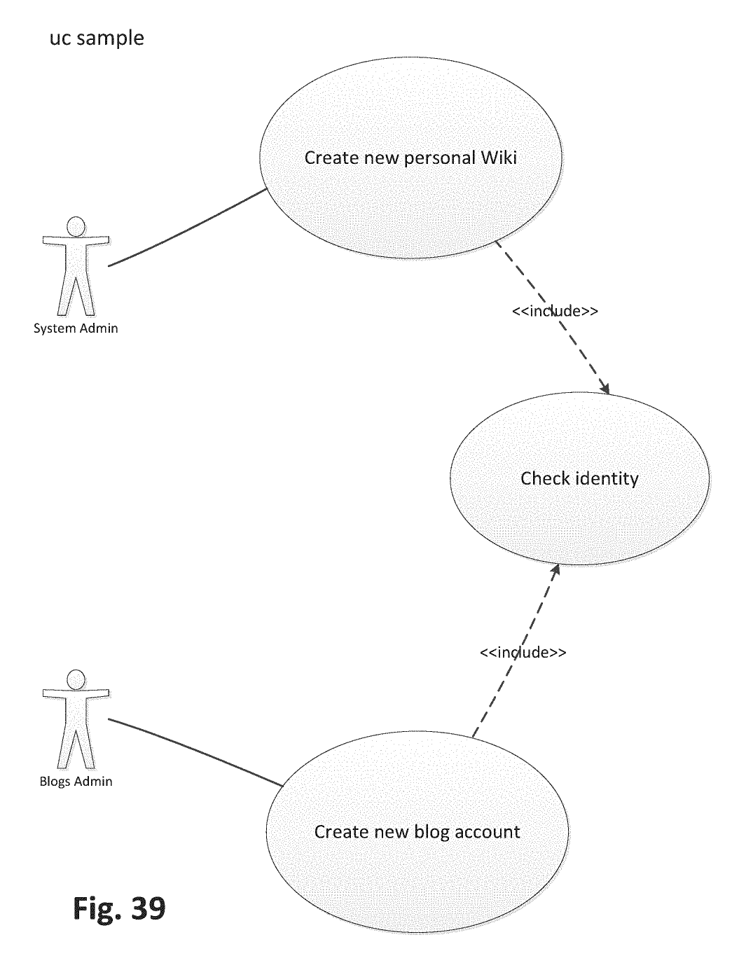

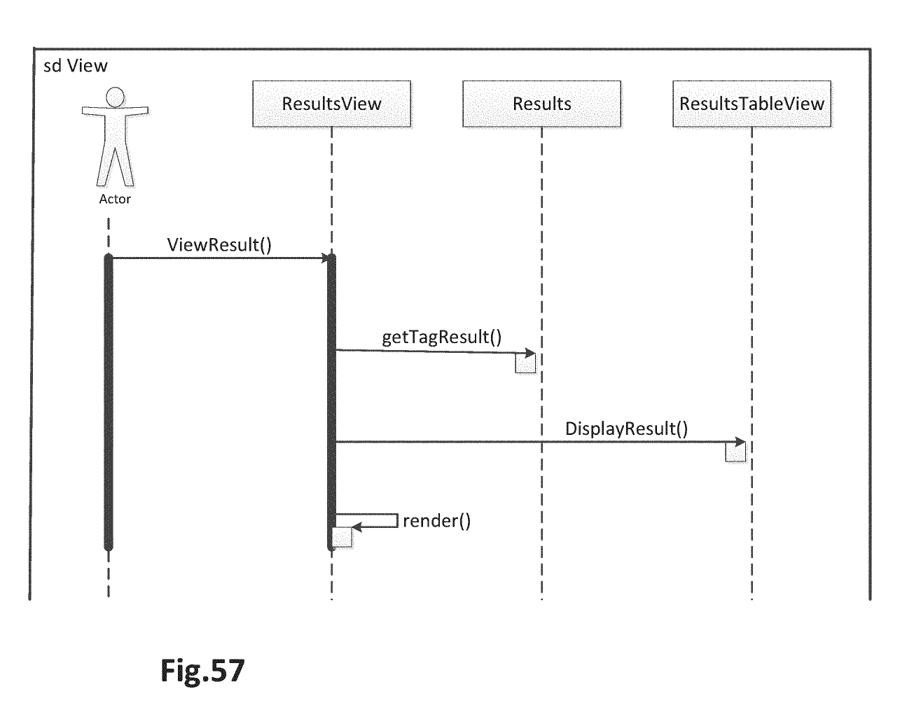

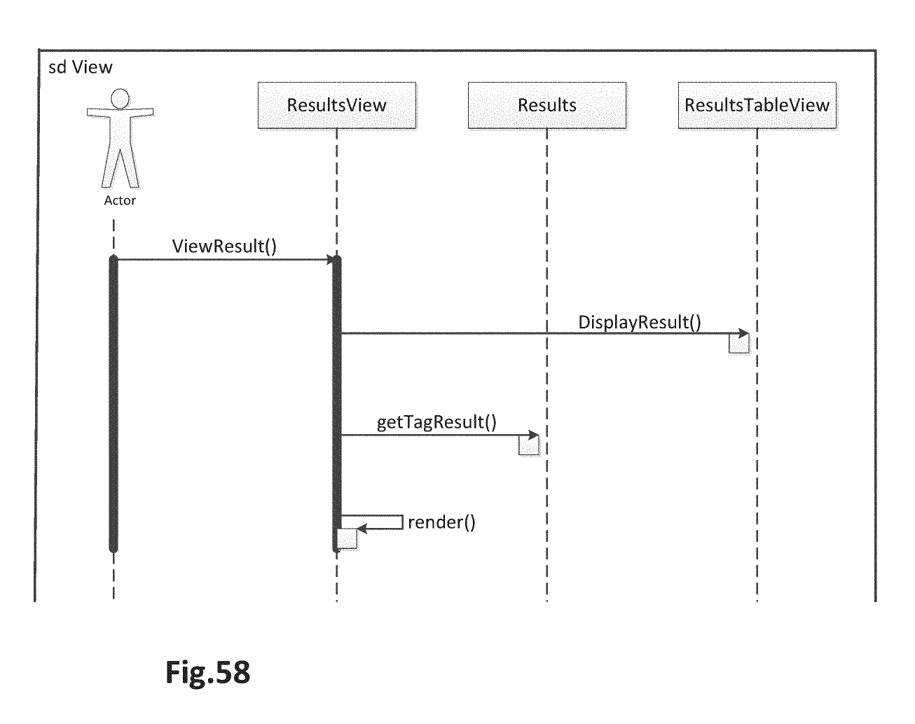

Although the above description regarding the alert messages is provided with respect to class diagrams, it should be understood that the above-noted description can be used with regard to any of the diagrams (for example, with regard to use-case diagrams in FIGS. 38 and 39, with regard to sequence diagrams in FIGS. 57 and 58, etc.) described in different embodiments of the present disclosure. In another embodiment to the method illustrated in the flowchart of FIG. 23, a programmed computing device comprises circuitry, wherein the circuitry is configured to obtain a first state of a class diagram including a first plurality of classifiers and a second state of the class diagram including a second plurality of classifiers, and identify one or more classifier type properties and one or more relationship properties for the first state of the class diagram and the second state of the class diagram. The circuitry is also configured to track a transformation in the one or more classifier type properties from the first state of the class diagram to the second state of the class diagram. The circuitry is also configured to track a transformation in the one or more relationship properties from the first state of the class diagram to the second state of the class diagram. The circuitry is also configured to calculate the structural model stability metric for the second state of the class diagram as a ratio of a percentage of unchanged classifier type properties from the first state to the second state plus a percentage of unchanged relationship properties from the first state to the second state to a total number of the first plurality of classifiers in the first state of the class diagram. The circuitry is also configured to transmit an alert message to a user when the structural model stability metric is equal to or less than a predetermined threshold. In an embodiment, the second state of the class diagram is transformed from a model level to a source code level. Such a transformation from a model level to a code level can be performed based on whether the calculated stability metric (i.e., any of the metrics described in the present disclosure) is above or below a predefined threshold. The circuitry can be specially programmed to perform the above-noted method and can be located on a server, a user computer, the cloud etc.

In yet another embodiment, a non-transitory computer-readable medium has computer-executable instructions embodied thereon, that when executed by a computing device, performs the method described above and illustrated in FIG. 23. In still another embodiment, an electronic chip includes circuitry configured to perform the method described above and illustrated in FIG. 23.

To count the changes that occur to the classifier properties, it is necessary to check first if the classifier is still in version i+1 or not. This is done using the selected identifier. If the identifier was deleted, the classifier change value would be the maximum value of one. Otherwise, each classifier property change is computed according to FIG. 24 and FIG. 25.

FIG. 24 illustrates classifier type changes. Zero means the classifier type remains unchanged. One means that the classifier type is changed, either from class to interface, or from interface to class.

FIG. 25 represents classifier relationship changes. The change counts as one in two cases: if the relationship is deleted or if it is changed to another type. The change will be zero if the relationship remains unchanged.

$$UCC = \frac{Ch ( CT ( i , i + 1 ) ) + {\sum }_{CR = 1}^{NUCR} Ch ( CR ( i , i + 1 ) )}{NUP} \qquad 4.1$$

UCC is an abbreviation for Unchanged in Classifier. This metric computes the unchanged properties of each classifier, which equals the summation of classifier type changes and all relationship changes over the number of unique properties.

NUCR is the abbreviation for the Number of Unique Classifier Relationships in the class diagram classifier.

CR is the abbreviation for Classifier Relationship.

CT is the abbreviation for Classifier Type.

NUP is the abbreviation for Number of Unique Properties. NUP=(NUCR+1), where 1 represents the classifier type.

i: a class diagram version

$$SS ( i + 1 ) = \frac{{\sum }_{C = 1}^{NC} UCC ( C )}{NC} \qquad 4.2$$

SS is an abbreviation for Structural Stability. This metric computes the stability of the class diagram, which equals the summation of all classifiers' change over the number of base version classifiers, and the value is subtracted from one.

C is the abbreviation for Classifier.

CC is the abbreviation for Classifier Change.

NC is the abbreviation for Number of Classifiers in the base version.

The following example illustrates the steps to measure class diagram stability.

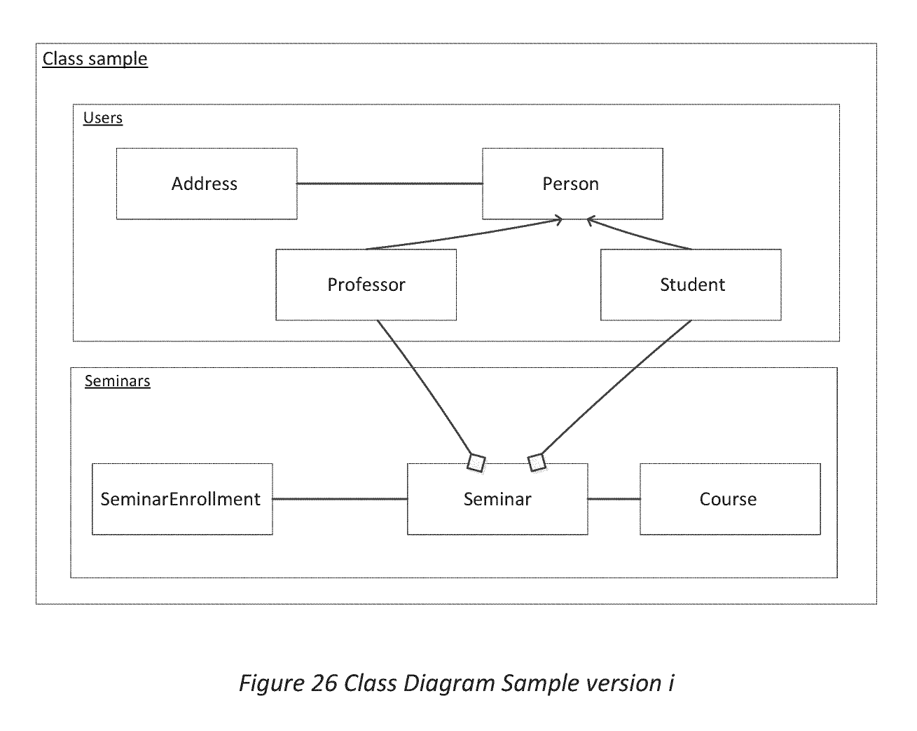

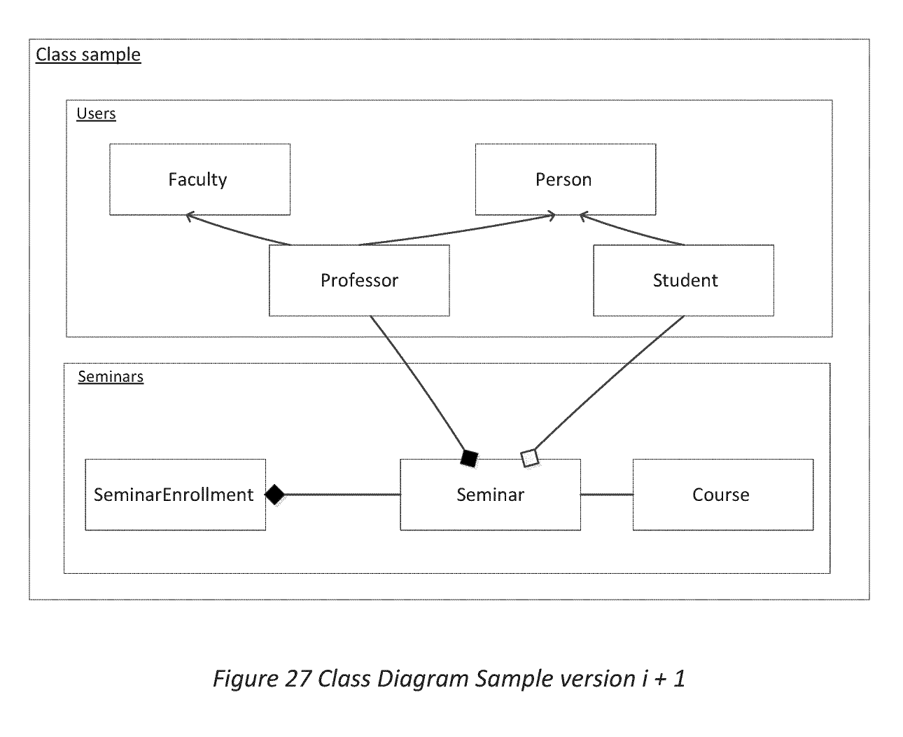

FIG. 26 illustrates version (or state) i of a sample class diagram, and FIG. 27 illustrates version (or state) i+1 of the same sample of a class diagram.

Table 10 illustrates the classifier properties for each version. Table 11 illustrates the calculation of all the unchanged properties from sample class diagram version i to sample class diagram version i+1.

TABLE 10
Each Classifier Properties

| Identifier | Properties | version i Data | version i + 1 Data |
|---|---|---|---|
| Person | Classifier Type | Class | Class |
| | Relationships | Address-Association | — |
| Address | Classifier Type | Class | Deleted |
| | Relationships with | Person-Association | |
| Professor | Classifier Type | Class | Class |
| | Relationships | Person-Inheritance | Person-Inheritance |
| | | — | Faculty-Inheritance |
| Student | Classifier Type | Class | Class |
| | Relationships | Person-Inheritance | Person-Inheritance |
| Seminar | Classifier Type | Class | Class |
| | Relationships | Professor-Aggregation | Professor-Composition |
| | | Student-Aggregation | Student-Aggregation |
| | | Course-Association | Course-Association |
| | | SeminarEnrollment- | — |
| | | Association | |
| Course | Classifier Type | Class | Class |
| | Relationships | Seminar-Association | Seminar-Association |
| Enroll- | Classifier Type | Class | Class |
| mentSeminar | Relationships | Seminar-Association | Seminar-Composition |

TABLE 11
Changes From version i to version i + 1

| | | No. of | | |
|---|---|---|---|---|
| | | Unique | Unchanged | Unchanged |
| Identifier | Changes | Properties | Value | Average |
| Person | Address-Association DELETED | 2 | 1 | 0.5 |
| Address | CLASSIFIER DELETED | 2 | 0 | 0 |
| Professor | — | 3 | 2 | 0.6 |
| Student | — | 2 | 2 | 1 |
| Seminar | Professor[Aggregation => | 5 | 3 | 0.6 |
| | Composition] | | | |
| | SeminarEnrollment-Association | | | |
| | DELETED | | | |
| Course | — | 2 | 2 | 1 |
| Enroll- | Seminar[Association => | 2 | 1 | 0.5 |
| mentSeminar | Composition] | | | |

$$SS ( i + 1 ) = \frac{0.5 + 0 + 0.6 + 1 + 0.6 + 1 + 0.5}{7}$$

$$SS ( i + 1 ) = 0.6$$

The 0.6 means that version i+1 of the sample class diagram's stability is 60%; in other words version i+1 kept 60% of the version i structure, elements, and attributes. Sixty percent of classifiers and relationships remain in the next version.

The evaluation and assessment of the UML use-case diagram and its functional stability metric are given herein. A use-case diagram is made up of a collection of actors, use cases, and relationships between and among them. Functional diagrams emphasize the flow of control and data among the things in the system being modeled. The client master approach was applied to track changes. A master role and a client role were applied to each actor and each use case in a relationship. Change was calculated by tracking the client roles in the use-case diagram. Either the actor name or the use-case name was used as the identifier in the use-case diagram. A use-case diagram was used to represent system functionality. Therefore, all of the properties that may affect the functionality of the system were tracked.

The actor is a part of the system functionality. It is the one which initiates the use case. An actor doesn't need to be a human user, wherein any external system element outside of the use case may trigger the use case. The actor is not always used to trigger use case (send data), but it can receive data also. The actor can have a relationship with another actor or with a use case. The actor name was selected as one of the identifiers.

From the actor information, only its name is involved in change assessment. The actor representation part is neglected because it does not have any functionality meaning. The actor can be identified by its name only. Therefore, if the actor name is changed, the original name cannot be recognized. In this case, the actor is dealt with by considering if it is deleted and if a new actor is emerging.

Use case is used to represent the functionality of a system. It describes what a system does, but it does not specify how it does it. Use case typically represents a major piece of functionality. It is a description of a set of sequential actions, including variants that a system performs to yield an observable result to an actor.

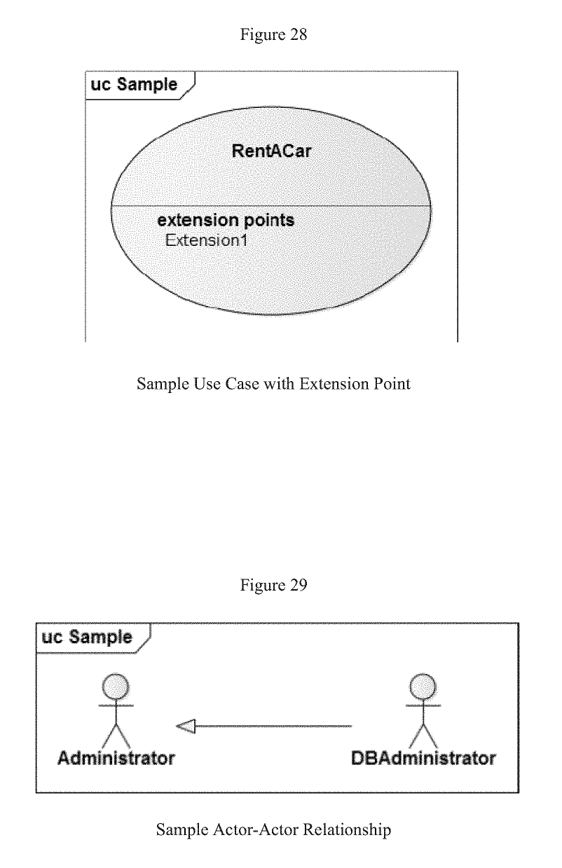

FIG. 28 illustrates a sample use case. The information that can be provided by the use case is the use-case name (i.e., RentACar) and the use-case type (i.e., extension points). The use-case name is used as a description of a functionality. In the example of FIG. 28, the use-case name RentACar indicates a specific system functionality, which is a car rental. The type means whether it has an extension point or is just a normal use case. A use case with an extension point is used when the use case is extending another use case. In the example, an extension1 shows the extension information with other use cases.

The use-case name and the use-case type are involved in the use-case diagram assessment. The use-case name is used as an identifier in comparison. Any change in the name cannot be recognized. For example, if the name was changed to CarRental, there are no indicators that they were the same functionality. Therefore, renaming is not considered. Use case is addressed as either being added or deleted. It cannot be certain that the use case has been renamed. Use case can be represented by different shapes. However, this representation is neglected and does not provide any functionality meaning.

Table 12 illustrates the possible changes with new relationships. A or B is affected if they included another use case, extended another use case, or used another use case as a general one.

TABLE 12
Possible Use Case Changes

| | The | |
|---|---|---|
| | Affected | |
| Change Type | Use Cases | Justification |
| A includes B | Use Case A | A will be changed to depend B. |
| | | B is a standalone use case. |
| B includes A | Use Case B | B will be changed to depend on A. |
| | | A is a standalone use case. |
| A is an extension | Use Case B | A is a standalone. Therefore, |
| to B | | because of the relationship, an |
| | | extension point emerges in B. |
| B is as extension | Use Case A | B is standalone. Therefore, |
| to A | | because of the relationship, an |
| | | extension point emerges in A. |
| A is a generalization | Use Case B | B will be changed to depend on A. |
| of B | | A is complete on its own. |
| B is a generalization | Use Case A | A will be changed to depend on B. |
| of A | | B is complete on its own. |
| A is as association | — | Use case A will not be changed. |
| Actor | | |

The use of the system boundaries herein is for the purposes of organization only. The boundaries are represented in a generic sense using a simple rectangle, with the name of the system at the top. If a designer decides to use or not use system boundaries when designing the system, it will not change any system functionality. Therefore, system boundaries will be excluded from the assessment.

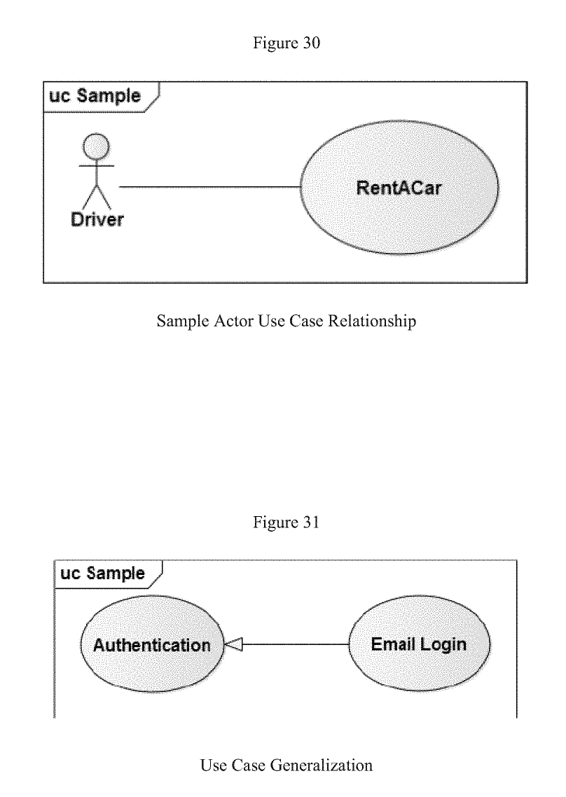

The actor has two kinds of relationships, wherein one relationship is a relationship with another actor, as illustrated in FIG. 29. The second relationship is the relationship with the use cases, as illustrated in FIG. 30.

Actors can be generalized similar to other classifiers Actor generalization is typically used to pull out common requirements from several different actors to simplify modeling. Generalization is attained by creating a generic actor to capture the common functionality, and then specialize it to identify the unique needs of each actor. The relationship can be represented by drawing a solid line, with a closed arrow pointing from the specialized actor to the base actor In FIG. 29, Administrator represents the master side of this relationship Any change which happens to this actor will affect the DBAdministrator, which is a client in this relationship. The possible changes that may happen in this case are the deletion of the actor Administrator or the deletion of the relationship itself. These changes will have a direct effect on the DBAdministrator actor. Another possible change is the deletion of the existing relationship, where a reverse relationship will emerge instead. In this case both actors are affected by this change. In an actor-actor relationship, the general actor is the master actor, and the specialized actor is the client actor.

The second relationship, as illustrated in FIG. 30, deals with the use cases. The actor can be associated with one or more use cases. This relationship is represented by a solid line. A relationship between an actor and a use case indicates that the actor initiates the use case, or the use case provides the actor with results, or both. FIG. 30 illustrates a sample relationship between an actor and a use case. In this relationship, both the Driver actor and RentACar use case are clients. For the RentACar use case, it represents a client role because its initiation is based on the actor. Therefore, changing the actor to another actor will lead to a different functional meaning.

The actor can be used to send data or receive data. Sometimes it is uncertain which role the actor is playing. However, the case needs to be considered when the actor receives data. Therefore, the actor needs to be involved in the assessment. The actor represents a client role in this relationship.

Use cases are usually depicted in a standard way in drawing and reading, which is from left to right. The actors initiating use cases are on the left and actors that receive use case results are on the right. However, depending on the model or level of complexity, it may make sense to group actors differently. Therefore, the standard convention cannot be relied upon because it cannot differentiate between the imitating actors and receiving actors. Therefore, all actors will be dealt with as clients when they communicate with use cases. In the actor use case relationship, the use case and the actor are clients.

Table 13 and Table 14 illustrate the possible changes in the actor-use case relationships and actor-actor relationships. Using the client master approach, the Actor and use case A are clients. A will be affected if the actor is changed to another actor or deleted, or if the relationship itself is deleted. The Actor is affected if A is changed to another use case or A is deleted, or if A is generalized to another actor.

TABLE 13
Possible Actor-Use case Relationships Changes

| | The | |
|---|---|---|
| | Affected | |
| Change Type | Entity | Justification |
| Change use case A | Actor | Use case A will be counted as |
| to another one | | deleted; the Actor will depend |
| | | on a new Use Case |
| Change the Actor | Use Case A | A will depend on a new Actor |
| to another one | | because the Actor will be |
| | | counted as deleted. |
| Delete use case A | Actor | When the use case is deleted, |
| | | the Actor will depend on a new |
| | | use case |
| Delete the Actor | Use Case A | A will depend on a new Actor |
| | | because of deletion. |
| Delete the | Use Case A, | A will not depend on an Actor; |
| relationship | Actor | An Actor will not depend on A. |

A generalization relationship is used to express higher level functionality. The use case generalization can be represented using a solid line, with a closed arrow pointing from the specialized use case to the base use case. FIG. 31 illustrates a sample diagram of this relationship. The use case Authentication represents the generic use case, while the use case EmailLogin represents a specialization of the use case Authentication. The generalization still pertains to the system functionality and not to an implementation, and hence the generic use case and the specialized use case are involved in the assessment. The generalization can also be called inheritance.

The sample use case Authentication represents the master side of the relationship because it contains general steps that can be used by the inherit use case. If it was desired to access use case EmailLogin, the use case Authentication steps would need to be used because every step in the general use case Authentication must occur in the specialized use case EmailLogin. Therefore the use case EmailLogin represents the client side of the relationship. In a use case generalization relationship, the generic use case is the master use case and the specialization use case is the client use case.

Some possible changes that may occur to the generalization relationship are illustrated in Table 15. Based upon the approach or action, A is the master side of the relationship and B is the client side of the relationship. A will be affected if the relationship is changed to an extend or include, whatever its direction. B is affected in all cases, except for an include A relationship.

An include relationship is used in the case of creating a shared and common functionality. The purpose of this action is behavior modularization, making the functionalities more manageable. The use case inclusion is represented using a dashed line with an open arrow (dependency) pointing from the base use case to the included use case. The line is labeled with the keyword include. FIG. 32 illustrates a sample diagram of the include relationship. Use case OrderAMeal represents the including use case, while use case Pay represents the included use case. An include relationship means that the behavior in the additional use case (Pay) is inserted into the behavior of the base use case (OrderAMeal).

From the sample diagram, the OrderAMeal use case represents the client side of the relationship. In order to access or perform OrderAMeal, the use case Pay needs to be implemented since OrderAMeal is not complete on its own. In other words, OrderAMeal depends and needs Pay. However, use case Pay can be complete and can be accessed without the use case OrderAMeal; Pay represents the master side of the relationship. In an include relationship, the master is the including use case and the client is the included use case.

Some possible changes that may occur to the include relationship are illustrated in Table 16. According to the approach, A is the client side of the relationship and B is the master side of the relationship. A will be affected if the relationship changes to any other type of relationship. B affected in all cases, except when A is used as a general use case.

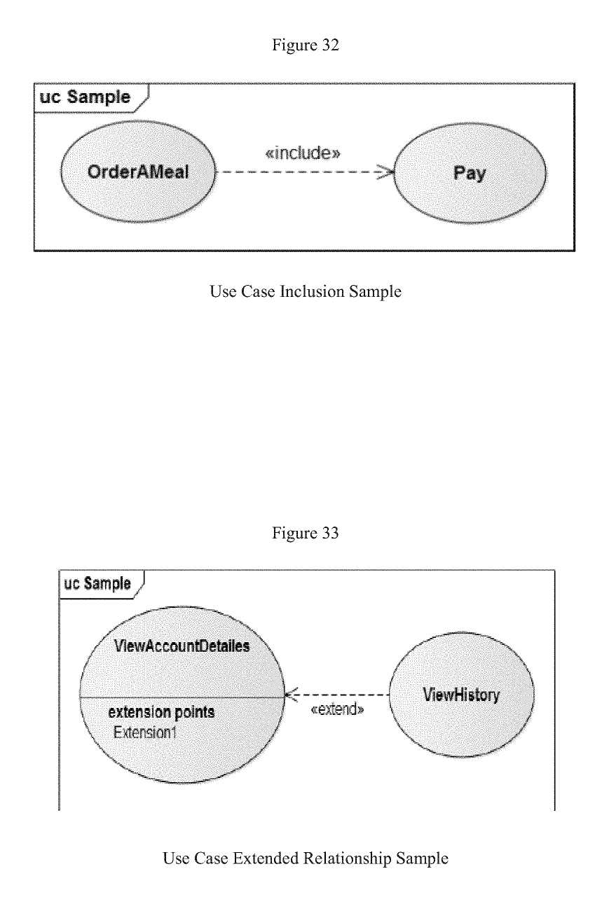

An extend relationship is used to plug in additional functionality to the base use case. It defines the instances in which additional functionality of a use case can be added to an extended use case. Use case extension is represented using a dashed line with an open arrow (a dependency) pointing from the extension use case to the base use case. The line is labeled with the keyword extend. FIG. 33 illustrates a sample diagram of the extend relationship. ViewAccountDetailes expresses the extended use case, while ViewHistory expresses the extending use case. The relationship in this example indicates that the ViewHistory inserts additional action sequences into the ViewAccountDetailes sequence. This allows ViewHistory to continue the activity sequence of ViewAccountDetailes when the appropriate extension point is reached in the ViewAccountDetailes, and the extension condition is fulfilled. In other words, a ViewHistory use case continues the functionality of a ViewAccountDetailes use case. Accordingly, ViewAccountDetailes is an independent use case, wherein it has to describe the master role of the relationship.

An extension point is a specification of some point in the use case where an extension use case can plug in and add functionality. UML doesn't have a particular syntax for extension points; they are typically freeform text. The extension point is introduced to the ViewAccountDetailes because of the extend relationship. In this case, the owner and the controller of this relationship is ViewHistory. This occurs in the case of deletion of the ViewHistory. Deletion of a ViewHistory will have a direct effect on ViewAccountDetailes by removing the extension point. Therefore, the ViewAccountDetailes is a client in this relationship, despite its independence.

The second part of this relationship is the extending use case, the ViewHistory use case. It represents another client side of the relationship. ViewHistory is not necessarily meaningful by itself, so if specific conditions are met in use case ViewAccountDetailes, then ViewHistory is performed. The performance of ViewHistory is dependent on ViewAccountDetailes. In the extension relationship, the two use cases are clients.

Some possible changes that can occur to the include relationship are illustrated in Table 17. Based on the approach, A and B are clients. A will be affected if something happens to B or to the relationship. B is affected in all cases.

A selected identifier has two main parts, and each part is complete by its own. There are two identifiers. The first identifier is relevant to the use case, which is the use case name. The other identifier is relevant to the actor, which is the actor name. There is separation of the two identifiers because each one identifies a different entity. The possible changes in the identifier are deletion and renaming. Renaming cannot be detected, so only an unchanged status is relevant or used

The following list of selected elements and attributes were evaluated and tracked according to their unchanged status.
Actor name.
Use case name.
Use case types.
Actor-actor relationship.
Actor-use case relationship.
Generalization relationship.
Include relationship.
Extend relationship.

The following terminology and formalism were used for the functional stability metric.

Definition 1 (USE CASE). Let the use-case diagram use case be denoted by U. The same use case can have different versions based on different use-case diagram versions. Let Ui denote the use case U in use case diagram version i where iε[1.n].

Definition 2 (ACTOR). Let the use-case diagram actor be denoted by A. The same actor can have different versions based on different use-case diagram versions. Let Ai denote the actor A in use-case diagram version i, where iε[1.n].

Definition 3 (IDENTIFIER). Let the use-case diagram identifier be denoted by ID. The identifier can be either a use case or an actor.

Definition 4 (IDENTIFIER PROPERTIES). Let P(ID1) denote the set of all properties of the identifier ID in use-case diagram version i.

Definition 5 (NUMBER OF USE-CASE PROPERTIES). Let NUUP denote the number of all unique properties of the use case U in use-case diagram version i. This version was used for comparison.

Definition 6 (USE-CASE NAME). Let the use-case name in the use-case diagram be denoted by UN. The same use case can have only one specific name, which is whatever the use-case diagram version is. Otherwise, it would be considered a different use case, since the use case renaming is indefinable.

Definition 7 (USE-CASE TYPE). Let the use-case type in the use-case diagram be denoted by UT.

Definition 8 (ACTOR NAME). Let the actor name in the use-case diagram be denoted by AN. The same actor can have only one specific name, which is whatever the use-case diagram version is. Otherwise, it would be considered a different actor, since actors renaming is indefinable.

Definition 9 (NUMBER OF USE CASES IN USE-CASE DIAGRAM BASE VERSION). Let NU represent the number of use cases in the use-case diagram base version.

Definition 10 (NUMBER OF ACTORS IN USE-CASE DIAGRAM BASE VERSION). Let NA represent the number of actors in the use-case diagram base version.

Definition 11 (NUMBER OF ACTOR RELATIONSHIPS). Let NUAR denote the number of all unique relationships of actor A in use-case diagram version i. This version was used for comparison.

Definition 12 (IDENTIFIER PROPERTIES CHANGE). Let change that may happen to any identifier be denoted by Ch. Ch represents any change in identifier properties from the use-case diagram base version to any other use-case diagram version.

Definition 13 (USE-CASE UNCHANGED)

UCU is the percentage of unchanged in the use case.

Definition 14 (ACTOR UNCHANGED)

UCA is the percentage of unchanged in the actor.

Definition 15 (FUNCTIONALITY STABILITY)

FS is the percentage of the functional stability, which represents the use-case diagram stability.

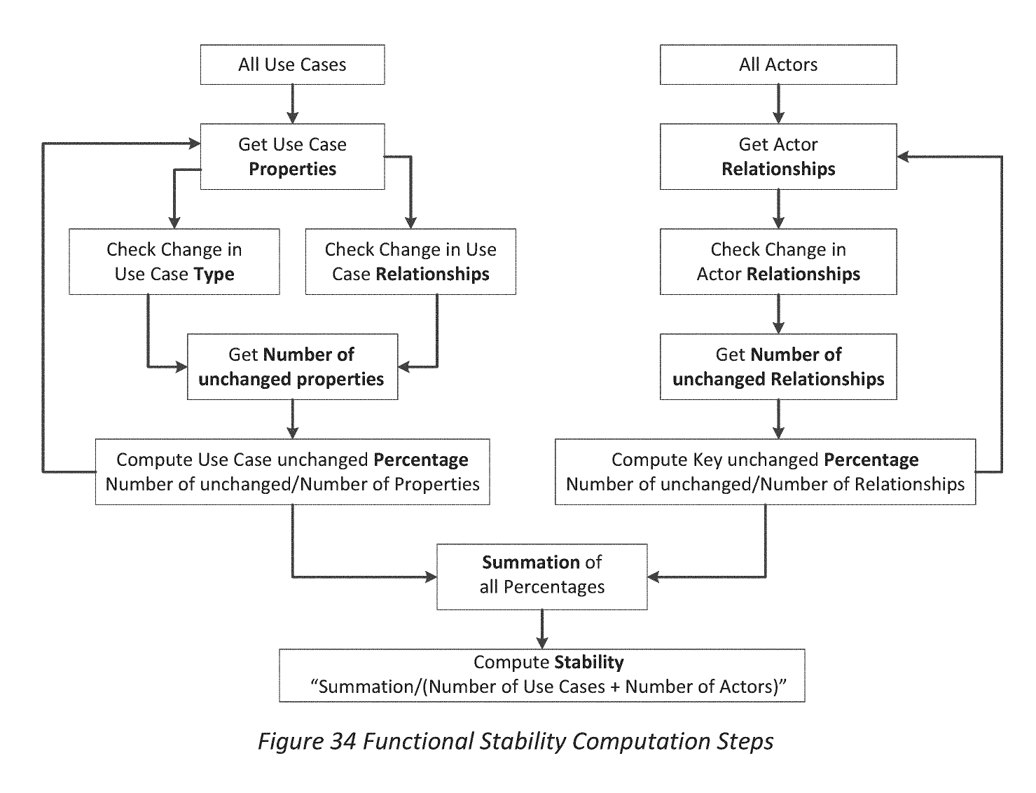

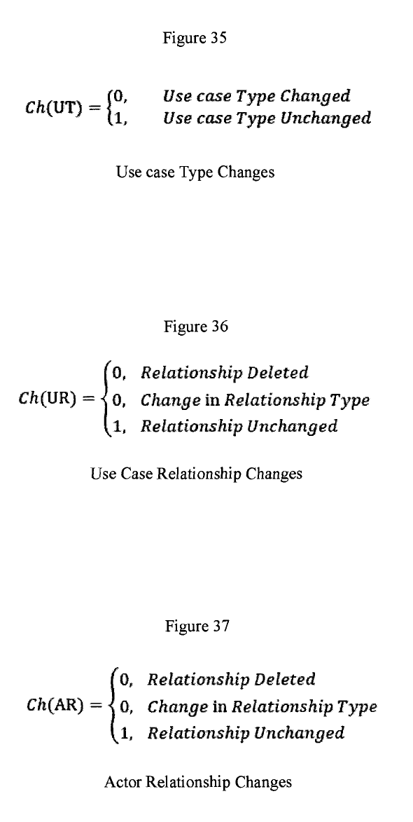

FIG. 34 summarizes the computation steps of computing a functional model stability metric. The measure of the use-case diagram stability is implemented through the following steps.
1. Develop a property change metric for each actor and each use-case. This metric is used to measure the changes of each actor and use-case properties. The unchanged properties are computed according to FIG. 35 and FIG. 36, which show use-case type changes and use-case relationship changes, respectively. FIG. 37 shows actor relationship changes.
2. Obtain each unchanged use case, which equals the summation of all use-case changes over the number of the use-case unique properties (NUUP), Equation 5.1 (given here under). Dividing by the number of properties will normalize the sum of the use-case changes, which gives a result between zero and one. One means all use-case diagram use cases have been changed from the i version to the i+1 version.
   FIG. 34 illustrates a flowchart for obtaining a first state of a use-case diagram including a first plurality of use cases and a second state of the use-case diagram including a second plurality of use cases in step S3410. Properties of the use cases for the first state of the use-case diagram and the second state of the use-case diagram are identified in step S3415. Changes to the use-case type for each of the properties are tracked in a transformation in the one or more use-case properties from a first state to a second state in step S3420. Changes to the use-case relationships for each of the one or more properties are tracked in the transformation from the first state to the second state in step S3425. The total number of unchanged properties for each use-case type and each use-case relationship are calculated in step S3430. A percentage of unchanged properties for the one or more use cases is calculated in step S3435.
3. Obtain each unchanged actor, which equals the summation of all actor changes over the number of the actor unique relationships (NUAR), Equation 5.2 (given here under). Dividing by the number of relationships will normalize the sum of the actor changes, which gives a result between zero and one. One means all use-case diagram actors have been changed from the i version to the i+1 version.
   FIG. 34 also illustrates obtaining the unchanged relationships for actors. A first plurality of actors for the first state of the use-case diagram and a second plurality of actors for the second state of the use-case diagram is obtained in step 3440. One or more actor relationships for the first state of the use-case diagram and the second state of the use-case diagram are identified in step S3445. A transformation in the one or more actor relationships is tracked from the first state of the use-case diagram to the second state of the use-case diagram in step S3450. A total number of unchanged actor relationships based on the transformation in the one or more actor relationships from the first state of the use-case diagram to the second state of the use-case diagram is calculated in step S3455. A percentage of unchanged actor relationships based on the total number of unchanged actor relationships and a total number of the actor relationships is calculated in step S3460.
4. Compute the summation of all use cases and actor change metrics over the summation of NU and NA. The percentage of unchanged properties for the one or more use cases calculated in step S3435 and the percentage of unchanged actor relationships calculated in step S3460 are combined for a total summation in step S3465. Dividing by NU+NA will normalize the summation of use cases and actor changes, which gives a result between zero and one. One means all use-case diagram elements have been changed from the i version to the i+1 version.
5. The overall use-case diagram stability metric is computed using Equation 5.3 (given here under). A functional model stability metric for the second state of the use-case diagram is calculated as a ratio of the percentage of unchanged use-case properties from the first state to the second state plus the percentage of unchanged actor relationships from the first state to the second state to a total number of the first plurality of use cases plus a total number of the first plurality of actors in the first state of the use-case diagram in step S3470. This final value is also normalized. Zero means all elements have been changed from version i to version i+1. Thus, version i+1 is unstable. On the other hand, one means nothing has been changed. Therefore, version i+1 is completely stable. In an embodiment, an alert message is transmitted to a user when the functional model stability metric is equal to or less than a predetermined threshold. In another embodiment, the second state of the use-case diagram is transformed from a model level to a source code level.

In another embodiment to the method illustrated in the flowchart of FIG. 34, a programmed computing device comprises circuitry, wherein the circuitry is configured to obtain a first state of a use-case diagram including a first plurality of use cases and a first plurality of actors, and obtain a second state of the use-case diagram including a second plurality of use cases and a second plurality of actors. The circuitry is further configured to identify one or more use-case properties for the first state of the use-case diagram and the second state of the use-case diagram. The circuitry is further configured to identify one or more actor relationships for the first state of the use-case diagram and the second state of the use-case diagram, and track a transformation in the one or more use-case properties from the first state of the use-case diagram to the second state of the use-case diagram. The circuitry is further configured to track a transformation in the one or more actor relationships from the first state of the use-case diagram to the second state of the use-case diagram. The circuitry is further configured to calculate a total number of unchanged use-case properties based on the transformation in the one or more use-case properties from the first state of the use-case diagram to the second state of the use-case diagram. The circuitry is further configured to calculate a total number of unchanged actor relationships based on the transformation in the one or more actor relationships from the first state of the use-case diagram to the second state of the use-case diagram. The circuitry is further configured to calculate a percentage of unchanged use-case properties based on the total number of unchanged use-case properties and a total number of the use-case properties, and calculate a percentage of unchanged actor relationships based on the total number of unchanged actor relationships and a total number of the actor relationships. The circuitry is further configured to calculate the functional model stability metric for the second state of the use-case diagram as a ratio of the percentage of unchanged use-case properties from the first state to the second state plus the percentage of unchanged actor relationships from the first state to the second state to a total number of the first plurality of use cases plus a total number of the first plurality of actors in the first state of the use-case diagram. The circuitry is further configured to transmit an alert message to a user when the functional model stability metric is equal to or less than a predetermined threshold. The circuitry can be specially programmed to perform the above-noted method and can be located on a server, a user computer, the cloud etc.

In yet another embodiment, a non-transitory computer-readable medium has computer-executable instructions embodied thereon, that when executed by a computing device, performs the method described above and illustrated in FIG. 34. In still another embodiment, an electronic chip includes circuitry configured to perform the method described above and illustrated in FIG. 34.

To count the changes that may occur to the use cases and actors, it is determined if the use case and actors are still in version i+1 or not. If the use case or the actor was deleted, the change value will be the maximum value of one. The check process is implemented based on the UN and AN. After confirming the identifier, each use case and actor change are computed according to FIG. 35, FIG. 36, and FIG. 37.

FIG. 35 represents use-case type changes. Zero means the use-case type remains unchanged. One means that the use-case type is changed, either from use case to use case with an extension or from use case with an extension to use case.

FIG. 36 represents use-case relationship changes. The change counts as one if the relationship is changed. Change will be zero if the relationship remains unchanged.

FIG. 37 represents actor relationship changes. The change counts as one if the relationship is changed. Change will be zero if the relationship remains unchanged.

$$UCU = \frac{Ch ( UT ( i , i + 1 ) ) + {\sum }_{R = 1}^{NUUR} Ch ( UR ( i , i + 1 ) )}{NUUP} \qquad 5.1$$

UCU is the abbreviation for Use Case Unchange. This metric computes the unchanged of each use case, which equals the summation of use-case type changes and all use-case relationship changes over the number of use-case properties.

Ch is the abbreviation for Changes in use-case types and use-case relationships.

UR is the abbreviation for use-case Relationship.

UT is the abbreviation for use-case Type. NUUP is the abbreviation for Number of Unique Use case Properties.

i: a use-case diagram version.

$$UCA = \frac{{\sum }_{R = 1}^{NUAR} Ch ( AR ( i , i + 1 ) )}{NUAR} \qquad 5.2$$

UCU is the abbreviation for Unchanged in Actor. This metric computes the unchanged of each actor, which equals the summation of actor-type changes and all actor-relationship changes over the number of actor relationships.

Ch is the abbreviation for Changes in actor relationships.

AR is the abbreviation for Actor Relationship.

NUAR is the abbreviation for Number of Unique Actor Relationships.

R is the abbreviation for Relationship.

i: a use-case diagram version.

$$FS ( i + 1 ) = \frac{{\sum }_{U = 1}^{NU} UCU ( U ) + {\sum }_{A = 1}^{NA} UCA ( A )}{NU + NA} \qquad 5.3$$

FS is the abbreviation for Functional Stability. This metric computes the stability of the use-case diagram, which equals the summation of all identifiers' changes subtracted from one.

U is the abbreviation for use case.

UCU is the abbreviation for Unchanged in Use case.

A is the abbreviation for Actor.

UCU is the abbreviation for Unchanged in Actor.

NU is the abbreviation for Number of Use cases in use-case diagram version i.

NA is the abbreviation for Number of Actors in use-case diagram version i.

i is the abbreviation for a use-case diagram version.

The following example shows the steps to measure sequence diagram stability.

FIG. 38 illustrates version i of a sample use-case diagram, and FIG. 39 illustrates version i+1 of the same sample of the use-case diagram.

Table 18 illustrates the properties for each version, and Table 19 illustrates the changes calculation from sample use-case diagram version i to sample use-case diagram version i+1.

TABLE 18
Use Case Sample Diagrams Properties

| Identifier | Properties | version i Data | version i + 1 Data |
|---|---|---|---|
| Create New | Identifier Type | Use case with extension | Use Case |
| Personal | | point | |
| Wiki | Relationships | Check Identity -Include | Check Identity -Include |
| System | Identifier Type | Actor | Actor |
| Admin | Relationships | Create New Personal Wiki - | Create New Personal Wiki - |
| | | Association | Association |
| Record | Identifier Type | Use Case | Deleted |
| Application | Relationships | Create New Personal Wiki- | |
| Failure | | Extend | |
| | | Create New Blog Account- | |
| | | Extend | |
| Check | Identifier Type | Use Case | Use Case |
| Identity | Relationships | — | — |
| Blog | Identifier Type | Actor | Actor |
| Admin | Relationships | System Admin - | — |
| | | Generalization | Create New Blog Account - |
| | | Create New Blog Account - | Association |
| | | Association | |
| Create New | Identifier Type | Use case with extension | Use Case |
| Blog | | point | |
| Account | Relationships | Check Identity -Include | Check Identity -Include |

TABLE 19
Use Case Sample Changes From version i to version i + 1

| | | No. of | | |
|---|---|---|---|---|
| | | Unique | Unchanged | Unchanged |
| Identifier | Changes | Properties | Value | Average |
| Create New | Use case with | 2 | 1 | 0.5 |
| Personal | extension | | | |
| Wiki | point => Use | | | |
| | Case | | | |
| System | — | 2 | 2 | 1 |
| Admin | | | | |
| Record | IDENTIFIER | 3 | 0 | 0 |
| Application | DELETED | | | |
| Failure | | | | |
| Check | — | 1 | 1 | 1 |
| Identity | | | | |
| Blog | System Admin - | 3 | 2 | 0.66 |
| Admin | Generalization | | | |
| | DELETED | | | |
| Create New | Use case with | 2 | 1 | 0.5 |
| Blog | extension | | | |
| Account | point => Use | | | |
| | Case | | | |

$$FS ( i + 1 ) = \frac{0.5 + 1 + 0 + 1 + 0.66 + 0.5}{6}$$

$$FS ( i + 1 ) = 0.61$$

The 0.61 means that version i+1 of the sample use-case diagram's stability is 61%. In other words, version i+1 kept 61% of version i's functionality, elements, and attributes. Sixty-one percent of use cases, actors, and relationships remain in the next version.

An analysis and assessment of the UML sequence diagram of the behavioral stability metric is described herein. A sequence diagram is made up of a collection of participants, lifelines, and messages to illustrate the behavior of a system. Change tracking in the sequence diagram will be based on and relies on, the messages and is based on the client master approach. Change is calculated by tracking changes to the client role of a participant.

For the sequence diagram, the client master approach is applied in a different way. This situation is slightly different from the UML class diagram and UML use-case diagram. Only the message invoking is assessed, and each message is assessed separately.

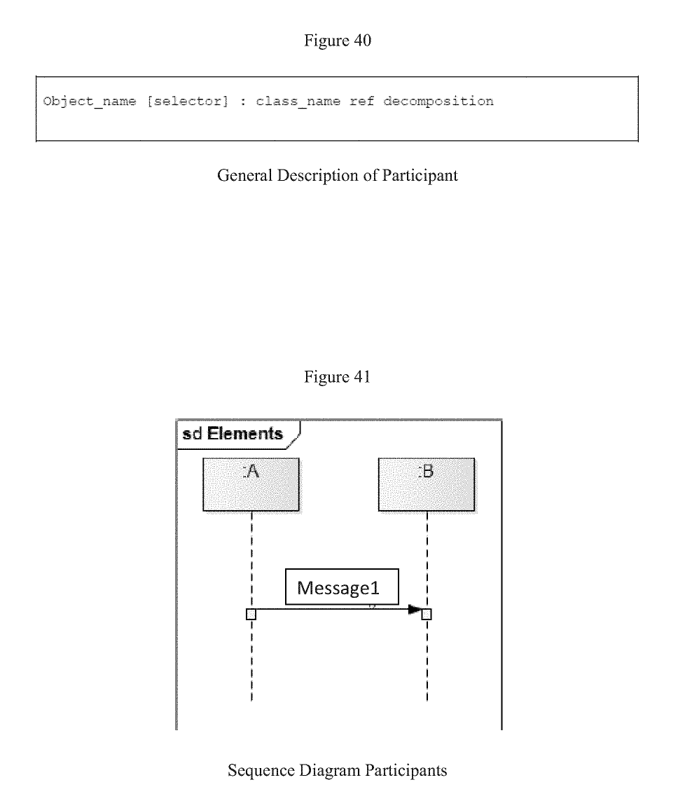

Participants include the system portions that interact with each other during the sequence, and each portion has a corresponding lifeline. Participants on a sequence diagram can be named in a number of different ways. FIG. 40 illustrates the general description of the participant.

The first portion of the name is the object name, which specifies the name of the instance involved in the interaction. In addition, this portion has another attribute, the selector which identifies the particular instance in which a multivalued element is used. The selector is an optional part of the name.

If no object is mentioned in the sequence diagram, it means that either no object is required or that an object without any particular name suffices. An object name and the selector are not always available. This kind of information about the participant may be unspecified during the design process, so no change that may have occurred with the participants was counted.

The second portion includes the class name and the decomposition. The class name represents one of the identifier portions. The decomposition is used to point to another interaction diagram that shows details of how this participant processes the message it receives. Thus, it is an optional part, and so it was ignored herein.

From the participant information, only the class name is involved in change assessment. Other portions were neglected, due to the optionality or the absence of its information. Only mandatory fields of the participants were assessed, such as participant A in FIG. 41. The class can be identified by its name only; therefore, if the class name is changed, the original class name cannot be reorganized. This case was addressed by considering the class is deleted and a new class has emerged.

FIG. 41 illustrates a sample of sequence diagram participants. Classifier A calls message1 from the classifier B. In this sample, A represents the client side of the relation because it calls message1 that belongs to B. This means that any changes which may have occurred to this method or to B will affect A. B represents the master side of the relationship because it does not depend on A.

Some possible changes include changing the classifier A to another classifier. This will not affect classifier B, since B is a master classifier in this relationship. Changing classifier B to another classifier has an effect on classifier A. The type of change on classifier B that can be recognized is the deletion of classifier B because the renaming recognition of the classifiers is not identifiable. The deletion of classifier B means that message1 is a completely different message than the original message; therefore, there is a change in its behavior.

Changing a participant to another participant means it is changing in participant name only. The only information known about the participant is its name.

Stereotypes are used to describe a specific property that a classifier has, which cannot be shown in the standard UML classifier. There are three main stereotypes which can be used in sequence diagrams, namely:
Entity: used to represent behavior related to the system data.
Boundary: represents the elements that usually interact with the system actors. Boundaries are called the front-end elements.
Controller: these elements serve as a median between entities and controllers.
   See R. Hennicker and N. Koch, “Systematic design of Web applications with UML,” in Unified modeling language, ed: IGI Publishing, 2001, pp. 1-20; and S. Berner, M. Glinz, and S. Joos, “A classification of stereotypes for object-oriented modeling languages,” presented at the Proceedings of the 2nd international conference on The unified modeling language: beyond the standard, Fort Collins, Colo., USA, 1999, each incorporated herein by reference in their entireties. The controller manages the interaction flow. The stereotypes were treated as if they were usual participants.

An interaction in a sequence diagram occurs when one participant decides to send a message to another participant, as illustrated in FIG. 41, where A sends a message to B. Messages are the heart of the sequence diagram, since they are used to represent the behavior of the systems. Sometimes, the messages are called events, which refer to any point in an interaction where something occurs. The term message will be used herein because it is the one used by software designers. Messages on a sequence diagram are specified using an arrow from the participant that wants to pass the message (Message Caller) to the participant that receives the message (Message Receiver). Messages can flow in whatever direction makes sense for the required interaction, including from left to right, right to left, or even back to the Message Caller itself.

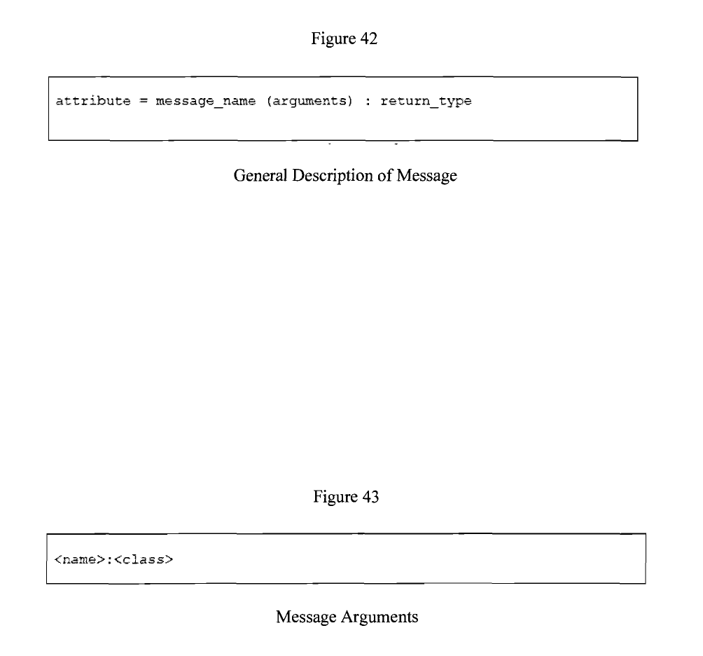

FIG. 42 illustrates a message signature format, which has four parts. An attribute is used to store the return value of the message, which is an optional part. The second part is the message name, which was chosen to be the other half of the identifier. The third part of the message signature is the arguments. FIG. 43 illustrates the format of an argument. Any number of different arguments can be specified on a message, with each argument being separated by a comma. The last part is the return type, which states what the return value from the message will be.

The format elements that can be used for a particular message will depend on the information known about a particular message at any given time. For example, message1 in FIG. 41, does not indicate that the message clearly has no argument or return values, but it is the only available information about it. It means that, for now, no further information is known. In order to be consistent and unified with all messages, only the message name information was involved in the stability assessment.

Triggering a message can result in one or more messages being sent by the receiving participant. Those resulting messages are said to be nested within the triggering message. There can be any number of nested messages and any number of levels on the sequence diagram.

There are five different message types, each differentiated based on the message arrow. Each message has its own meaning. For example, the Message Caller can choose to wait for a message to return before carrying on with its work. It can also choose to just send the message to the Message Receiver without waiting for any return as a form of “fire and forget” message.

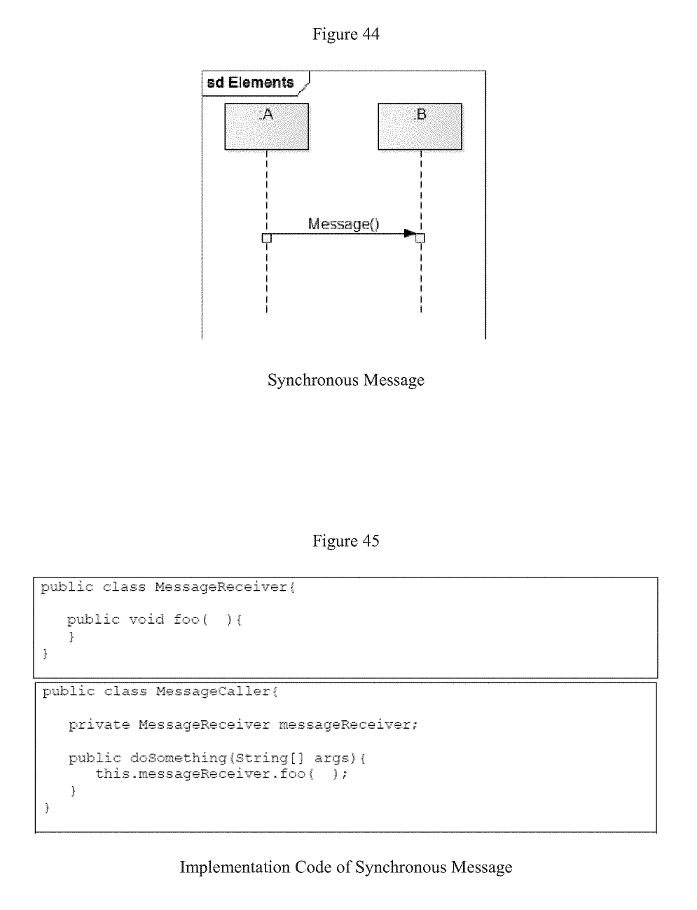

A synchronous message declares that the Message Caller waits for the Message Receiver to return from the message invocation. This can be implemented in the code as a simple method invocation. FIG. 44 illustrates a sample diagram of a synchronous message, where the figure shows that a classifier A is the client and a classifier B is the master.

FIG. 45 illustrates how this type of message can be converted into a code using a simple method invocation. The MessageReceiver which represents participant B in the example, is in the master role of the relationship because it is a standalone participant and does not depend upon participant A. The MessageCaller, which represents A in the example, is on the client side of the relationship because it depends on B. Any change that may happen to B will have a direct effect on A.

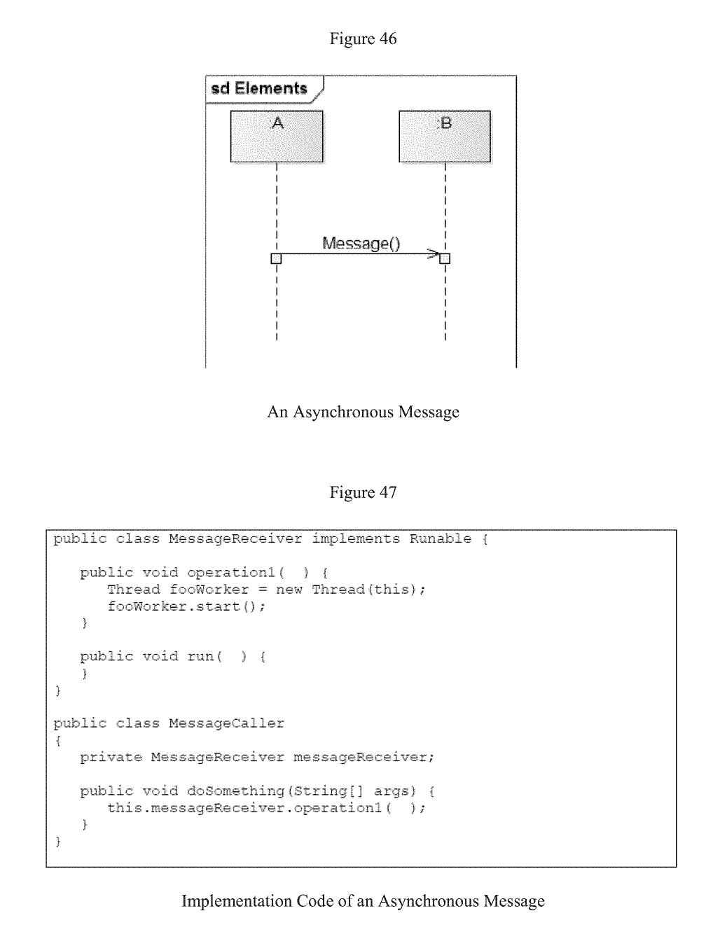

Interactions are not always occurring one after the other. Interactions can occur at the same point in time, which is termed an asynchronous message. An asynchronous message declares that Message Caller invokes a message and does not wait for the message invocation to return before carrying on with the rest of the interaction's steps. This means that the Message Caller will invoke a message on the Message Receiver and the Message Caller will be busy invoking further messages before the original message returns, as illustrated in FIG. 46. FIG. 46 illustrates that participant A is the client and participant B is the master.

FIG. 47 illustrates how this type of message can be converted into a code using threads. The MessageReceiver, which represents participant B in the example of FIG. 46 is on the master side of the relationship because it is a standalone and does not depend upon A. The MessageCaller, which represents participant A in the example in FIG. 46 is on the client side of the relationship because it depends on B. Any change that may happen to B will have a direct effect on A.

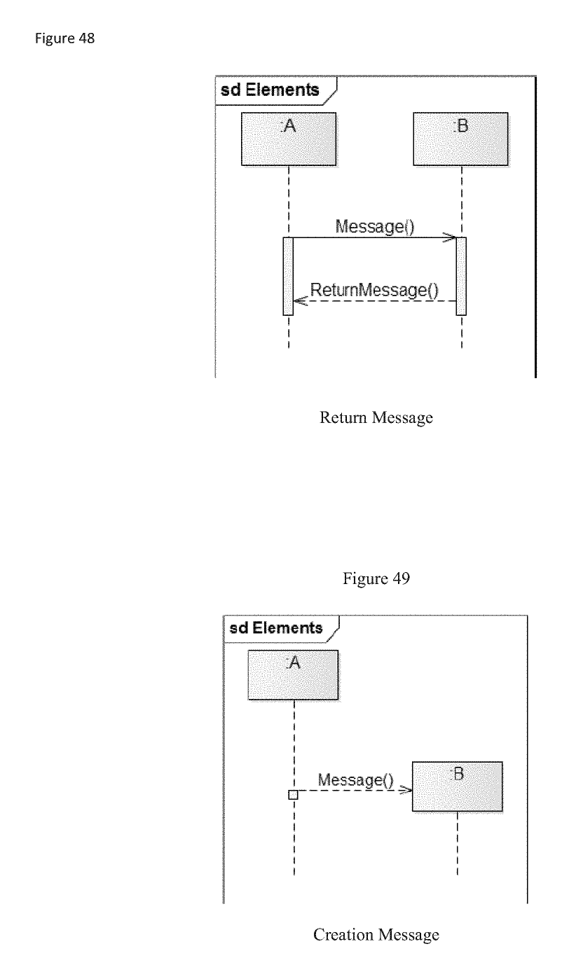

The return message, shown in FIG. 48, is used at the end of an activation bar. The control flow of the activation is returned to the participant that passed the original message. In code, a return is like reaching the end of the method or calling a return statement. Return messages are an optional notation; their use will make the sequence diagram too busy, so there is no need to show them. However, in synchronous message invocation there is an implied return arrow on the activation bars that are invoked. We will skip this type of message, and we will not involve it in our assessment.

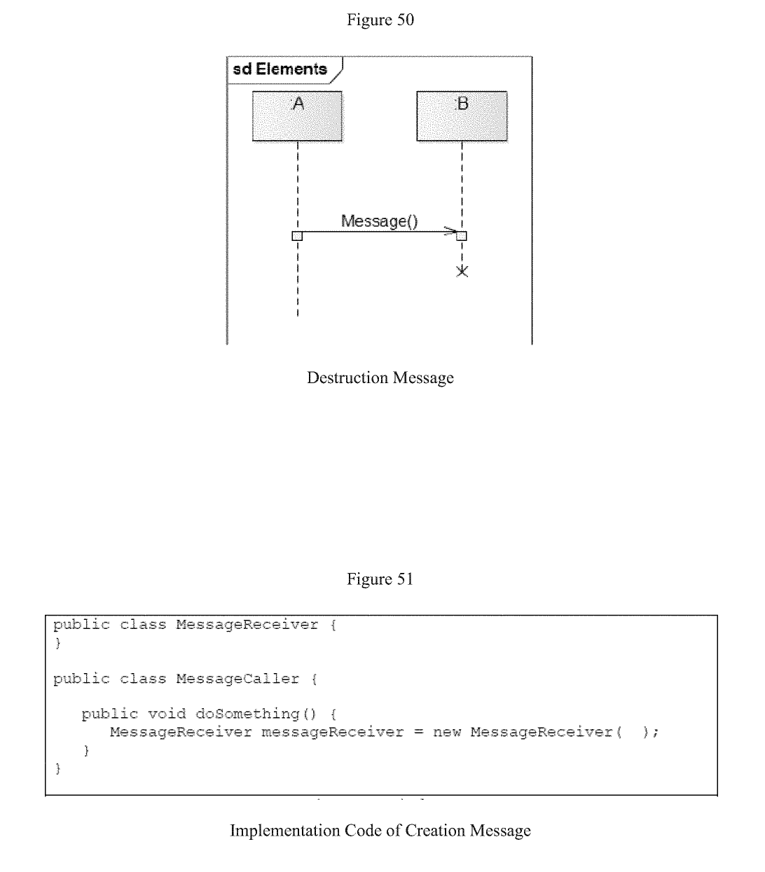

Participants do not necessarily live for the entire duration of an interaction of a sequence diagram. Participants can be created and destroyed according to the messages that are being passed, as illustrated in FIG. 49 and FIG. 50. A creation message is used to create objects during interactions, while a destruction message is used to delete objects during interactions.

FIG. 51 illustrates the implementation code of a creation message. For the destruction message, there is not always an explicit destroy method, for example in Java. In Java, after having finished executing the doSomething method, the MessageReceiver object will be marked for destruction. Subsequently, the garbage collector will implicitly handle the destruction. In this case, there is no need for additional destruction messages.

The metric is not just focused on Java. A comprehensive metric is possible that can be applied to whatever the design implementation language may be. In these two types of messages, participant A is the master and participant B is the client. The MessageReceiver, which represents B is on the client side of the relationship because its existence depends upon A. The MessageCaller, which represents A is on the master side of the relationship because it controls B's existence. Any change that may happen to A will have a direct effect on B.

Notes are used to help associate interactions within elements, place local variable names and values, and place the state invariant information. They are used to describe some information about the diagram. Notes are not used to represent any behavioral states of the diagram. Notes will not be addressed in embodiments described herein.

An activation bar can be shown at the sending and receiving ends of a message. It indicates that the sending participant is active while it sends the message, and that the receiving participant is actively doing something after the message has been received. The activation bars are optional, so they will not be addressed in embodiments described herein.

The sequence diagram initiator is a user, wherein a simple label at the top is used rather than a rectangle. The sequence diagram initiator is the one who initiates the first message. An actor name can be involved in the assessment process.

Sequence diagrams are primarily about the ordering of the interactions between participants. The order in which interactions are placed within the diagram indicates the order in which those interactions will take place over time. Time on a sequence diagram is all about ordering, and not about duration. However, the time at which an interaction occurs is indicated on a sequence diagram by where it is placed vertically on the diagram. The amount of vertical space the interaction takes up has nothing to do with the duration of time that the interaction will take. The order was considered in embodiments described herein. The message represents the identifier in the sequence diagram. In FIG. 50, the message is the core of the interaction between participant A and participant B. The client master approach that that is followed to track changes and avoid assessment duplication was applied in a different way in the sequence diagram. The messages are the main part of the interactions, so the changes were linked to them directly. From the previous evaluation of the participant's relationships, there were no connected participants which are masters and clients at the same time. Each time, one of the participants is a client and the other is a master. If the message type changes, the change is counted once, whichever the client and the master happens to be at the time. Since the message was chosen as the identifier, it was counted for the message that connects the two participants.

The message order is a second point to consider in selecting the message as an identifier. The sequence diagrams are used to represent the system behavior and to show how the interactions really act. Interactions and order of messages is important in defining the system's behavior. Since the order is a message property, it cannot be assigned the order for the participants. This is another reason to select the message as the identifier in the sequence diagram. However, in the end, the changes of the system behavior are being tracked, and not the changes in the participants themselves, even when a change in the participants reflects on the message properties. Therefore, only the messages and their properties' changes were considered herein.

The selected identifier is the message name. However, message names cannot be used as an identifier alone. There may be different participants, but with the same message name. Therefore, another property besides the name can be used, such as the message receiver. The message receiver here represents the participant, which owns the message.

Five properties for each message are identified below as:
Message Name: the invoked message name.
Message Receiver: the participant which owns the method. The messagewas considered as being a new one if the message receiver was changed, despite having the same name. Some participants may have the same message name, so the original message was not specified from its name only.
Message Caller: the participant which initiates the message.
Message Type: four types were considered: synchronous, asynchronous, creation, and destruction. In the case of a return message, it was not considered because it is an optional message. This represented the client/master changes.
Message Order: a number was assigned to every message to indicate its order in the execution process. The base message has the order number of zero.

The changes that may occur to the identifier are illustrated in Table 20. Table 20 is just to show which parts are affected by a specific change. However, Table 20 did not affect the way the stability was computed. The changes were connected with the messages.

TABLE 20
Possible Identifier Changes

| Element | Change Type | The Affected Classes |
|---|---|---|
| Message Caller | Change the | One of identifier |
| | class to | properties changed |
| | another one | |
| | Deleted | Identifier is deleted |
| Message Receiver | Change the | Identifier is deleted |
| | class to | |
| | another one | |
| | Deleted | Identifier is deleted |
| Message Type | Synchronous | Message Receiver |
| Asynchronous | Creation | Message Caller, Message |
| | | Receiver |
| | Destruction | Message Caller, Message |
| | | Receiver |
| Message Type | Asynchronous | Message Receiver |
| Synchronous | Creation | Message Caller, Message |
| | | Receiver |
| | Destruction | Message Caller, Message |
| | | Receiver |
| Message Type | Asynchronous | Message Caller, Message |
| Creation | | Receiver |
| | Synchronous | Message Caller, Message |
| | | Receiver |
| | Destruction | Message Caller, Message |
| | | Receiver |
| Message Type | Asynchronous | Message Caller, Message |
| Destruction | | Receiver |
| | Synchronous | Message Caller, Message |
| | | Receiver |
| | Creation | Message Caller, Message |
| | | Receiver |
| Message Order | The Order | — |

Terminology and formalisms of the behavioral stability metric are given herein.

Definition 1 (PARTICIPANT). Let the sequence diagram participants be denoted by P. The same participants can have different versions based on different sequence diagram versions. Let Pᵢ denote the participants P in sequence-diagram version i, where iε[1.n].

Definition 2 (MESSAGE PROPERTIES). Let P(Mᵢ) denote the set of all properties of the message M in sequence-diagram version i.

Definition 3 (MESSAGE NAME). Let the message name in the sequence diagram be denoted by MN. The same message can have only one specific name, whatever the sequence-diagram version is. Otherwise, it will be considered to be a different message because the message renaming is indefinable.

Definition 4 (MESSAGE RECEIVER). Let the message receiver in the sequence diagram be denoted by MR. The same message can have only one specific receiver, whatever the sequence-diagram version is. Otherwise, it will be computed as a different message.

Definition 5 (MESSAGE CALLER). Let the message caller in the sequence diagram be denoted by MC. The same message can have different values based on different sequence-diagram versions.

Definition 6 (MESSAGE TYPE). Let the message type in the sequence diagram be denoted by MT. The same message can have different values based on different sequence-diagram versions.

Definition 7 (MESSAGE ORDER). Let the message order in the sequence diagram be denoted by MO. The same message can have different values based on different sequence-diagram versions.

Definition 8 (NUMBER OF MESSAGES OF SEQUENCE DIAGRAM BASE VERSION).

Let NM represent the number of sequence diagram base version messages.

Definition 9 (MESSAGE PROPERTIES CHANGE). Let the change that may happen to any message be denoted by Ch. Ch represents any change in message properties from the sequence-diagram base version to any other sequence-diagram version.

Definition 10 (MESSAGE CHANGES)

MC is the percentage of sequence-diagram message changes.

Definition 11 (NUMBER OF MESSAGE PROPERTIES). Messages in a sequence diagram have a fixed number of properties, which include message caller, message type, and message order. Message receiver was omitted because the changes of the other three are tracked. Let the number of message properties be denoted by NMP.

Definition 12 (BEHAVIORAL STABILITY)

BS is the percentage of behavioral stability, which represents the sequence-diagram stability.

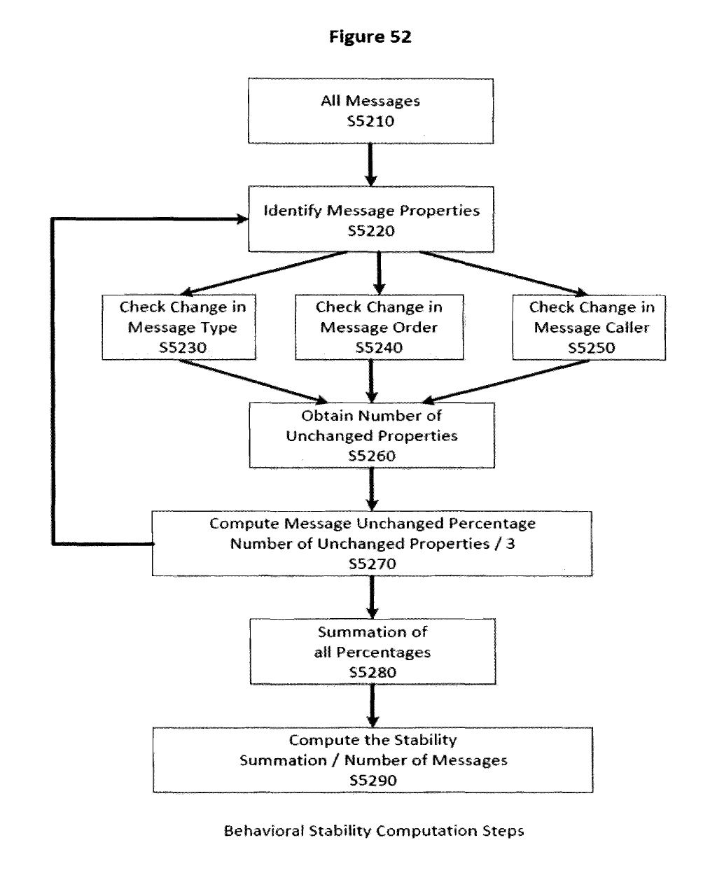

Each message property was handled separately, and the change of the base version was observed. FIG. 52 summarizes the computation steps of computing a behavioral model stability metric. The measurement of the sequence-diagram stability was implemented through the following steps.
1. Develop a property change metric, which is a metric to measure each unchanged message property. FIG. 52 is a flowchart illustrating the steps in computing a behavioral model stability metric. A plurality of messages in a sequence diagram is obtained in step S5210. A first state of a sequence diagram including a first plurality of message participants and a second state of the sequence diagram including a second plurality of message participants is obtained. One or more message properties for the first state of the sequence diagram and the second state of the sequence diagram are identified in step S5220. Each message is evaluated for a change in a message property in a transformation from a first state of the sequence diagram to a second state of the sequence diagram. A transformation in a message property for a message type is tracked in step S5230. A transformation in a message property for a message order is tracked in step S5240. A transformation in a message property for a message caller is tracked in step S5250. Message property transformation is computed according to FIG. 54, FIG. 55, and FIG. 56, which show message caller changes, message type changes, and message order changes, respectively.
2. Calculate the summation of all property change metrics and divide it by the number of message properties according to Equation 6.1 (given here under). A total number of unchanged message properties for the message type, the message order, and the message caller is calculated from the first state of the sequence diagram to the second state of the sequence diagram in step S5260. There are three message properties used herein. Dividing by the number of message properties normalizes the message changes to give a result between zero and one. One means all message properties have been fully changed from the i version to the i+1 version.
3. Compute the sum of all message change metrics and divide it by the number of sequence-diagram base version messages. A percentage of unchanged message properties for the message type, the message order, and the message caller is calculated for the plurality of messages in step S5270. A combined percentage of the unchanged message properties is calculated as a ratio of the total number of unchanged message properties per a total number of the message properties from the first state of the sequence diagram to the second state of the sequence diagram in step S5280. Dividing by the number of base version messages normalizes the sum of message changes to give a result between zero and one. One means all sequence-diagram messages have been changed from the i version to the i+1 version.
4. The overall sequence-diagram stability metric is computed using Equation 6.2 (given here under). The behavioral model stability metric is calculated for the second state of the sequence diagram as a ratio of the combined percentages of unchanged message properties from the first state to the second state to a total number of the first plurality of message participants in the first state of the sequence diagram in step S5290. The final value is also normalized. Zero means all messages have been changed from the version i to the version i+1. Thus, the version i+1 is unstable. On the other hand, one means nothing has been changed. Therefore, version i+1 is completely stable.
5. An alert message is transmitted to a user when the behavioral model stability metric is equal to or less than a predetermined threshold. In an embodiment, the second state of the class diagram is transformed from a model level to a source code level.

In another embodiment to the method illustrated in the flowchart of FIG. 52, a programmed computing device comprises circuitry, wherein the circuitry is configured to obtain a first state of a sequence diagram including a first plurality of message participants and a second state of the sequence diagram including a second plurality of message participants, and identify one or more message properties for the first state of the sequence diagram and the second state of the sequence diagram. The circuitry is further configured to track a transformation in the one or more message properties for a message type, a message order, and a message caller from the first state of the sequence diagram to the second state of the sequence diagram. The circuitry is further configured to calculate a total number of unchanged message properties for the message type, the message order, and the message caller from the first state of the sequence diagram to the second state of the sequence diagram. The circuitry is further configured to calculate a combined percentage of unchanged message properties as a ratio of the total number of unchanged message properties per a total number of the message properties from the first state of the sequence diagram to the second state of the sequence diagram, and calculate the behavioral model stability metric for the second state of the sequence diagram as a ratio of the combined percentage of unchanged message properties from the first state to the second state to a total number of the first plurality of message participants in the first state of the sequence diagram. The circuitry is further configured to transmit an alert message to a user when the behavioral model stability metric is equal to or less than a predetermined threshold. The circuitry can be specially programmed to perform the above-noted method and can be located on a server, a user computer, the cloud etc.

In another embodiment, a non-transitory computer-readable medium has computer-executable instructions embodied thereon, that when executed by a computing device, performs the method described above and illustrated in FIG. 52. In still another embodiment, an electronic chip includes circuitry configured to perform the method described above and illustrated in FIG. 52.

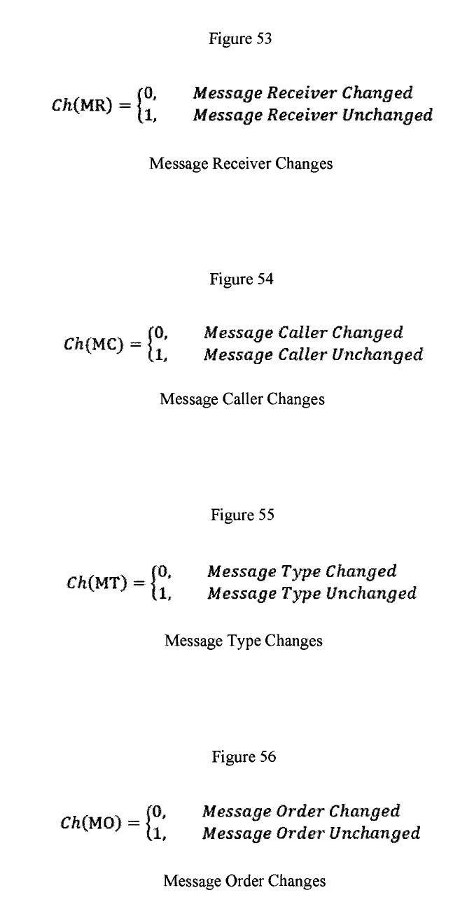

In order to count the changes that can occur to the message properties, it was checked first if the message was still in version i+1 or not. If the message was deleted, then the message change value was the maximum value, one. It was checked to see if the message was still in the next version, and this was done based on the name. After that, the second part of the message identifier was checked, which is the message receiver. FIG. 53 illustrates the possible changes in the message receiver. The message receiver represents one of the message identifier parts. If any change might be occurring to it, it is considered that the message is another message. If the property is changed, the message is fully unstable. After confirming the message, each property change was computed according to FIG. 54, FIG. 55, and FIG. 56.

FIG. 54 represents message-caller changes. Zero means the message caller remains unchanged. One means that the message caller is changed.

FIG. 55 represents message-type changes. Zero means the message type remains unchanged. One means that the message type is changed. The four possible changes are: asynchronous, synchronous, creation, and destruction.

FIG. 56 represents message-order changes. Zero means the message order remains unchanged. One means that the message order is changed.

$$UCM = \frac{Ch ( MC ( i , i + 1 ) ) + Ch ( MT ( i , i + 1 ) ) + Ch ( MO ( i , i + 1 ) )}{NMP} \qquad 6.1$$

UCM is the abbreviation for Unchanged in Messages. This metric computes the unchanged of each message, which equals the summation of the message-caller changes, message-type changes, and message-order changes over the number of message properties.

UCM is the abbreviation for Unchanged in Messages.

Ch is the abbreviation for Changes in message caller, type, and order.

MC is the abbreviation for Message Caller.

MT is the abbreviation for Message Type.

MO is the abbreviation for Message Order.

NMP is the abbreviation for Number of Message Properties (three); message properties are classified by the caller, type, and order.

i is the abbreviation for a sequence diagram version.

$$BS ( i + 1 ) = \frac{{\sum }_{M = 1}^{NM} UCM ( M )}{NM} \qquad 6.2$$

BS is the abbreviation for Behavioral Stability. This metric computes the stability of the sequence diagram, which equals the summation of all message changes subtracted from one.

UCM is the abbreviation for Unchanged in Messages.

M is the abbreviation for Message.

NM is the abbreviation for Number of Messages in the sequence diagram version i.

i is the abbreviation for a sequence-diagram version.

The following example shows the steps to measure sequence-diagram stability.

FIG. 57 illustrates version i of a sample sequence diagram, and FIG. 58 illustrates version i+1 of the same sample of a sequence diagram.

Table 21 illustrates the message properties for each version. Table 22 illustrates the changes calculation from sample sequence diagram version i to sample sequence diagram version i+1.

TABLE 21
All Messages Property for the Sequence Sample Diagrams

| Identifier | Properties | version i Data | version i + 1 Data |
|---|---|---|---|
| viewResult | Message Receiver | ResultsView | ResultsView |
| | Message Caller | Actor | Actor |
| | Message Type | Synchronous | Synchronous |
| | Message Order | 1 | 1 |
| getTagResult | Message Receiver | Results | Results |
| | Message Caller | ResultsView | ResultsView |
| | Message Type | Synchronous | Asynchronous |
| | Message Order | 2 | 3 |
| displayResult | Message Receiver | ResultsTableView | ResultsTableView |
| | Message Caller | ResultsView | ResultsView |
| | Message Type | Synchronous | Asynchronous |
| | Message Order | 3 | 2 |
| render | Message Receiver | ResultsView | ResultsView |
| | Message Caller | ResultsView | ResultsView |
| | Message Type | Synchronous | Synchronous |
| | Message Order | 4 | 4 |

TABLE 22
Changes From version 1 to version
2 in Sequence Sample Diagrams

| | | No. of | | |
|---|---|---|---|---|
| | | Proper- | Unchanged | Unchanged |
| Identifier | Changes | ties | Value | Average |
| viewResult | — | 3 | 3 | 1 |
| getTagResult | Synchronous => | 3 | 1 | 0.33 |
| | Asynchronous | | | |
| | 2 => 3 | | | |
| displayResult | Synchronous => | 3 | 1 | 0.33 |
| | Asynchronous | | | |
| | 3 => 2 | | | |
| render | — | 3 | 3 | 1 |

$$BS ( i + 1 ) = \frac{1 + 0.33 + 0.33 + 1}{4}$$

$$BS ( i + 1 ) = 0.66$$

The 0.66 means that version i+1 of the sample sequence-diagram's stability is 66%. In other words, version i+1 kept 66% of version i's behavior, elements, and attributes. Sixty-six percent of participants, messages, and relationships remain in the next version

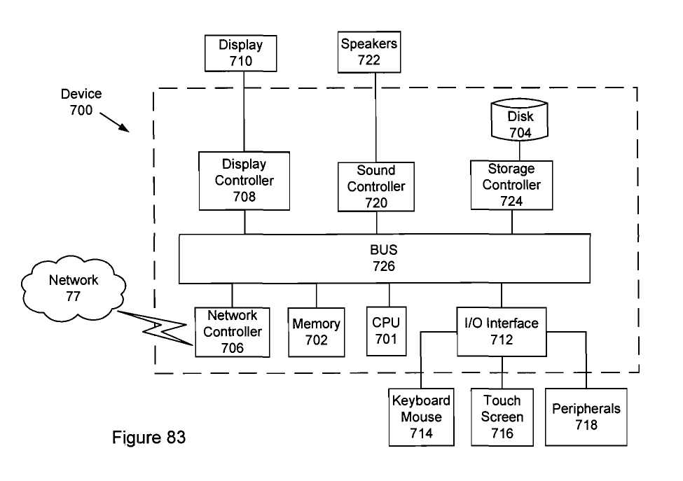

A hardware description of a computing device 700 used in accordance with exemplary embodiments is described with reference to FIG. 83. Computing device 700 could be used in conjunction with one or more embodiments of the present disclosure, such as the UML modelling diagrams, including the class diagram of the structural model, the use-case diagram of the functional model, and the sequence diagram of the behavioral model. However, any of the diagrams of UML or diagrams of other modelling languages can be implemented via the computing device 700.

Embodiments herein describe a plurality of stability metrics for modelling diagrams. The client master approach of the stability metrics assigns a master role or a client role to each of the actors, participants, or objects of a relationship or property. Stability can be calculated by considering a change to the client role. When a master role changes, it affects the client role since the client depends upon the master. If the change is initiated by the client, it will not affect the master. Therefore, the client experiences any changes from its master, as well as its own changes. As a result, tracking changes to the client will incorporate all changes to the relationship. In doing so, functioning of the computing device has improved and is more efficient by processing change to just one side of a relationship or property, i.e. the client role instead of both the master role and the client role. Therefore, the functioning of the computing device has been improved by reducing the necessary processing power and executions in using the client master approach.

Another computing advantage is realized by applying stability metrics to the modelling level of a system instead of the source code level. The approaches described herein measure stability at the front-end of a process instead of the back-end of the process. The functioning and efficiency of the computing device is greatly improved by determining an instability of a system at the beginning of a process. Conventional systems measure the stability of the system after all of the source code has been developed, which could result in computer inefficiencies many times over that of embodiments described herein.

Embodiments described herein apply stability metrics to the modelling level, which are transformed to the source code level. As a result, the advantages described herein at the modelling level are automatically incorporated and transformed into the source code level. Therefore, stability metrics applied to the modelling technical field are transformed into the source code technical field.

Since conventional systems don't measure stability until the source code level, there is no transformation of stability metrics from the modelling level to the source code level. Improvements made to the modelling technical field from embodiments described herein translate to improvements made to the source code technical field. These improvements are realized by writing the source code from a stable model, rather than an unstable model. As a result, re-writing the source code is greatly reduced, thereby enhancing the functioning of the computing device.

Embodiments described herein overcome previous limitations of computer processing. The client master approach has reduced the tracking functions of the computer processor(s) by nearly half. In addition, embodiments for stability metrics are applied by the computer processor(s) (circuitry) at a modelling level instead of a source code level, thereby reducing processing functions by magnitudes of order.

In FIG. 83, the computing device 700 includes a CPU 701 which performs the processes described herein. The process data and instructions may be stored in memory 702. These processes and instructions may also be stored on a storage medium disk 704 such as a hard drive (HDD) or portable storage medium or may be stored remotely. Further, the claimed embodiments are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claimed embodiments may be provided as a utility application, background daemon, or component of an operating system, or combination thereof, executing in conjunction with CPU 701 and an operating system. Examples of an operating system include Microsoft Windows 7, UNIX, Solaris, LINUX, Apple MAC-OS, and other systems known to those skilled in the art.

CPU 701 may be a Xenon or Core processor from Intel of America or an Opteron processor from AMD of America, or may be other processor types that would be recognized by one of ordinary skill in the art. Alternatively, the CPU 701 may be implemented on an FPGA, ASIC, PLD or using discrete logic circuits, as one of ordinary skill in the art would recognize. Further, CPU 701 may be implemented as multiple processors cooperatively working in parallel to perform the instructions of the inventive processes described above.

The computing device 700 in FIG. 83 also includes a network controller 706, such as an Intel Ethernet PRO network interface card from Intel Corporation of America, for interfacing with network 77. As can be appreciated, the network 77 can be a public network, such as the Internet, or a private network such as an LAN or WAN network, or any combination thereof and can also include PSTN or ISDN sub-networks. The network 77 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device 700 further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface 712 also connects to a variety of peripherals 718 including printers and scanners, such as an OfficeJet or DeskJet from Hewlett Packard. A sound controller 720 is also provided in the computing device, such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the computing device 700. A description of the general features and functionality of the display 710, keyboard and/or mouse 714, as well as the display controller 708, storage controller 724, network controller 706, sound controller 720, and general purpose I/O interface 712 are omitted herein for brevity.

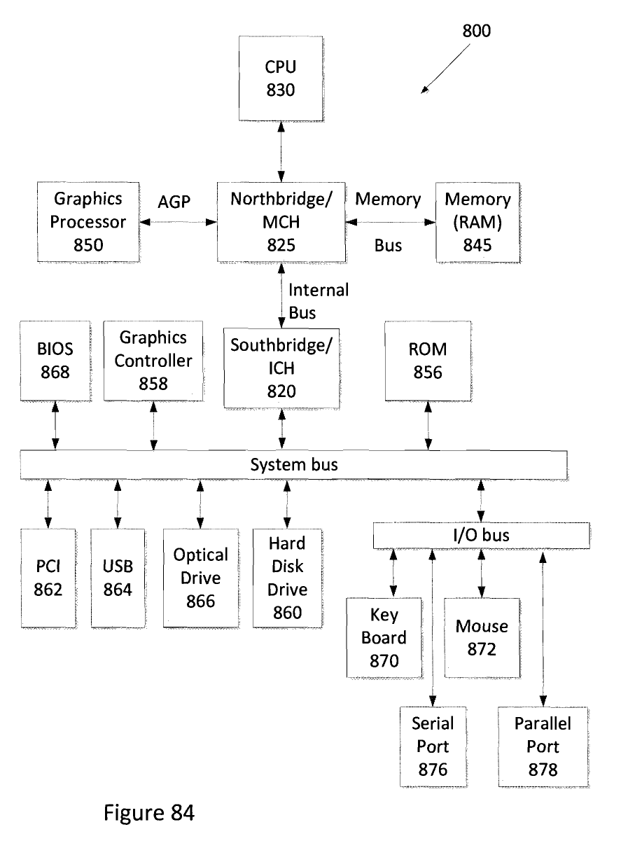

The exemplary circuit elements described in the context of the present disclosure can be replaced with other elements and structured differently than the examples provided herein. Moreover, circuitry configured to perform features described herein can be implemented in multiple circuit units (e.g., chips), or the features can be combined in circuitry on a single chipset, as shown in FIG. 84. The chipset of FIG. 84 can be implemented in conjunction with computing device 700 described herein with reference to FIG. 83.

FIG. 84 shows a schematic diagram of a data processing system, according to aspects of the disclosure described herein for computing a model stability metric. The data processing system is an example of a computer in which code or instructions implementing the processes of the illustrative embodiments can be located.

In FIG. 84, data processing system 800 employs an application architecture including a north bridge and memory controller application (NB/MCH) 825 and a south bridge and input/output (I/O) controller application (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU 830 can contain one or more processors and even can be implemented using one or more heterogeneous processor systems.

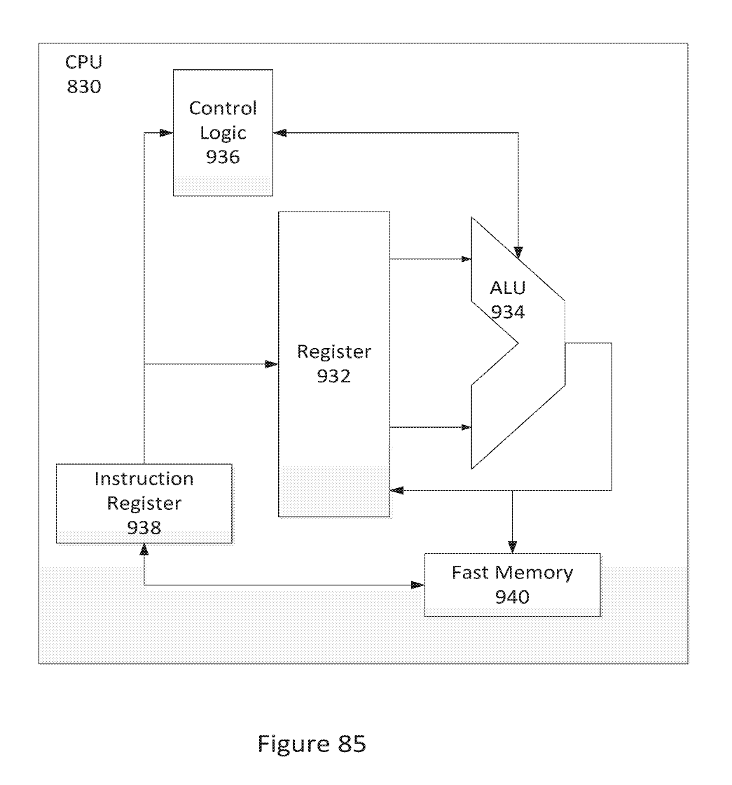

For example, FIG. 85 shows one implementation of CPU 830. In one implementation, an instruction register 938 retrieves instructions from a fast memory 940. At least part of these instructions are fetched from an instruction register 938 by a control logic 936 and interpreted according to the instruction set architecture of the CPU 830. Part of the instructions can also be directed to a register 932. In one implementation the instructions are decoded according to a hardwired method, and in another implementation the instructions are decoded according to a microprogram that translates instructions into sets of CPU configuration signals that are applied sequentially over multiple clock pulses.

After fetching and decoding the instructions, the instructions are executed using an arithmetic logic unit (ALU) 934 that loads values from the register 932 and performs logical and mathematical operations on the loaded values according to the instructions. The results from these operations can be fed back into the register 932 and/or stored in a fast memory 940.

According to aspects of the disclosure, the instruction set architecture of the CPU 830 can use a reduced instruction set computer (RISC), a complex instruction set computer (CISC), a vector processor architecture, or a very long instruction word (VLIW) architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor; a Power architecture processor by, e.g., IBM; a SPARC architecture processor by Sun Microsystems or by Oracle; or other known CPU architectures.

Referring again to FIG. 84, the data processing system 800 can include the SB/ICH 820 being coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 820 through a PCI bus 862.

The PCI devices can include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)). The network can be a private network, such as a LAN or WAN, or can be a public network, such as the Internet. Input to the system can be received via direct user input and received remotely either in real-time or as a batch process. Additionally, some implementations can be performed on modules or hardware not identical to those described. Accordingly, other implementations are within the scope that can be claimed.

The functions and features described herein may also be executed by various distributed components of a system. For example, one or more processors may execute these system functions, wherein the processors are distributed across multiple components communicating in a network. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized locations and accessible to multiple users who interact with the centralized processing locations through individual terminals.

The hardware description above, exemplified by any one of the structural examples illustrated in FIG. 83 or 84, constitutes or includes specialized corresponding structure that is programmed or configured to perform the methods described herein. For example, one or more of the methods may be completely performed by the circuitry included in the single device shown in FIG. 83, or the chipset as illustrated in FIG. 84. The one or more methods may also be completely performed in a shared manner distributed over the circuitry of any plurality of the devices.

In a discussion herein, the metrics suite is validated theoretically. The proposed metrics attempt to capture information about the system stability. Introducing any kind of measurements needs a proper validation to have a scientific basis. See L. Briand, K. El Emam, and S. Morasca, “Theoretical and empirical validation of software product measures,” International Software Engineering Research Network, Technical Report ISERN-95-03, 1995, incorporated herein by reference in its entirety. Therefore the metrics validation, whether theoretical or empirical, is not a purely objective exercise. See K. El-Emam, “A methodology for validating software product metrics,” 2000, incorporated herein by reference in its entirety.

The basic question whenever a metric is proposed is whether the measure captures the attribute it claims to depict. Accepting a product measure is the process of guaranteeing that the measure of the claimed attribute is a fitting numerical characterization by demonstrating that the representation condition is satisfied. See N. E. Fenton and S. L. Pfleeger, Software Metrics: A Rigorous and Practical Approach: PWS Publishing Co., 1998, incorporated herein by reference in its entirety. In other words, the theoretical validation confirms that the measure does not abuse any essential properties of the measurement elements. See K. Srinivasan and T. Devi, “Software Metrics Validation Methodologies in Software Engineering,” ed: IJSEA, 2014, incorporated herein by reference in its entirety.

Several frameworks were proposed to validate software metrics. Briand et al proposed a framework to validate cohesion metrics. See E. J. Weyuker, “Evaluating software complexity measures,” Software Engineering, IEEE Transactions on, vol. 14, pp. 1357-1365, 1988, incorporated herein by reference in its entirety. Weyuker introduced a framework to validate complexity metrics. However, no frameworks was found specifically to validate stability metrics. Therefore, a standard metrics validation framework was used, a Kitchenham framework, in order to validate the metrics theoretically.

Kitchenham et al. introduced the metric-evaluation framework to validate software metrics. See B. Kitchenham, S. L. Pfleeger, and N. Fenton, “Towards a Framework for Software Measurement Validation,” IEEE Trans. Softw. Eng., vol. 21, pp. 929-944, 1995, incorporated herein by reference in its entirety. They define various properties that a theoretically valid software metric should have. They identified a set of theoretical criteria that must be satisfied in order to propose a valid measure. The metric-evaluation framework has five models: a unit definition model, an attribute relationship model, an instrumentation model, a measurement protocol model, and an entity population model.

For a Unit definition model, a unit is defined for all measures, including ratio, scale, nominal, and ordinal. There are four types of the unit definition model: reference to a wider theory model, reference to a standard model, reference to a model involving several attributes model, and reference to conversion from another unit model. A metric has a valid unit if the used units are an appropriate means of measuring the attribute.

Reference to a standard determines a metric unit based on an application domain standard. Reference to a wider theory defines the unit for a metric based on the way in which an attribute is observed in a particular entity. Reference to conversion from another unit sets a metric unit by converting from a known unit. Reference to a model defines the unit of a composite metric by combining the units of the individual metrics involved.

The Instrumentation model defines the method used to perform the measurements. The instrumentation model is closely related to the unit definition. It has two types: the direct representational model and the indirect theory-based model. A metric has a valid instrument if the underlying measurement instrument is valid and adjusted properly.

An attribute may include other attributes, so the attribute relationship model was used to define the relationships among these attributes. There are two types of attribute relationship models, namely a definition model and a predictive model. The definition model is used to define a multi-dimensional attribute, while, the predictive model is used in the prediction of a specific attribute value based on other values.

The Measurement protocol model is concerned with how to measure an attribute consistently on a particular entity. The measurement protocol model's objective is to make a measure independent of the environment and the measurer. A metric has a valid protocol if a widely accepted measurement protocol is used.

The Entity population model sets the normal values of a metric. Kitchenham et al. introduced four properties which every metric must satisfy in order to be theoretically valid. These properties are:
1. “For an attribute to be measurable, it must allow different entities to be distinguished from one another”. This means, there must be two entities with different measurement values.
2. “A valid measure must obey the Representation Condition”. For example, in the instant case, if there are two entities and the first entity is less than the other entity in terms of selected properties, then the stability of the first entity must be less than the second entity.
3. “Each unit of an attribute contributing to a valid measure is equivalent”. This means that the entities that are measured alongside each other are equivalent. See L. Maciaszek, C. González-Pérez, and S. Jablonski, Evaluation of Novel Approaches to Software Engineering: 3rd and 4th International Conferences, ENASE 2008/2009, Funchal, Madeira, Portugal, May 4-7, 2008/Milan, Italy, May 9-10, 2009. Revised Selected Papers vol. 69. Berlin, Heidelberg: Springer, 2010, incorporated herein by reference in its entirety.
4. Different entities can have the same attribute value (within the limits of measurement error)”.

The metric for measuring class diagram stability was given the following parameters:
The entity is the class diagram being analyzed.
The attribute measured is the stability.
The unit is the percentage.
The data scale is an interval.

The SS (Structural Stability) conforms to Kitchenham's properties as follows:

Property 1:

Let there be two versions of a system, version i and version j where (j>i). Assume there are two classes, a class C1i in release i, and a corresponding class version C1i in release j. Assume another two classes, a class C2i in release i, and a corresponding class version C2j in release j. Let the C1i class have P1 properties, which are a1, a2, . . . , an and b1, b2, . . . , bx (x<=n), where the set of properties has remained unchanged between the two releases, release i and release j. Also, let the C2i class have P1 properties, which are c1, c2, . . . , cn and d1, d2, . . . , dy (y<=n) a set of properties has remained unchanged between the two releases, release i and release j. When x/P1≠y/P1, then Stability (C1)≠Stability (C2).

Property 2:

Let there be two versions of a system, version i and version j where (j>i). Assume there are two classes, a class C1i in release i, and a corresponding class version C1j in release j. Assume another two classes, a class C2i in release i, and a corresponding class version C2j in release j. Let the C1i class have P1 properties, which are a1, a2, . . . , an and b1, b2, . . . , bx (x<=n) a set of properties has remained unchanged between the two releases, release i and release j. Also, let the C2i class have P1 properties, which are c1, c2, . . . , cn and d1, d2, . . . , dy (y<=n) a set of properties has remained unchanged between the two releases, release i and release j. When x/P1>y/P1, then Stability (C1)>Stability (C2).

Property 3:

Let there be two versions of a system, version i and version j where (j>i). Assume there are two classes, a class C1i in release i, and a corresponding class version C1j in release j. Assume another two classes, a class C2i in release i, and a corresponding class version C2j in release j. Let the C1i class have P1 properties, which are a1, a2, . . . , an and b1, b2, . . . , bx (x<n) a set of properties has remained unchanged between the two releases, release i and release j. Also, let the C2i class have P1 properties, which are a1, a2, . . . , an and b1, b2, . . . , b(x+1) (x<n) a set of properties has remained unchanged between the two releases, release i and release j. Then Stability (C2)=Stability (C1)+1/P1.

Property 4:

Let there be two versions of a system, version i and version j where (j>i). Assume there are two classes, a class C1i in release i, and a corresponding class version C1j in release j. Assume another two classes, a class C2i in release i, and a corresponding class version C2j in release j. Let the C1i class have P1 properties, which are a1, a2, . . . , an and b1, b2, . . . , bx (x<=n) a set of properties has remained unchanged between the two releases, release i and release j. Also, let the C2i class have P1 properties, which are a1, a2, . . . , an and b1, b2, . . . , bx (x<=n) a set of properties has remained unchanged between the two releases, release i and release j. Then Stability (C1)=Stability (C2).

The proposed metric for measuring use-case diagram stability has the following parameters:
The entity is the use-case diagram being analyzed.
The attribute measured is the stability.
The unit is the percentage.
The data scale is an interval.

The FS (Functional Stability) conforms to Kitchenham's properties as follows:

Property 1:

Let there be two versions of a system, version i and version j where (j>i). Assume there are two identifiers, an identifier ID1i in release i, and a corresponding identifier version ID1j in release j. Assume another two identifiers, an identifier ID2i in release i, and a corresponding identifier version ID2j in release j. Let the identifier ID1i have P1 properties, which are a1, a2, . . . , an and b1, b2 . . . , bx (x<=n) a set of properties has remained unchanged between the two releases, release i and release j. Also, let the identifier ID2i have P1 properties, which are c1, c2, . . . , cn and d1, d2, . . . , dy (y<=n) a set of properties has remained unchanged between the two releases, release i and release j. When x/P1≠y/P1, then Stability (ID1)≠Stability (ID2).

Property 2:

Let there be two versions of a system, version i and version j where (j>i). Assume there are two identifiers, an identifier ID1i in release i, and a corresponding identifier version ID1j in release j. Assume another two identifiers, an identifier ID2i in release i, and a corresponding identifier version ID2j in release j. Let the identifier ID1i have P1 properties, which are a1, a2, . . . , an and b1, b2, . . . , bx (x<=n) a set of properties has remained unchanged between the two releases, release i and release j. Also, let the ID2i class have P1 properties, which are c1, c2, . . . , cn and d1, d2, . . . , dy (y<=n) a set of properties has remained unchanged between the two releases, release i and release j. When x/P1>y/P1, then Stability (ID1)>Stability (ID2).

Property 3:

Let there be two versions of a system, version i and version j where (>i). Assume there are two identifiers, an identifier ID1i in release i, and a corresponding identifier version ID1j in release j. Assume another two identifiers, an identifier ID2i in release i, and a corresponding identifier version ID2j in release j. Let the identifier ID1i have P1 properties, which are a1, a2 . . . , an and b1, b2, . . . , bx (x<n) a set of properties has remained unchanged between the two releases, release i and release j. Also, let the identifier ID2i have P1 properties, which are a1, a2, . . . , an and b1, b2, . . . , b(x+1) (x<n) a set of properties has remained unchanged between the two releases, release i and release j. Then Stability (ID2)=Stability (ID1)+1/P1.

Property 4:

Let there be two versions of a system, version i and version j where (j>i). Assume there are two identifiers, an identifier ID1i in release i, and a corresponding identifier version ID1j in release j. Assume another two identifiers, a identifier ID2i in release i, and a corresponding identifier version ID2j in release j. Let the identifier ID1i have P1 properties, which are a1, a2, . . . , an and b1, b2, . . . , bx (x<=n) a set of properties has remained unchanged between the two releases, release i and release j. Also, let the identifier ID2i have P1 properties, which are a1, a2, . . . , an and b1, b2 . . . , bx (x<=n) a set of properties has remained unchanged between the two releases, release i and release j. Then Stability (ID1)=Stability (ID2).

The proposed metric for measuring sequence-diagram stability has the following parameters:
The entity is the sequence diagram being analyzed.
The attribute measured is the stability.
The unit is the percentage.
The data scale is an interval.

The BS (Behavioral Stability) conforms to Kitchenham's properties as follows:

Property 1:

Let there be two versions of a system, version i and version j where (j>i). Assume there are two messages, a message M1i in release i, and a corresponding message version M1j in release j. Assume another two messages, a message M2i in release i, and a corresponding message version M2j in release j. Let the M1i class have the properties a1, a2, a3 and M1j have the properties b1, b2, b3, with x (x<=3) and properties have remained unchanged between the two releases, release i and release j. Also, let the M2i class have the properties c1, c2, c3 and M2j have the properties d1, d2, d3 with y (y<=3), and properties have remained unchanged between the two releases, release i and release j. When x/3≠y/3, then Stability (M1)≠Stability (M2).

Property 2:

Let there be two versions of a system, version i and version j where (j>i). Assume there are two messages, a message M1i in release i, and a corresponding message version M1j in release j. Assume another two messages, a message M2i in release i, and a corresponding message version M2j in release j. Let the M1i class have the properties a1, a2, a3 and M1j have the properties b1, b2, b3, with x (x<=3) properties have remained unchanged between the two releases, release i and release j. Also, let the M2i class have the properties c1, c2, c3 and M2ⱼ have the properties d1, d2, d3 with y (y<=³) properties have remained unchanged between the two releases, release i and release j. When/3>y/3, then Stability (M1)>Stability (M2).

Property 3:

Let there be two versions of a system, version i and version j where (j>i). Assume there are two messages, a message M1i in release i, and a corresponding message version M1j in release j. Assume another two messages, a message M2i in release i, and a corresponding message version M2j in release j. Let the M1i class have the properties a1, a2, a3 and M1j have the properties b1, b2, b3, with x (x<3), and properties have remained unchanged between the two releases, release i and release j. Also, let the M2i class have the properties a1, a2, a3 and M2j have the properties b1, b2, b3 with x+1 and properties have remained unchanged between the two releases, release i and release j. When and x/3>y/3, then Stability (M2)=Stability (M1)+1/3.

Property 4:

Let there be two versions of a system, version i and version j where (j>i). Assume there are two messages, a message M1i in release i, and a corresponding message version M1j in release j. Assume another two messages, a message M2i in release i, and a corresponding message version M2j in release j. Let the M1i class have the properties a1, a2, a3 and M1j have the properties b1, b2, b3, with x (x<=3) properties have remained unchanged between the two releases, release i and release j. Also, let the M2i class have the properties a1, a2, a3 and M2j have the properties b1, b2, b3 with x(x<=3) properties have remained unchanged between the two releases, release i and release j. Then Stability (M1)=Stability (M2).

A number of examples or models were selected for an experiment from two groups. The first group was published case studies, and three different case studies were selected. The other group was student projects. The student projects were designed by undergraduate students as a senior project, and three projects were selected from the best of them.

Before starting the experiment, a second version from each UML diagram was created. The creation of the diagram takes into consideration the most likely changes that can be introduced without affecting the core of the original version. A description of the examples used in the experiment are described herein.

Automated Teller Machine (ATM) was selected for a first example, in which a customer interacts with the ATM for various banking needs. See L. C. Briand, Y. Labiche, and L. O'Sullivan, “Impact analysis and change management of UML models,” in Software Maintenance, 2003. ICSM 2003. Proceedings. International Conference on, 2003, pp. 256-265, incorporated herein by reference in its entirety. The customer inserts his/her card and enters a PIN, which allows the customer to perform transactions, such as a withdrawal or a deposit. A receipt is issued by the ATM at the end of the transaction. The class diagram and sequence diagrams were used for the ATM example. For the sequence diagram, three diagrams were selected and the average number of messages was seven. Table 23 illustrates the ATM experimental summary.

TABLE 23
ATM Case Study Summary

| Diagram Type | System Name | Stability |
|---|---|---|
| Class Diagram | ATM | 0.694 |
| Sequence Diagram | ATMStartUp | 0.761 |
| Sequence Diagram | Deposit | 0.833 |
| Sequence Diagram | Withdrawal | 0.62 |

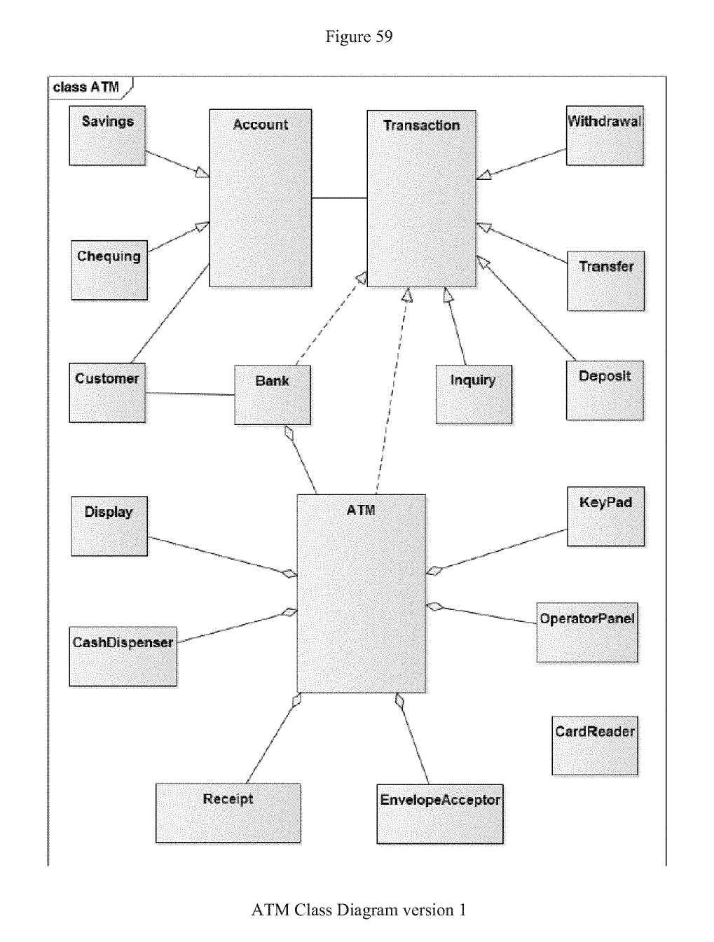

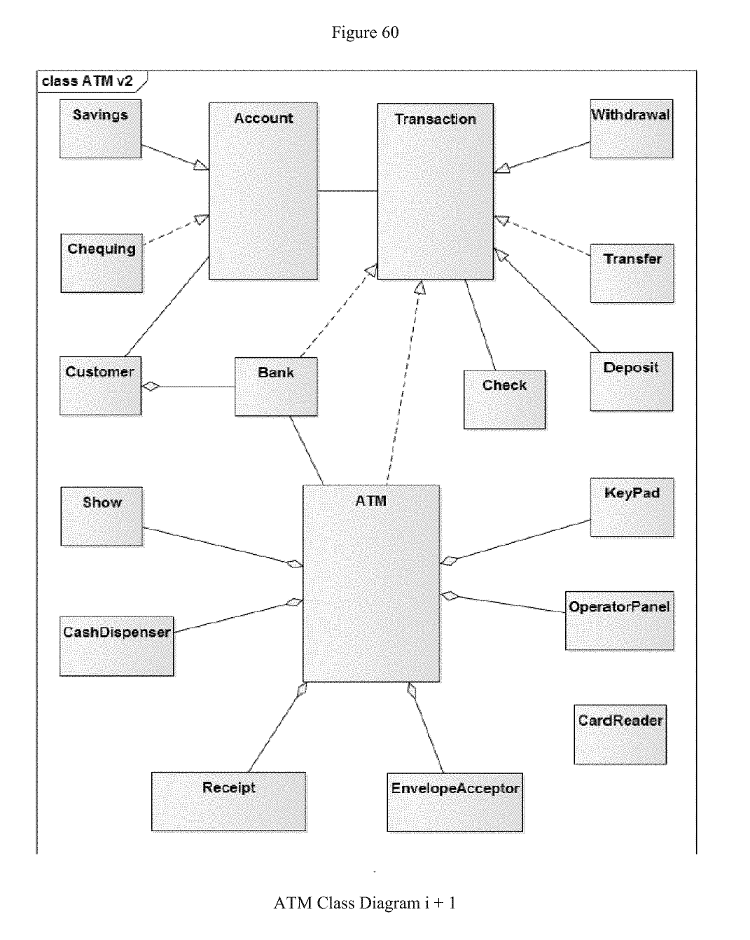

FIG. 59 and FIG. 60 illustrate ATM class diagram version 1 and version 2, respectively. Table 24 illustrates the comparison and Table 25 illustrates the computation results. Sixty-nine percent of version 1 of the class diagram remains in version 2. The cited figures and tables illustrate the implementation of stability metrics described herein for a class diagram, in which objects and interfaces of an ATM system are exemplified in a transformation from a first state to a second state to yield an improved ATM system.

TABLE 24
ATM Class Diagram Comparison

| | Version 1 | | Version 2 | |
|---|---|---|---|---|
| | Classifier | Classifier | Classifier | Classifier |
| Classifier Name | Type | Relationships | Type | Relationships |
| Savings | Class | Account-INH | Class | Account-INH |
| Account | Class | Customer-ASO | Interface | — |
| | | Transaction-ASO | | Transaction-ASO |
| Transaction | Interface | Account-ASO | Interface | Account-ASO |
| | | | | Check-ASO |
| Withdrawal | Class | Transaction-INH | Class | Transaction-INH |
| Chequing | Class | Account-INH | Class | Account-REA |
| Transfer | Class | Transaction-INH | Class | Transaction-REA |
| Customer | Class | Account-ASO | Class | Account-INH |
| | | Bank-ASO | | Bank-AGG |
| Bank | Class | Customer-ASO | Class | — |
| | | Transaction-REA | | Transaction-REA |
| | | ATM-AGG | | ATM-ASO |
| Inquiry | Class | Transaction-INH | DELETED | |
| Deposit | Class | Transaction-INH | Class | Transaction-INH |
| Display | Class | — | DELETED | |
| ATM | Class | Display-AGG | Class | Show-AGG |
| | | CashDispenser-AGG | | CashDispenser-AGG |
| | | Receipt-AGG | | Receipt-AGG |
| | | EnvelopeAcceptor-AGG | | EnvelopeAcceptor-AGG |
| | | CardReader-AGG | | CardReader-AGG |
| | | OperatorPanel-AGG | | OperatorPanel-COM |
| | | KeyPad-AGG | | KeyPad-AGG |
| Keypad | Class | — | Class | — |
| CashDispenser | Class | — | Class | — |
| OperatorPanel | Class | — | Class | — |
| Receipt | Class | — | Class | — |
| EnvelopeAcceptor | Class | — | Class | — |
| CardReader | Class | — | Class | — |

TABLE 25
ATM Class Diagram Comparison Results

| | | Number Of | Number Of | Changes/ |
|---|---|---|---|---|
| Classifier Name | Changes From version 1 to version 2 | Changes | Unique Pairs | Unique |
| Savings | — | 0 | 2 | 0 |
| Account | Class => Interface | 2 | 3 | 0.666 |
| | Customer-ASO => DELETED | | | |
| Transaction | Check-ASO => NEW | 1 | 3 | 0.333 |
| Withdrawal | — | 0 | 2 | 0 |
| Chequing | Account-INH => Account-REA | 1 | 2 | 0.5 |
| Transfer | Transaction-INH => Transaction-REA | 1 | 2 | 0.5 |
| Customer | Account-ASO => Account-INH | 2 | 3 | 0.666 |
| | Bank-ASO => Bank-AGG | | | |
| Bank | Customer-ASO => DELETED | 2 | 4 | 0.5 |
| | ATM-AGG => ATM-ASO | | | |
| Inquiry | DELETED | FULL | FULL | 1 |
| Deposit | — | 0 | 2 | 0 |
| Display | DELETED | FULL | FULL | 1 |
| ATM | Display-AGG => Deleted | 3 | 9 | 0.333 |
| | Show AGG => NEW | | | |
| | OperatorPanel-AGG => OperatorPanel- | | | |
| | COM | | | |
| KeyPad | — | 0 | 1 | 0 |
| CashDispenser | — | 0 | 1 | 0 |
| OperatorPanel | — | 0 | 1 | 0 |
| Receipt | — | 0 | 1 | 0 |
| EnvelopeAcceptor | — | 0 | 1 | 0 |
| CardReader | — | 0 | 1 | 0 |

| | |
|---|---|
| SUM | 5.5 |
| Instability | 0.305 |
| Stability | 0.695 |

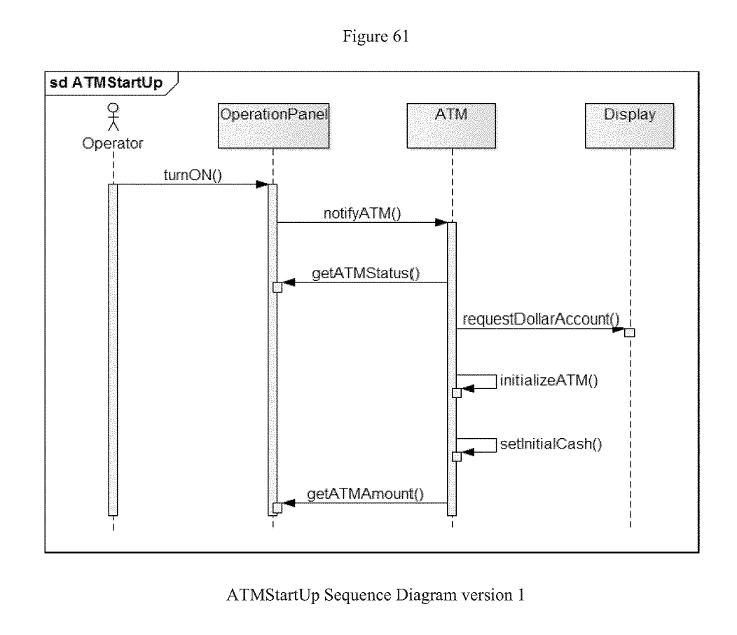

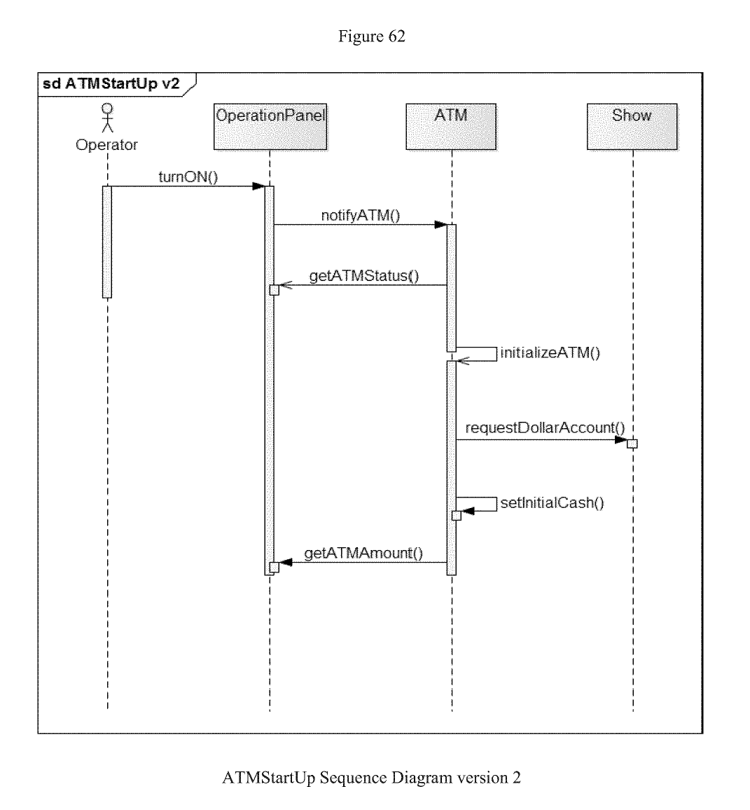

FIG. 61 and FIG. 62 illustrate the first version and second version of the ATMStartUp sequence diagram, respectively. The comparison is illustrated in Table 26. The second version of the sequence diagram kept 76% of the first version, as illustrated in the Table 27 computations. The cited figures and tables illustrate the implementation of stability metrics described herein for a sequence diagram, in which entities and transactions of an ATM system are exemplified in a transformation from a first state to a second state to yield an improved ATM system.

TABLE 26
ATMStartUp Sequence Diagrams Comparison

| The Identifier | | Properties | | | | | |
|---|---|---|---|---|---|---|---|
| | Message | Message Caller | | Message Type | | Message Order | |
| Message Name | Receiver | version 1 | version 2 | version 1 | version 2 | version 1 | version 2 |
| teurnON | OperationPanel | Operator | Operator | Synchronous | Synchronous | 1 | 1 |
| notifyATM | ATM | OperationPanel | OperationPanel | Synchronous | Synchronous | 2 | 2 |
| getATMStatus | OperationPanel | ATM | ATM | Synchronous | Asynchronous | 3 | 3 |
| requestDollarAccount | Display | DELETED in version 2 | | | | | |
| initializeATM | ATM | ATM | ATM | Synchronous | Asynchronous | 5 | 4 |
| setInitialCash | ATM | ATM | ATM | Synchronous | Synchronous | 6 | 6 |
| getATMAmount | OperationPanel | OperationPanel | OperationPanel | Synchronous | Synchronous | 7 | 7 |

TABLE 27
ATMStartUp Sequence Diagrams Comparison Results

| Message Name | Message Receiver | Changes | Changes/NMP |
|---|---|---|---|
| teurnON | Bank | 0 | 0 |
| notifyATM | Deposit | 0 | 0 |
| getATMStatus | Deposit | 1 | 0.333 |
| requestDollarAccount | Account | FULL | 1 |
| initializeATM | Account | 1 | 0.333 |
| setInitialCash | EnvelopeAcceptor | 0 | 0 |
| getATMAmount | OperationPanel | 0 | 0 |

| | |
|---|---|
| Sum | 1.666 |
| Instability | 0.238 |
| Stability | 0.762 |

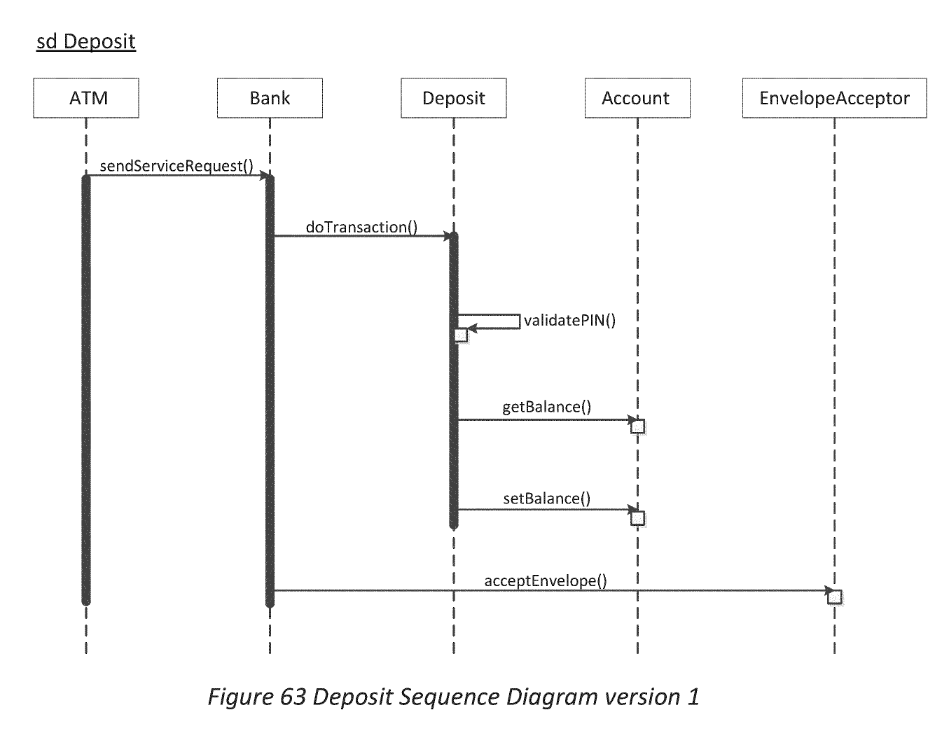

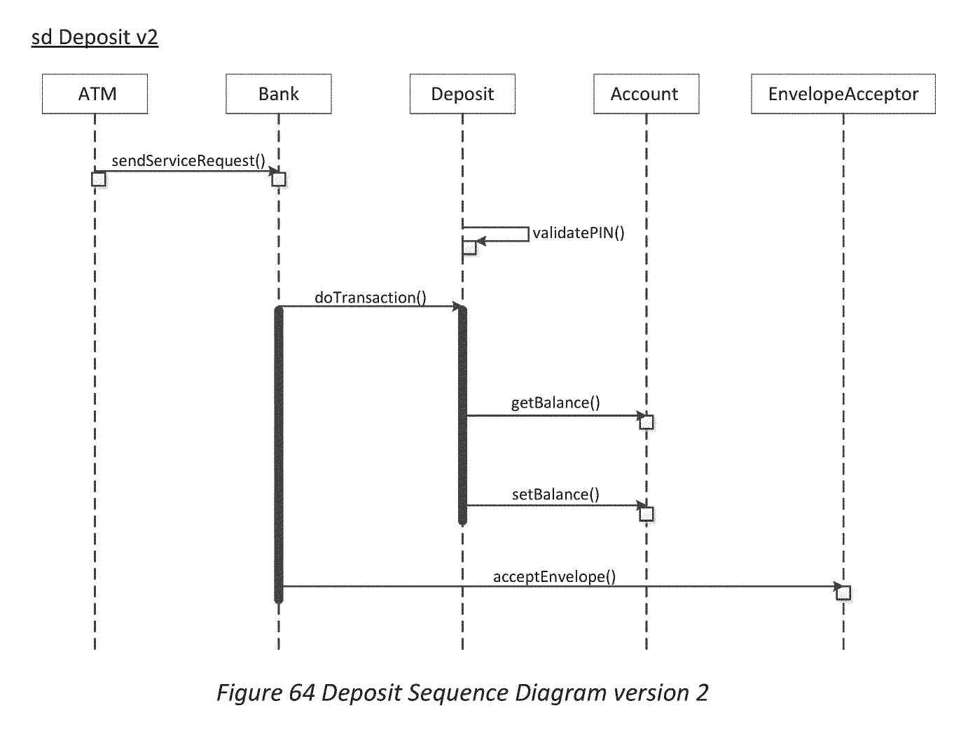

FIG. 63 and FIG. 64 illustrate the Deposit sequence diagram of version 1 and version 2, respectively. The comparison is illustrated in Table 28. Eighty-three percent of the first version remains in the second version, as illustrated in the Table 29 computations.

TABLE 28
Deposit Sequence Diagrams Comparison

| | | Properties | | | | | |
|---|---|---|---|---|---|---|---|
| The Identifier | | Message Caller | | Message Type | | Message Order | |
| Message Name | Message Receiver | version 1 | version 2 | version 1 | version 2 | version 1 | version 2 |
| sendServiceRequest | Bank | ATM | ATM | Synchronous | Synchronous | 1 | 1 |
| doTrasaction | Deposit | Bank | Bank | Synchronous | Synchronous | 2 | 3 |
| validatePIN | Deposit | Deposit | Deposit | Synchronous | Synchronous | 3 | 2 |
| getBalance | Account | Deposit | Deposit | Synchronous | Asynchronous | 4 | 4 |
| setBalance | Account | Deposit | Deposit | Synchronous | Synchronous | 5 | 5 |
| acceptEnvelope | EnvelopeAcceptor | Bank | Bank | Synchronous | Synchronous | 6 | 6 |

TABLE 29
Deposit Sequence Diagrams Comparison Results

| Message Name | Message Receiver | Changes | Changes/NMP |
|---|---|---|---|
| sendServiceRequest | Bank | 0 | 0 |
| doTransaction | Deposit | 1 | 0.333 |
| validatePIN | Deposit | 1 | 0.333 |
| getBalance | Account | 1 | 0.333 |
| setBalance | Account | 0 | 0 |
| acceptEnvelope | EnvelopeAcceptor | 0 | 0 |

| | |
|---|---|
| Sum | 1 |
| Instability | 0.167 |
| Stability | 0.833 |

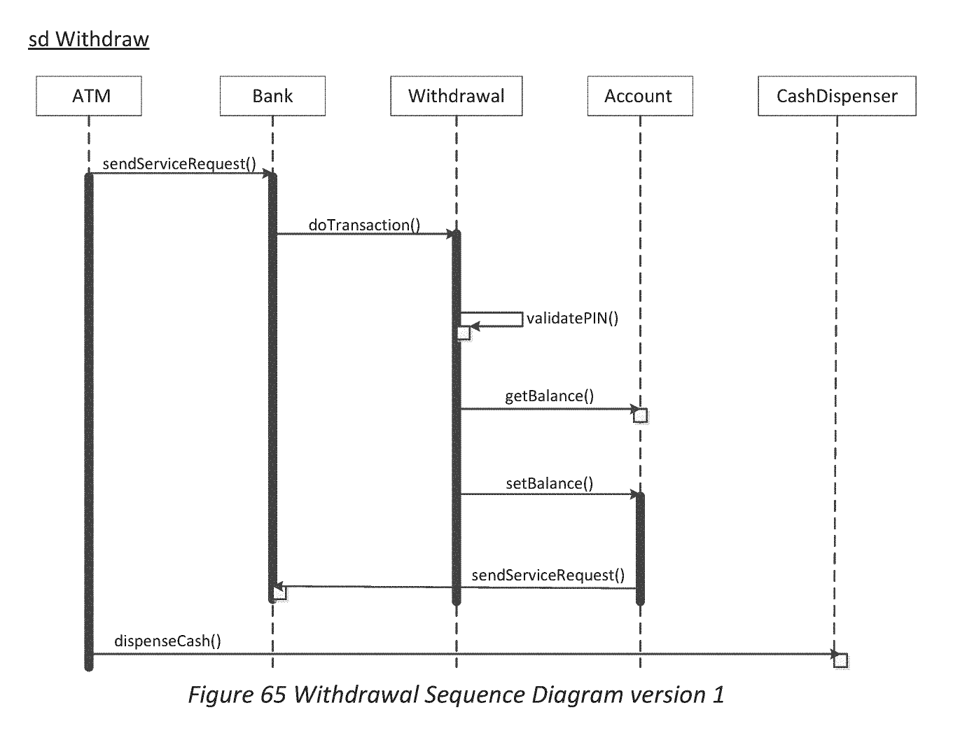

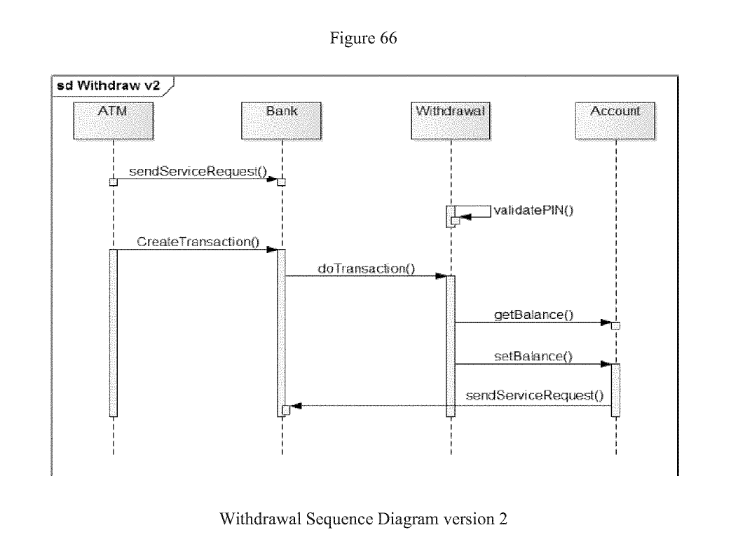

FIG. 65 and FIG. 66 illustrate the first version and second version of the Withdrawal sequence diagram, respectively. The comparison is illustrated in Table 30. The second version of the sequence diagram kept 62% of the first version, as illustrated in Table 31 computations.

TABLE 30
Withdrawal Sequence Diagrams Comparison

| | | Properties | | | | | |
|---|---|---|---|---|---|---|---|
| The Identifier | | Message Caller | | Message Type | | Message Order | |
| Message Name | Message Receiver | version 1 | version 2 | version 1 | version 2 | version 1 | version 2 |
| sendServiceRequest | Bank | ATM | ATM | Synchronous | Synchronous | 1 | 1 |
| doTransaction | Withdrawal | Bank | Bank | Synchronous | Synchronous | 2 | 4 |
| validatePIN | Withdrawal | Withdrawal | Withdrawal | Synchronous | Synchronous | 3 | 2 |
| getBalance | Account | Withdrawal | Withdrawal | Synchronous | Synchronous | 4 | 5 |
| setBalance | Account | Withdrawal | Withdrawal | Synchronous | Synchronous | 5 | 6 |
| sendServiceRequest | Bank | Account | Account | Synchronous | Synchronous | 6 | 7 |

| | | |
|---|---|---|
| dispenseCash | CashDispenser | DELETED in version 2 |

TABLE 31
Withdrawal Sequence Diagrams Results

| Message Name | Message Receiver | Changes | Changes/NMP |
|---|---|---|---|
| sendServiceRequest | Bank | 0 | 0 |
| doTransaction | Withdrawal | 1 | 0.333 |
| validatePIN | Withdrawal | 1 | 0.333 |
| getBalance | Account | 1 | 0.333 |
| setBalance | Account | 1 | 0.333 |
| sendServiceRequest | Bank | 1 | 0.333 |
| dispenseCash | CashDispenser | FULL | 1 |

| | |
|---|---|
| Sum | 2.666 |
| Instability | 0.38 |
| Stability | 0.62 |

The cited figures and tables illustrate the implementation of stability metrics described herein for deposit and withdrawal sequence diagrams, in which message properties of an ATM system are exemplified in a transformation from a first state to a second state to yield an improved ATM system.

A retailer subsystem was selected from a Supply Chain Management (SCM) application for a second example. See M. Chapman, M. Goodner, B. Lund, B. McKee, and R. Rekasius, “Supply Chain Management Sample Application Architecture,” Web Services Ineroperabilily Organization, 2003, incorporated herein by reference in its entirety. The Retailer's purpose is to present a web service for a third party system. The class diagram and the existing sequence diagrams were used in the experimentation. The class diagram has nine classifiers. For the sequence diagram, three diagrams were selected, and the average number of messages was three.

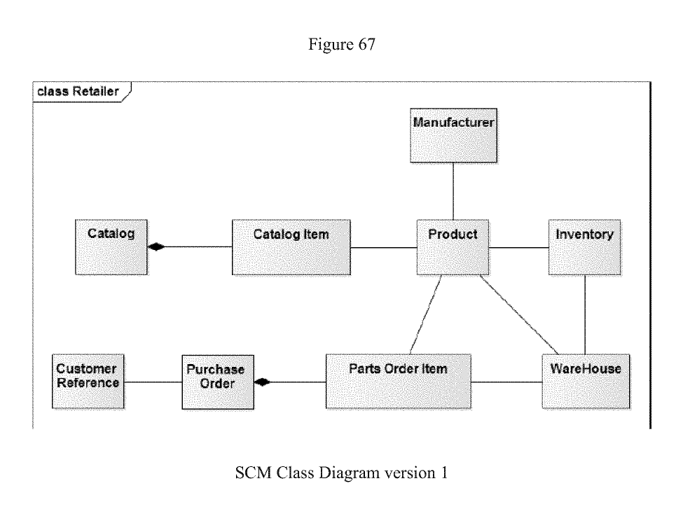

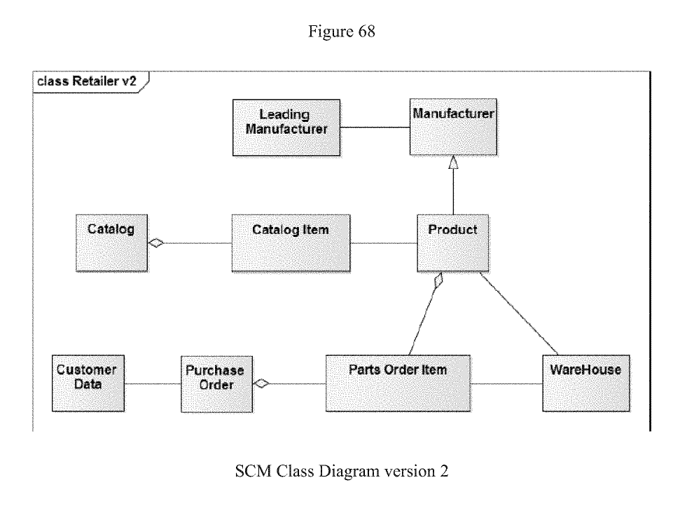

Table 32 illustrates the experimental summary. FIG. 67 and FIG. 68 illustrate the Retailer class diagram version 1 and version 2, respectively. Table 33 illustrates the comparison, and Table 34 illustrates the computation results. Sixty-six percent of version 1 of the class diagram remains in version 2. The cited figures and tables illustrate the implementation of stability metrics described herein for a class diagram, in which objects and interfaces of a SCM system are exemplified in a transformation from a first state to a second state to yield an improved SCM system.

TABLE 32
SCM Case Study Summary

| Diagram Type | System Name | Stability |
|---|---|---|
| Class Diagram | Retailer | 0.462 |
| Sequence Diagram | Purchase | 0.666 |
| Sequence Diagram | Replenish | 0.444 |
| Sequence Diagram | Source | 0.666 |

TABLE 33
SCM Class Diagrams Comparison

| | Version 1 | | Version 2 | |
|---|---|---|---|---|
| | Classifier | Classifier | Classifier | Classifier |
| Classifier Name | Type | Relationships | Type | Relationships |
| Manufacturer | Class | Product-ASO | Class | — |
| | | — | | LeadingManufacturer-ASO |
| Catalog | Class | CatalogItem-COM | Class | CatalogItem-AGG |
| Catalog Item | Class | Product-ASO | Class | Product-ASO |
| Product | Class | CatalogItem-ASO | Class | CatalogItem-ASO |
| | | Inventory-ASO | | Inventory-ASO |
| | | Manufacturer-ASO | | Manufacturer-INH |
| | | PartsOrderItem-ASO | | PartsOrderItem-AGG |
| | | WareHouse-ASO | | WareHouse-ASO |
| Inventory | Class | Product-ASO | DELETED | |
| | | WareHouse-ASO | | |
| Customer Reference | Class | PurchaseOrder-ASO | DELETED | |
| Purchase Order | Class | CustomerReference-ASO | Class | — |
| | | PartsOrderItem-COM | | PartsOrderItem-AGG |
| | | — | | CustomerData-ASO |
| Parts Order Item | Class | Product-ASO | Class | — |
| | | WareHouse-ASO | | WareHouse-ASO |
| WareHouse | Class | Inventory-ASO | Class | — |
| | | Product-ASO | | Product-ASO |
| | | PartsOrderItem-ASO | | PartsOrderItem-ASO |

TABLE 34
SCM Class Diagram Comparison Results

| | | Number Of | Number Of | Changes/ |
|---|---|---|---|---|
| Classifier Name | Changes From version 1 to version 2 | Changes | Unique Pairs | Unique |
| Manufacturer | Product-ASO => DELETED | 2 | 3 | 0.666 |
| | LeadingManufacturer-ASO => NEW | | | |
| Catalog | CatalogItem-COM => CatalogItem-AGG | 1 | 2 | 0.5 |
| Catalog Item | — | 0 | 2 | 0 |
| Product | Manufacturer-ASO => Manufacturer-INH | 2 | 6 | 0.333 |
| | PartsOrderItem-ASO => PartsOrderItem-AGG | | | |
| Inventory | DELETED | FULL | FULL | 1 |
| Customer Reference | DELETED | FULL | FULL | 1 |
| Purchase Order | CustomerReference-ASO => DELETED | 3 | 4 | 0.75 |
| | PartsOrderItem-COM => PartsOrderItem-AGG | | | |
| | CustomerData-ASO => NEW | | | |
| Parts Order Item | Product-ASO => DELETED | 1 | 3 | 0.333 |
| WareHouse | Inventory-ASO => DELETED | 1 | 4 | 0.25 |

| | |
|---|---|
| SUM | 4.833 |
| Instability | 0.537 |
| Stability | 0.463 |

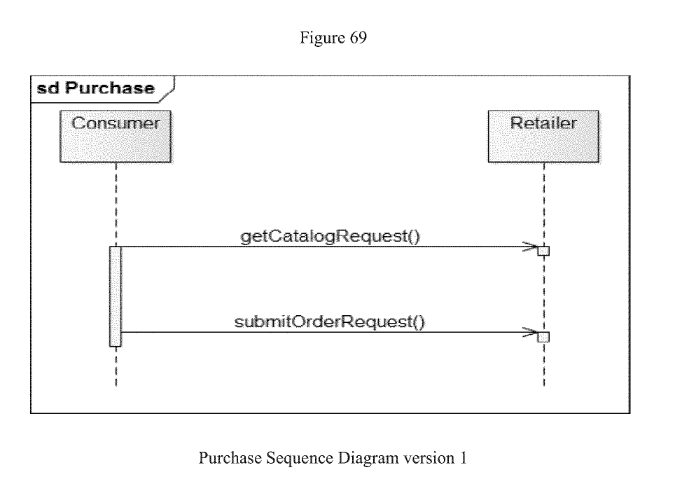

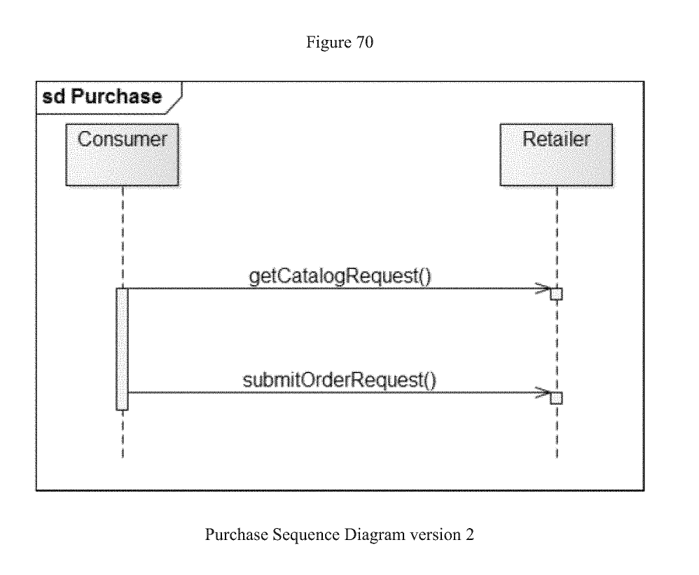

FIG. 69 and FIG. 70 illustrate the first version and the second version of the Purchase sequence diagram, respectively. The comparison is illustrated in Table 35. The second version of the sequence diagram kept 76% of the first version, as illustrated in Table 36 computations. The cited figures and tables illustrate the implementation of stability metrics described herein for a Purchase sequence diagram, in which message properties of an SCM system are exemplified in a purchase transformation from a first state to a second state to yield an improved SCM system.

TABLE 35
Purchase Sequence Diagram Comparison

| | | Properties | | | | | |
|---|---|---|---|---|---|---|---|
| The Identifier | | Message Caller | | Message Type | | Message Order | |
| Message Name | Message Receiver | version 1 | version 2 | version 1 | version 2 | version 1 | version 2 |
| getCatalogRequest | Retailer | Consumer | Consumer | Asynchronous | Synchronous | 1 | 1 |
| submitOrderRequest | Retailer | Consumer | Consumer | Asynchronous | Synchronous | 2 | 2 |

TABLE 36
Purchase Sequence Diagram Comparison Results

| Message Name | Message Receiver | Changes | Changes/NMP |
|---|---|---|---|
| getCatalogRequest | Retailer | 1 | 0.333 |
| submitOrderRequest | Retailer | 1 | 0.333 |

| | |
|---|---|
| Sum | 0.666 |
| Instability | 0.333 |
| Stability | 0.667 |

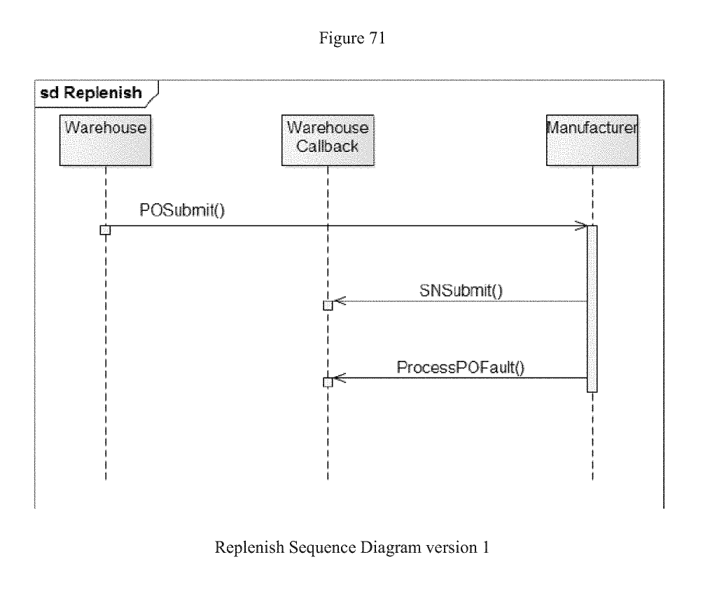

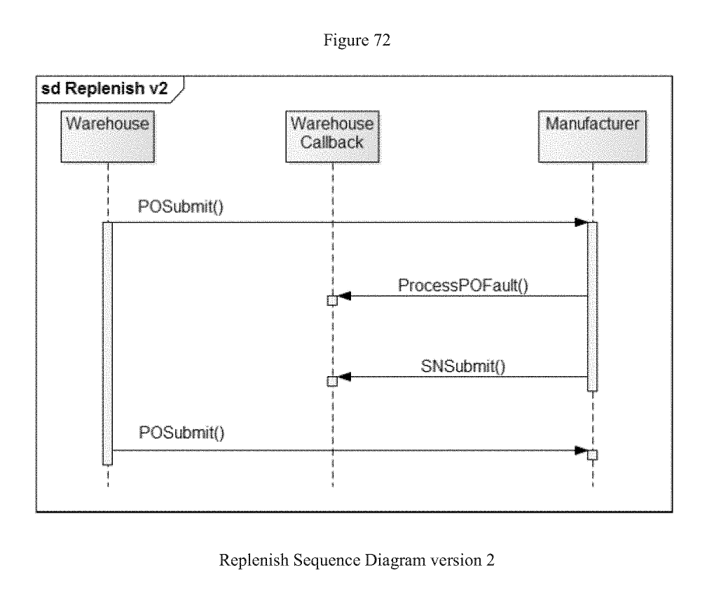

FIG. 71 and FIG. 72 illustrate the Replenish sequence diagram version I and version 2, respectively. The comparison is illustrated in Table 37. Forty-four percent of the first version remains in the second version, as illustrated in Table 38 computations. The cited figures and tables illustrate the implementation of stability metrics described herein for a Replenish sequence diagram, in which message properties of an SCM system are exemplified in a warehouse replenish transformation from a first state to a second state to yield an improved SCM system.

TABLE 37
Replenish Sequence Diagram Comparison

| | | Properties | | | | | |
|---|---|---|---|---|---|---|---|
| The Identifier | | Message Caller | | Message Type | | Message Order | |
| Message Name | Message Receiver | version 1 | version 2 | version 1 | version 2 | version 1 | version 2 |
| POSubunit | Manufacturer | Warehouse | Warehouse | Asynchronous | Synchronous | 1 | 1 |
| SNSubunit | Warehouse Callback | Manufacturer | Manufacturer | Asynchronous | Synchronous | 2 | 3 |
| ProcessPOFault | Warehouse Callback | Manufacturer | Manufacturer | Asynchronous | Synchronous | 3 | 2 |

TABLE 38
Replenish Sequence Diagram Comparison Results

| Message Name | Message Receiver | Changes | Changes/NMP |
|---|---|---|---|
| POSubmit | Manufacturer | 1 | 0.333 |
| SNSubmit | Warehouse Callback | 2 | 0.666 |
| ProcessPOFault | Warehouse Callback | 2 | 0.666 |

| | |
|---|---|
| Sum | 1.666 |
| Instability | 0.555 |
| Stability | 0.445 |

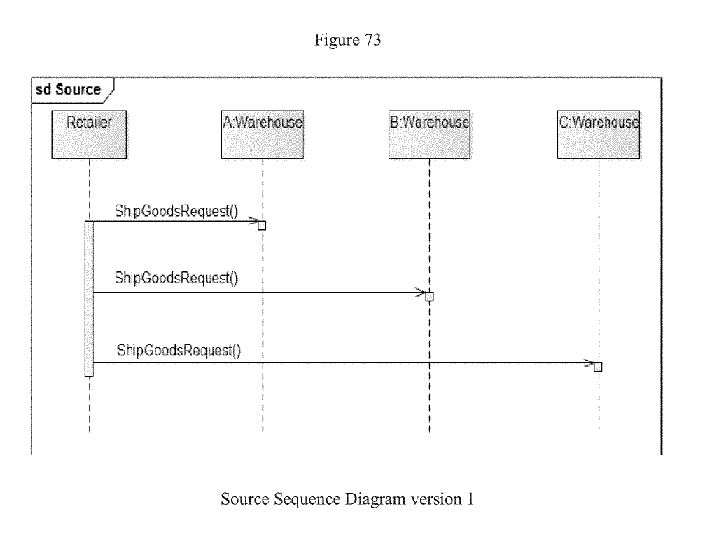

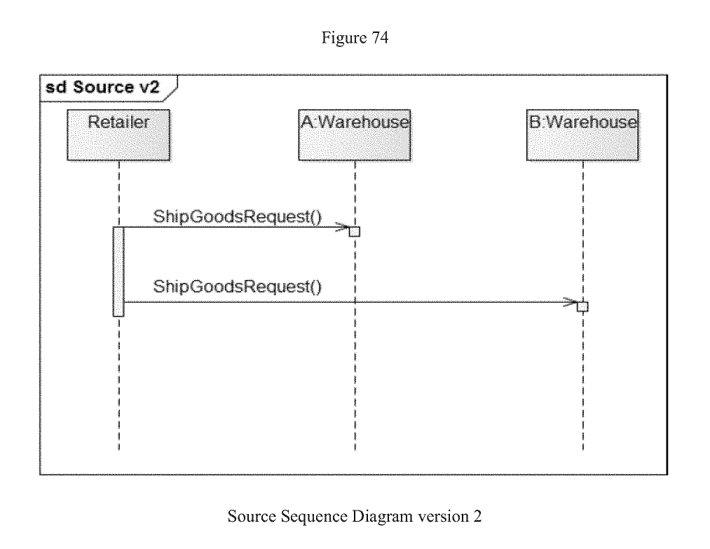

FIG. 73 and FIG. 74 illustrate the first version and the second version of Source sequence diagram, respectively. The comparison is illustrated in Table 39. The second version of the sequence diagram kept 66% of the first version, as illustrated in Table 40 computations. The cited figures and tables illustrate the implementation of stability metrics described herein for a Source sequence diagram, in which message properties of an SCM system are exemplified in a goods source transformation from a first state to a second state to yield an improved SCM system.

TABLE 39
Source Sequence Diagram Comparison

| The Identifier | | Properties | | | | | |
|---|---|---|---|---|---|---|---|
| | Message | Message Caller | | Message Type | | Message Order | |
| Message Name | Receiver | version 1 | version 2 | version 1 | version 2 | version 1 | version 2 |
| ShipGoodsRequest | Warehouse | Retailer | Retailer | Asynchronous | Asynchronous | 1 | 1 |
| ShipGoodsRequest | Warehouse | Retailer | Retailer | Asynchronous | Asynchronous | 2 | 2 |

| | | |
|---|---|---|
| ShipGoodsRequest | Warehouse | DELETED in version 2 |

TABLE 40
Source Sequence Diagram Comparison Results

| Message Name | Message Receiver | Changes | Changes/NMP |
|---|---|---|---|
| ShipGoodsRequest | Warehouse | 0 | 0 |
| ShipGoodsRequest | Warehouse | 0 | 0 |
| ShipGoodsRequest | Warehouse | Full | 1 |

| | |
|---|---|
| Sum | 1 |
| Instability | 0.333 |
| Stability | 0.667 |

A use case diagram was used for an On Road Assistance (ORA) application in a third example. See N. Koch, “Automotive case study: UML specification of on road assistance scenario,” Technical Report 1, FAST2007, incorporated herein by reference in its entirety. The diagram contains 13 use cases and five different actors.

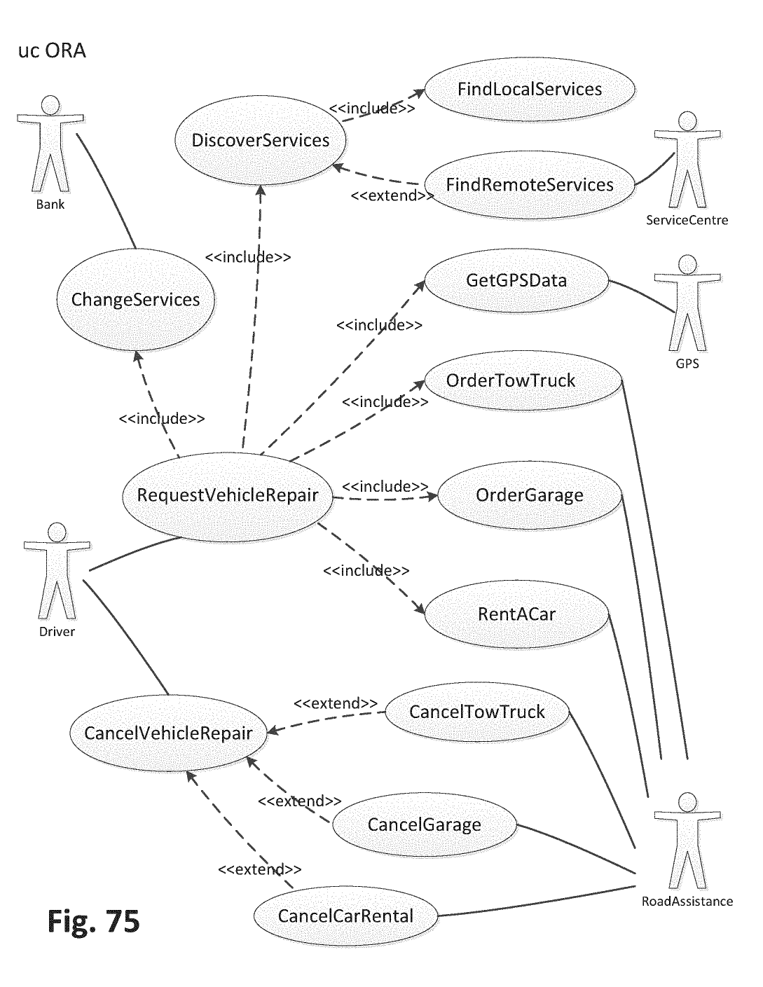

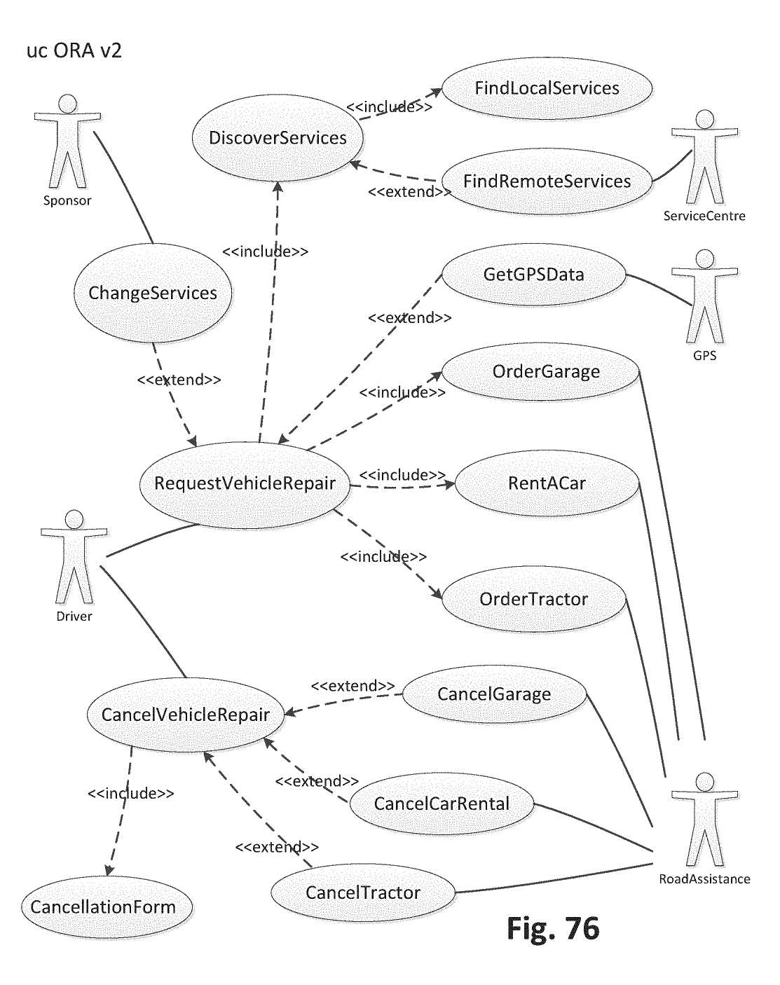

FIG. 75 and FIG. 76 show a Retailer use-case diagram version 1 and version 2, respectively. Table 41 illustrates the comparison and Table 42 illustrates the computation results. Seventy-eight percent of use-case version 1 remains in version 2. The cited figures and tables illustrate the implementation of stability metrics described herein for a use-case diagram, in which actors and actor relationships interface in an ORA system, which are exemplified in a transformation from a first state to a second state to yield an improved ORA system.

TABLE 41
ORA Use Case Diagram Comparison

| | Version 1 | | Version 2 | |
|---|---|---|---|---|
| | Identifier | Identifier | Identifier | Identifier |
| Identifier Name | Type | Relationships | Type | Relationships |
| Bank | DELETED - Change the name to Sponsor | | | |
| ChangeServices | Use Case | Bank-ASO | Use Case | — |
| | | — | | RequestVechicleRepair-EX |
| | | — | | Sponsor-ASO |
| DiscoverServices | Use Case with | FindLocalServies-INC | Use Case with | FindLocalServies-INC |
| | Extension Point | | Extension Point | |
| FindLocalServies | Use Case | — | Use Case | — |
| FindRemoteServices | Use Case | ServiceCentre-ASO | Use Case | ServiceCentre-ASO |
| | | DiscoverServices-EX | | DiscoverServices-EX |
| ServiceCentre | Actor | FindRemoteServices-ASO | Actor | FindRemoteServices-ASO |
| Driver | Actor | RequestVechicleRepair-ASO | Actor | RequestVechicleRepair-ASO |
| | | CancelVechicleRepair-ASO | | CancelVechicleRepair-ASO |
| RequestVechicleRepair | Use Case | ChangeServices-INC | Use Case with | — |
| | | DiscoverServices-INC | Extension Point | DiscoverServices-INC |
| | | GetGPSData-INC | | — |
| | | OrderTwoTruck-INC | | OrderTwoTruck-INC |
| | | OrderGrage-INC | | OrderGrage-INC |
| | | RentACar-INC | | RentACar-INC |
| CancelVechicleRepair | Use Case with | Driver-ASO | Use Case with | Driver-ASO |
| | Extension Point | — | Extension Point | CancellationForm-INC |
| GetGPSData | Use Case | GPS-ASO | Use Case | GPS-ASO |
| | | — | | RequestVechicleRepair-EX |
| GPS | Actor | GetGPSData-ASO | Actor | GetGPSData-ASO |
| OrderTwoTruck | DELETED - Change the name in OderTractor | | | |
| OrderGrage | Use Case | RoadAssistance-ASO | Use Case | RoadAssistance-ASO |
| RentACar | Use Case | RoadAssistance-ASO | Use Case | RoadAssistance-ASO |
| CancelTwoTruck | Use Case | RoadAssistance-ASO | Use Case | RoadAssistance-ASO |
| | | CancelVechicleRepair-EX | | CancelVechicleRepair-EX |
| CancelGrage | Use Case | RoadAssistance-ASO | Use Case | RoadAssistance-ASO |
| | | CancelVechicleRepair-EX | | CancelVechicleRepair-EX |
| CancelCarRental | Use Case | RoadAssistance-ASO | Use Case | RoadAssistance-ASO |
| | | CancelVechicleRepair-EX | | CancelVechicleRepair-EX |
| RoadAssistance | Actor | OrderTwoTruck-ASO | Actor | OrderTwoTruck-ASO |
| | | OrderGrage-ASO | | OrderGrage-ASO |
| | | RentACar-ASO | | RentACar-ASO |
| | | CancelTwoTruck-ASO | | CancelTwoTruck-ASO |
| | | CancelGrage-ASO | | CancelGrage-ASO |
| | | CancelCarRental-ASO | | CancelCarRental-ASO |

TABLE 42
ORA Class Diagram Comparison Results

| | | Number Of | Number Of | Changes/ |
|---|---|---|---|---|
| Identifier Name | Changes From version 1 to version 2 | Changes | Unique Pairs | Unique |
| Bank | DELETED | FULL | — | 1 |
| ChangeServices | Bank-ASO => DELETED | 3 | 4 | 0.75 |
| | RequestVechicleRepair-EX => NEW | | | |
| | Sponsor-ASO => NEW | | | |
| DiscoverServices | — | 0 | — | 0 |
| FindLocalServies | — | 0 | — | 0 |
| FindRemoteServices | — | 0 | — | 0 |
| ServiceCentre | — | 0 | — | 0 |
| Driver | — | 0 | — | 0 |
| RequestVechicleRepair | Use Case => Use Case with Extension Point | 3 | 7 | 0.428 |
| | ChangeServices-INC => DELETED | | | |
| | GetGPSData-INC => DELETED | | | |
| CancelVechicleRepair | CancellationForm-INC => NEW | 1 | 3 | 0.333 |
| GetGPSData | RequestVechicleRepair-EX => NEW | 1 | 3 | 0.333 |
| GPS | — | 0 | — | 0 |
| OrderTwoTruck | DELETED | FULL | — | 1 |
| OrderGrage | — | 0 | — | 0 |
| RentACar | — | 0 | — | 0 |
| CancelTwoTruck | — | 0 | — | 0 |
| CancelGrage | — | 0 | — | 0 |
| CancelCarRental | — | 0 | — | 0 |
| RoadAssistance | — | 0 | — | 0 |

| | |
|---|---|
| SUM | 3.845 |
| Instability | 0.214 |
| Stability | 0.786 |

An Online Real Estate Directory (O-RED) application was used in a fourth example to provide an online directory of the real estate offers to serve the end user. A user-management class diagram was used, which has eleven classifiers.

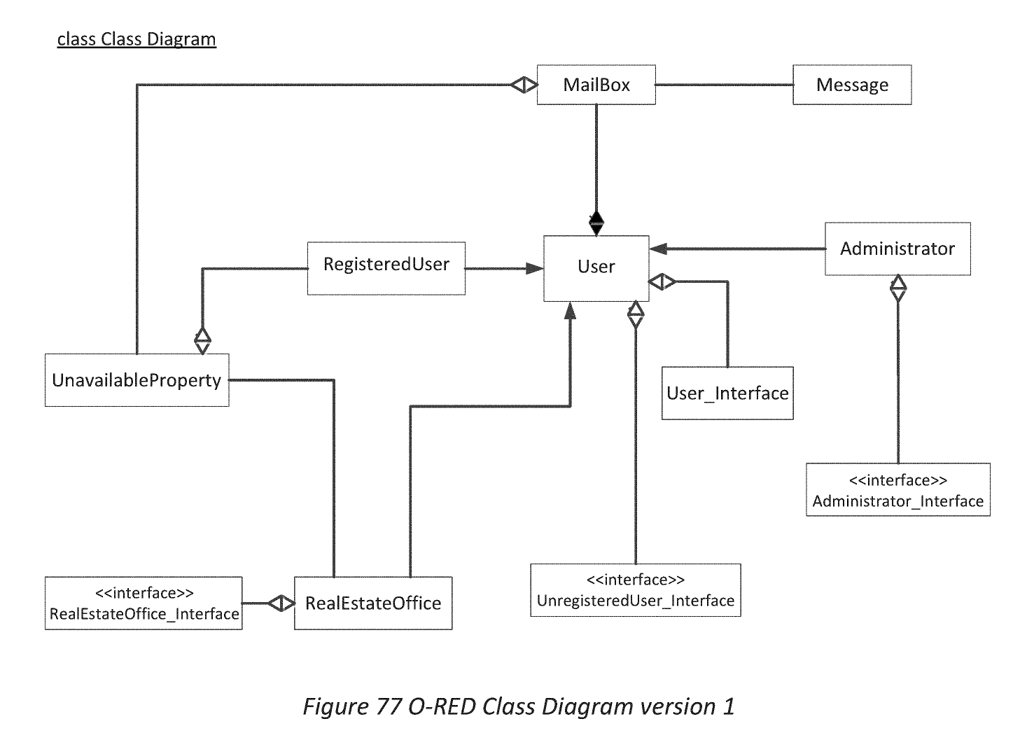

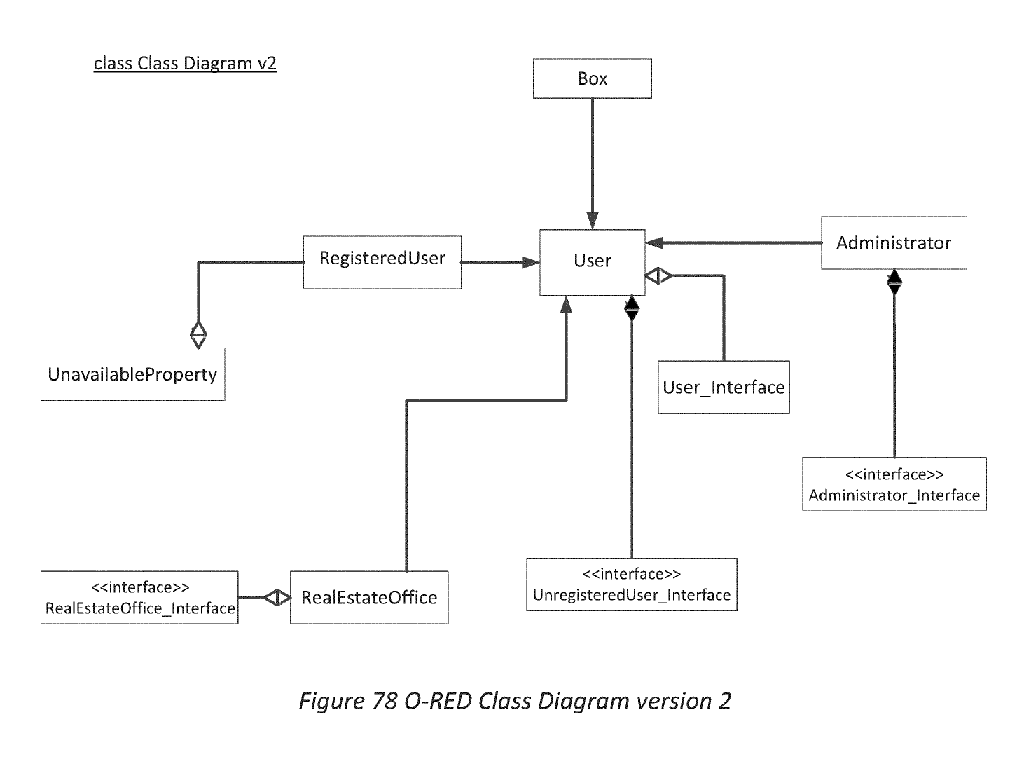

FIG. 77 and FIG. 78 illustrate Retailer class diagram version 1 and version 2, respectively. Table 43 illustrates the comparison and Table 44 illustrates the computation results. Seventy-one percent of version 1 of the class diagram remains in version 2. The cited figures and tables illustrate the implementation of stability metrics described herein for a class diagram, in which objects and interfaces of an O-RED system are exemplified in a transformation from a first state to a second state to yield an improved O-RED system.

TABLE 43
O-RED Class Diagram Comparison

| | Version 1 | | Version 2 | |
|---|---|---|---|---|
| | Classifier | Classifier | Classifier | Classifier |
| Classifier Name | Type | Relationships | Type | Relationships |
| MailBox | Class | Message-ASO | DELETED | |
| | | UnavailableProperty-AGG | | |
| Message | Class | MailBox-ASO | DELETED | |
| UnavailableProperty | Class | RegisteredUser-AGG | Class | RegisteredUser-AGG |
| | | RealEstateOffice-ASO | | — |
| RegisteredUser | Class | User-INH | Class | User-INH |
| User | Class | MailBox-COM | Class | — |
| | | User_Interface-AGG | | User_Interface-AGG |
| | | UnregisteredUser_Interface-AGG | | UnregisteredUser_Interface-AGG |
| Administrator | Class | User-INH | Class | User-INH |
| | | Administrator_Interface-AGG | | Administrator_Interface-COM |
| Administrator_Interface | Interface | — | Interface | — |
| User_Interface | Interface | — | Interface | — |
| UnregisteredUser_Interface | Interface | — | Interface | — |
| RealEstateOffice | Class | User-INH | Class | User-INH |
| | | UnavailableProperty-ASO | | — |
| | | RealEstateOffice_Interface- | | RealEstateOffice_Interface-AGG |
| RealEstateOffice_Interface | Interface | — | Interface | — |

TABLE 44
O-RED Class Diagram Comparison Results

| | | Number Of | Number Of | Changes/ |
|---|---|---|---|---|
| Classifier Name | Changes From version 1 to version 2 | Changes | Unique Pairs | Unique |
| MailBox | DELETED | FULL | FULL | 1 |
| Message | DELETED | FULL | FULL | 1 |
| UnavailableProperty | RealEstateOffice-ASO => DELETED | 1 | 3 | 0.333 |
| RegisteredUser | — | 0 | — | 0 |
| User | MailBox-COM => DELETED | 1 | 4 | 0.25 |
| Administrator | Administrator_Interface-AGG => | 1 | 3 | 0.333 |
| | Administrator_Interface-COM | | | |
| Administrator_Interface | — | 0 | — | 0 |
| User_Interface | — | 0 | — | 0 |
| UnregisteredUser_Interface | — | 0 | — | 0 |
| RealEstateOffice | UnavailableProperty-ASO => | 1 | 4 | 0.25 |
| | UnavailableProperty-AGG | | | |
| RealEstateOffice_Interface | — | 0 | — | 0 |

| | |
|---|---|
| SUM | 3.16 |
| Instability | 0.287 |
| Stability | 0.713 |

A Hajj Online Services System (HOSS) application was used in a fifth example, which is an online service of Hajj management. A use-case diagram of the Communication Management Subsystem was used. It has nine use cases and three actors.

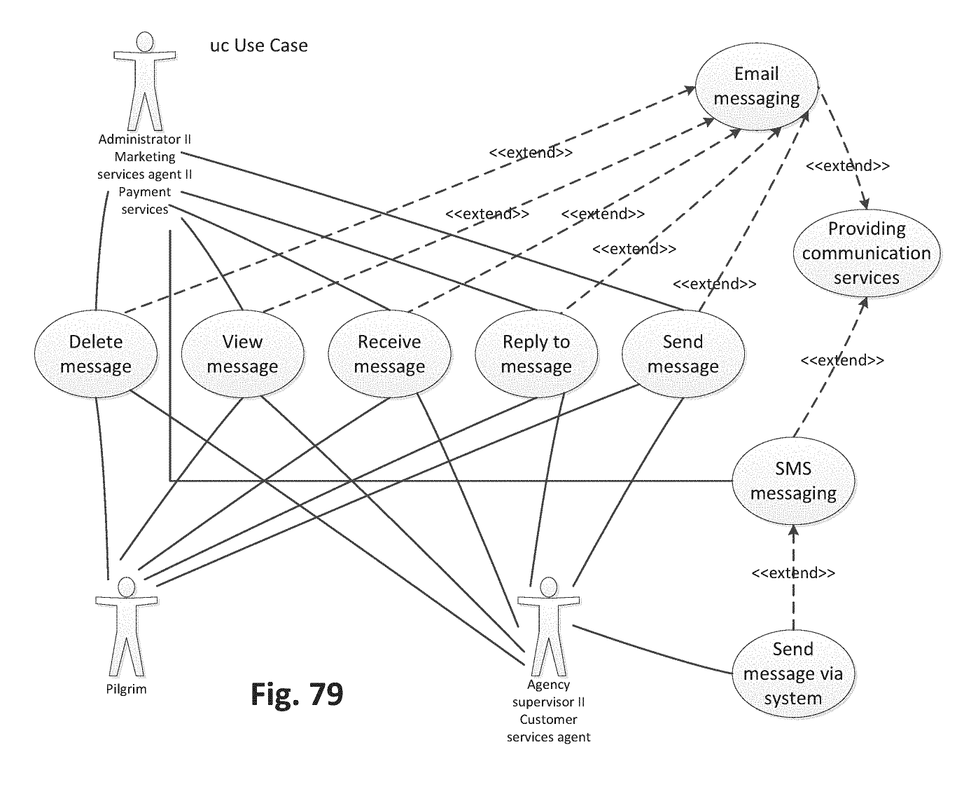

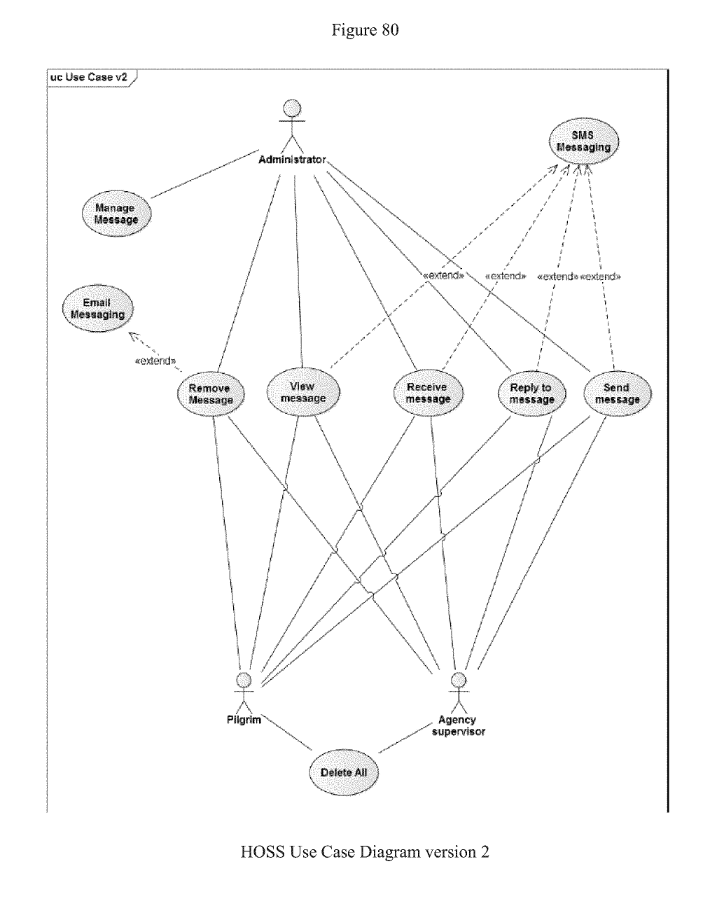

FIG. 79 and FIG. 80 illustrate Retailer use-case diagram version 1 and version 2, respectively. Table 45 illustrates the comparison and Table 46 illustrates the computation results. Fifty-three percent of version 1 of the use-case diagram remains in version 2. The cited figures and tables illustrate the implementation of stability metrics described herein for a use-case diagram, in which actors and actor relationships interface in a HOSS system, which are exemplified in a transformation from a first state to a second state to yield an improved HOSS system.

TABLE 45
HOSS Use Case Diagram Comparison

| | Version 1 | | Version 2 | |
|---|---|---|---|---|
| | Identifier | Identifier | Identifier | Identifier |
| Identifier Name | Type | Relationships | Type | Relationships |
| Administrator | Actor | Delete message-ASO | Actor | — |
| | | View message-ASO | | View message-ASO |
| | | Receive message-ASO | | Receive message-ASO |
| | | Reply to message-ASO | | Reply to message-ASO |
| | | Send message-ASO | | Sead message-ASO |
| | | SMS Messaging-ASO | | — |
| | | — | | Manage messages -ASO |
| | | — | | Remove Message - ASO |
| Delete message | DELETED - Change the name to Remove Message | | | |
| View message | Use Case | Administrator-ASO | Use Case | Administrator-ASO |
| | | Pilgrim-ASO | | Pilgrim-ASO |
| | | Agency supervisor-ASO | | Agency supervisor-ASO |
| | | Email Messaging-EX | | — |
| | | — | | SMS Messaging-EX |
| Receive message | Use Case | Administrator-ASO | Use Case | Administrator-ASO |
| | | Pilgrim-ASO | | Pilgrim-ASO |
| | | Agency supervisor-ASO | | Agency supervisor-ASO |
| | | Email Messaging-EX | | — |
| | | — | | SMS Messaging-EX |
| Reply to message | Use Case | Administrator-ASO | Use Case | Administrator-ASO |
| | | Pilgrim-ASO | | Pilgrim-ASO |
| | | Agency supervisor-ASO | | Agency supervisor-ASO |
| | | Email Messaging-EX | | — |
| | | — | | SMS Messaging-EX |
| Send message | Use Case | Administrator-ASO | Use Case | Administrator-ASO |
| | | Pilgrim-ASO | | Pilgrim-ASO |
| | | Agency supervisor-ASO | | Agency supervisor-ASO |
| | | Email Messaging-EX | | — |
| | | — | | SMS Messaging-EX |
| Pilgrim | Actor | Delete message-ASO | Actor | — |
| | | View message-ASO | | View message-ASO |
| | | Receive message-ASO | | Receive message-ASO |
| | | Reply to message-ASO | | Reply to message-ASO |
| | | Send message-ASO | | Send message-ASO |
| | | — | | Delete All - ASO |
| | | — | | Remove Message - ASO |
| Agency supervisor | Actor | Delete message-ASO | Actor | — |
| | | View message-ASO | | View message-ASO |
| | | Receive message-ASO | | Receive message-ASO |
| | | Reply to message-ASO | | Reply to message-ASO |
| | | Send message-ASO | | Send message-ASO |
| | | Send message via system-ASO | | Send message via system-ASO |
| | | — | | Delete All - ASO |
| | | — | | Remove Message - ASO |
| SMS Messaging | Use Case with | Administrator-ASO | Use Case with | Administrator-ASO |
| | Extension Point | Providing communication | Extension Point | — |
| | | services-EX | | |
| Email Messaging | Use Case with | Providing communication | Use Case with | — |
| | Extension Point | services-EX | Extension Point | |

| | |
|---|---|
| Send message via | DELETED |
| system | |
| Providing | DELETED |
| communication services | |

TABLE 46
HOSS Use Case Diagram Comparison Results

| | | Number Of | Number Of | Changes/ |
|---|---|---|---|---|
| Identifier Name | Changes From version 1 to version 2 | Changes | Unique Pairs | Unique |
| Administrator | Delete message-ASO => DELETED | 4 | 9 | 0.444 |
| | SMS Messaging-ASO => DELETED | | | |
| | Manage messages -ASO => NEW | | | |
| | Remove Message - ASO => NEW | | | |
| Delete message | DELETED | FULL | — | 1 |
| View message | Email Messaging-EX => DELETED | 2 | 6 | 0.333 |
| | SMS Messaging-EX => NEW | | | |
| Receive message | Email Messaging-EX => DELETED | 2 | 6 | 0.333 |
| | SMS Messaging-EX => NEW | | | |
| Reply to message | Email Messaging-EX => DELETED | 2 | 6 | 0.333 |
| | SMS Messaging-EX => NEW | | | |
| Send message | Email Messaging-EX => DELETED | 2 | 6 | 0.333 |
| | SMS Messaging-EX => NEW | | | |
| Pilgrim | Delete message-ASO => DELETED | 3 | 8 | 0.375 |
| | Delete All - ASO => NEW | | | |
| | Remove Message - ASO => NEW | | | |
| Agency supervisor | Delete message-ASO => DELETED | 3 | 9 | 0.333 |
| | Delete All - ASO => NEW | | | |
| | Remove Message - ASO => NEW | | | |
| SMS Messaging | Providing communication | 1 | 3 | 0 |
| | services-EX => DELETED | | | |
| Email Messaging | Providing communication | 1 | 2 | 0.5 |
| | services-EX => DELETED | | | |
| Send message | DELETED | FULL | — | 1 |
| via system | | | | |
| Providing | DELETED | FULL | — | 1 |
| communication services | | | | |

| | |
|---|---|
| SUM | 5.541 |
| Instability | 0.462 |
| Stability | 0.538 |

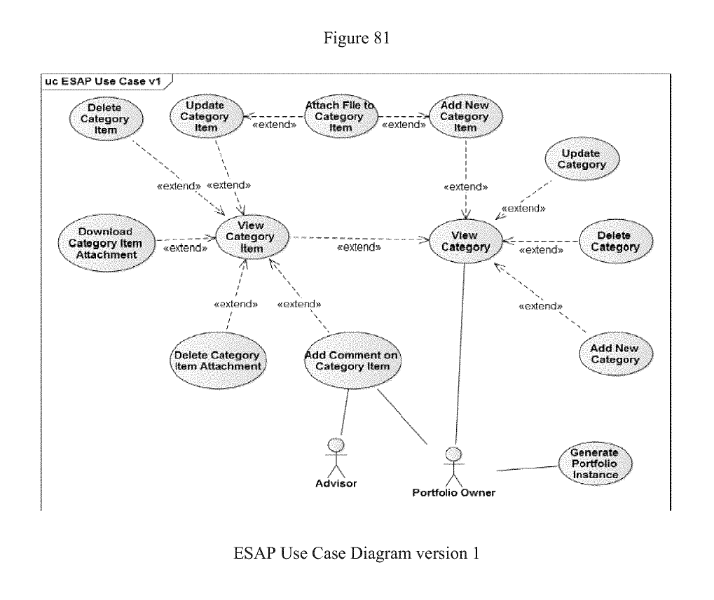

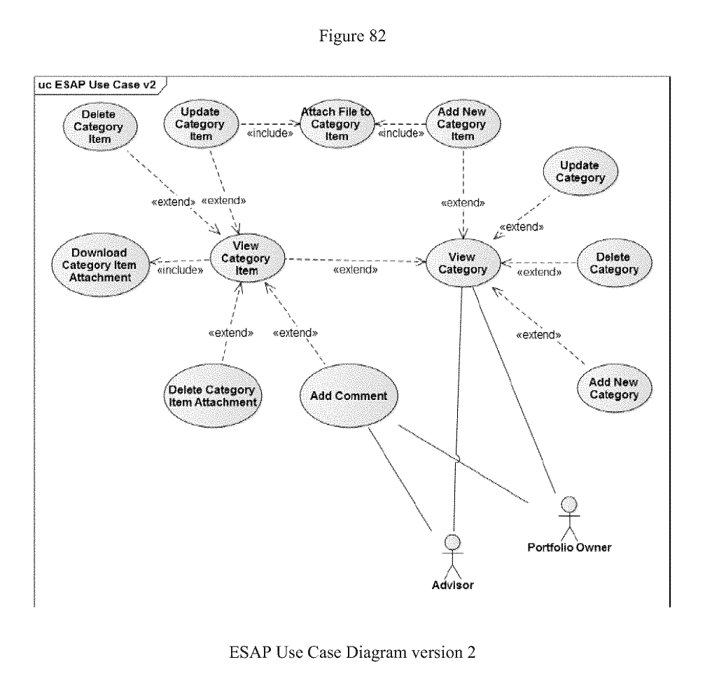

Electronic Students' Academic Portfolio (ESAP) was used in a sixth example, which is an application used to work more efficiently with less paper work. An existing use-case diagram was used, which has thirteen use cases and two actors. FIG. 81 and FIG. 82 illustrate Retailer use-case diagram version 1 and version 2, respectively. Table 47 illustrates the comparison and Table 48 illustrates the computation results. Sixty-one percent of version 1 of the use-case diagram remains in version 2. The cited figures and tables illustrate the implementation of stability metrics described herein for a use-case diagram, in which actors and actor relationships interface in an ESAP system, which are exemplified in a transformation from a first state to a second state to yield an improved ESAP system.

TABLE 47
ESAP Use Case Diagram Comparison

| | Version 1 | | Version 2 | |
|---|---|---|---|---|
| | Identifier | Identifier | Identifier | Identifier |
| Identifier Name | Type | Relationships | Type | Relationships |
| Delete Category Item | Use Case | View Category Item - EX | Use Case | View Category Item - EX |
| Update Category Item | Use Case with | View Category Item - EX | Use Case | View Category Item - EX |
| | Extension Point | — | | Attach File to Category Item - |
| | | | | INC |
| Attach File to Category | Use Case | Update Category Item - EX | Use Case | — |
| Item | | Add New Category Item - EX | | — |
| Add New Category Item | Use Case with | View Category - EX | Use Case | View Category - EX |
| | Extension Point | — | | Attach File to Category Item - |
| | | | | INC |
| Download Category | Use Case | View Category Item - EX | Use Case | — |
| Item Attachment | | | | |
| View Category Item | Use Case with | View Category - EX | Use Case with | View Category - EX |
| | Extension Point | — | Extension Point | Download Category Item |
| | | | | Attachment - INC |
| View Category | Use Case with | Portfolio Owner - ASO | Use Case with | Portfolio Owner - ASO |
| | Extension Point | — | Extension Point | Advisor - ASO |
| Update Category | Use Case | View Category - EX | Use Case | View Category - EX |
| Delete Category | Use Case | View Category - EX | Use Case | View Category - EX |
| Delete Category Item | Use Case | View Category Item - EX | Use Case | View Category Item - EX |
| Attachment | | | | |
| Add Comment on | DELETED - Change the name to Add Comment | | | |
| Category Item | | | | |
| Add New Category | Use Case | View Category Item - EX | Use Case | View Category Item - EX |
| Generate Portfolio | DELETED | | | |
| Instance | | | | |
| Advisor | Actor | Add Comment on Category | Actor | — |
| | | Item - EX | | |
| | | — | | View Category - ASO |
| | | — | | Add Comment - ASO |
| Portfolio Owner | Actor | Add Comment on Category | Actor | — |
| | | Item - EX | | |
| | | View Category - EX | | View Category - EX |
| | | Generate Portfolio Instance - | | — |
| | | EX | | |
| | | — | | Add Comment - ASO |

TABLE 48
ESAP Use Case Diagram Comparison Results

| | | Number Of | Number Of | Changes/ |
|---|---|---|---|---|
| Identifier Name | Changes From version 1 to version 2 | Changes | Unique Pairs | Unique |
| Delete Category Item | — | 0 | — | 0 |
| Update Category Item | Attach File to Category Item - INC => NEW | 1 | 3 | 0.333 |
| Attach File to Category Item | Update Category Item - EX => DELETED | 2 | 3 | 0.666 |
| | Add New Category Item - EX => DELETED | | | |
| Add New Category Item | Attach File to Category Item - INC => NEW | 1 | 3 | 0.333 |
| Download Category Item | View Category Item - EX => DELETED | 1 | 2 | 0.5 |
| Attachment | | | | |
| View Category Item | Download Category Item Attachment - INC => NEW | 1 | 3 | 0.333 |
| View Category | Advisor - ASO => NEW | 1 | 3 | 0.333 |
| Update Category | — | 0 | — | 0 |
| Delete Category | — | 0 | — | 0 |
| Delete Category Item | — | 0 | — | 0 |
| Attachment | | | | |
| Add Comment on Category Item | DELETED | FULL | — | 1 |
| Add New Category | — | 0 | — | 0 |
| Generate Portfolio Instance | DELETED | FULL | — | 1 |
| Advisor | Add Comment on Category Item - EX => DELETED | 3 | 4 | 0.75 |
| | View Category - ASO => NEW | | | |
| | Add Comment - EX => NEW | | | |
| Portfolio Owner | Add Comment on Category Item - EX => DELETED | 3 | 5 | 0.6 |
| | Generate Portfolio Instance - EX => DELETED | | | |
| | Add Comment - EX => NEW | | | |

| | |
|---|---|
| SUM | 5.85 |
| Instability | 0.39 |
| Stability | 0.61 |

Embodiments herein describe a suite of metrics that measures the stability of UML class diagrams, UML use-case diagrams, and U-ML sequence diagrams. A comprehensive survey was conducted of existing stability metrics, and results illustrate that UML diagrams were not considered. The existing stability metrics target the source code, and few of them have been validated theoretically.

The research methodology for embodiments described herein started with UML diagram analysis. All UML diagram elements were identified, and a set of them was selected to compute their unchanged values. The selection of these elements was based on those elements that are not optional, and a consideration that the elements need to serve the meaning of the UML diagram. An identifier was selected to compare UML diagram versions. The identifier contained the minimum information that can be used to recognize the corresponding partner in the next UML diagram version so that a correct comparison could be made.

Embodiments were given herein to illustrate advantages and applications of forming a metric for measuring stability when changing from one UML diagram version to another UML diagram version. However, embodiments described herein are not restricted to UML applications, wherein embodiments can be implemented in other modeling languages. In addition, embodiments described herein can be used to measure stability in transitioning from one state to another state. In particular, embodiments described herein can be used to measure stability at a model level in transitioning from one state to another state. Advantages include evaluating and measuring stability at a front-end of a process, i.e. at a model level, as opposed to evaluating and measuring stability at a back-end of the process, i.e. at a source code level. Determining a lack of stability at the front-end of the process avoids unnecessary source code programming at the back-end of the process.

UML diagrams have multiple relationships. Therefore, a client master approach was used to avoid counting the changes more than once. The client master approach was used to determine which side of the relationship was the client and which side was the master. The changes in the relationship were counted as being on the client side. All possible changes that might occur to any selected element were checked in each UML diagram.

The proposed stability metrics suite was implemented to compute the unchanged properties in each UML diagram. The metrics included the structural stability (SS) metric to measure UML class diagrams, the functional stability (FS) metric to measure UML use-case diagrams, and the behavioral stability (BS) metric to measure UML sequence diagrams.

The proposed stability metrics were applied on six different examples, which included Automated Teller Machine (ATM), Supply Chain Management (SCM), On Road Assistance (ORA), Online Real Estate Directory (O-RED), Hajj Online Services System (HOSS), and Electronic Students' Academic Portfolio (ESAP).

An advantage of embodiments herein include software stability metrics assessed at a model level for the UML class diagram, UML use-case diagram, and UML sequence diagram, rather than at a source code level. These three diagrams represent the most common diagrams in the structural UML view, the functional UML view, and the behavioral UML view. However, other structural, functional, and behavioral diagrams can be used with embodiments described herein, including UML diagrams and diagrams in other modelling languages. In addition, an assessment approach called the client master approach provides a mechanism to skip duplication. An assessment methodology used for tracking changes included analyzing each UML diagram, applying the client master approach, and obtaining the change possibilities. Based on the assessment process, a stability metric suite was obtained for the UML class diagram, the UML use-case diagram, and the UML sequence diagram. The advantages of stability metrics described herein can be applied to UML diagrams, as well as diagrams in other modelling languages.

Embodiments described herein could apply UML sequence diagram fragments and constrains, in addition to the elements described herein. Embodiments can also be applied to a maintenance process in which the stability metrics are correlated with the maintenance process.

Elements that were renamed were treated as deleted elements in the methodology used herein. In an alternative embodiment, they could be considered without counting them as fully changed.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative, but not limiting of the scope of the disclosure, including the claims. The disclosure, including any readily discernible variants of the teachings herein, defines in part, the scope of the foregoing claim terminology such that no inventive subject matter is dedicated to the public.

1. A method of computing a structural model stability metric, the method comprising:
obtaining, using circuitry, a first state of a class diagram including a first plurality of classifiers and a second state of the class diagram including a second plurality of classifiers;
identifying, using said circuitry, one or more classifier type properties and one or more relationship properties for the first state of the class diagram and the second state of the class diagram;
tracking, using said circuitry, a transformation in the one or more classifier type properties from the first state of the class diagram to the second state of the class diagram;
tracking, using said circuitry, a transformation in the one or more relationship properties from the first state of the class diagram to the second state of the class diagram; and
calculating, using said circuitry, the structural model stability metric for the second state of the class diagram as a ratio of a percentage of unchanged classifier type properties from the first state to the second state plus a percentage of unchanged relationship properties from the first state to the second state to a total number of the first plurality of classifiers in the first state of the class diagram.

2. The method of claim 1, wherein the identifying the one or more relationship properties includes identifying a dependency relationship when a client classifier depends upon a master classifier, and a change to the master classifier causes a change to the client classifier.

3. The method of claim 1, wherein the identifying the one or more relationship properties includes identifying an association relationship when one or more objects within a first classifier depend upon one or more objects of a second classifier and when the one or more objects within the second classifier depend upon the one or more objects of the first classifier, and the first classifier and the second classifier are both a client classifier and a master classifier at a same time.

4. The method of claim 1, wherein the identifying the one or more relationship properties includes identifying an aggregation relationship when a client classifier aggregates an object from a master classifier, and a change to the client classifier does not cause a change to the master classifier.

5. The method of claim 1, wherein the identifying the one or more relationship properties includes identifying a composition relationship when a first classifier aggregates an object of a second classifier and when the object of the second classifier cannot be aggregated by another classifier, and the first classifier and the second classifier are both a client classifier and a master classifier at the same time.

6. The method of claim 1, wherein the identifying the one or more relationship properties includes identifying an inheritance relationship when a client sub-classifier is a type of a master super-classifier, and a change to the master super-classifier causes a change to the client sub-classifier.

7. The method of claim 1, wherein the identifying the one or more relationship properties includes identifying a realization relationship when a client classifier realizes an object of a master classifier, and a change to the client classifier does not cause a change to the master classifier.

8. The method of claim 1, further comprising:
assigning a master role and a client role to each of the first plurality of classifiers; and
tracking, using said circuitry, a change to the client role for each of the first plurality of classifiers from the first state of the class diagram to the second state of the class diagram, wherein the master role does not change when the client role changes, and the client role changes when the master role changes.

9. The method of claim 1, further comprising:
transforming the second state of the class diagram from a model level to a source code level.

10. A method of computing a functional model stability metric, the method comprising:
obtaining, using circuitry, a first state of a use-case diagram including a first plurality of use cases and a first plurality of actors;
obtaining, using said circuitry, a second state of the use-case diagram including a second plurality of use cases and a second plurality of actors;
identifying, using said circuitry, one or more use-case properties for the first state of the use-case diagram and the second state of the use-case diagram;
identifying, using said circuitry, one or more actor relationships for the first state of the use-case diagram and the second state of the use-case diagram;
tracking, using said circuitry, a transformation in the one or more use-case properties from the first state of the use-case diagram to the second state of the use-case diagram;
tracking, using said circuitry, a transformation in the one or more actor relationships from the first state of the use-case diagram to the second state of the use-case diagram;
calculating, using said circuitry, a total number of unchanged use-case properties based on the transformation in the one or more use-case properties from the first state of the use-case diagram to the second state of the use-case diagram;
calculating, using said circuitry, a total number of unchanged actor relationships based on the transformation in the one or more actor relationships from the first state of the use-case diagram to the second state of the use-case diagram;
calculating, using said circuitry, a percentage of unchanged use-case properties based on the total number of unchanged use-case properties and a total number of the use-case properties;
calculating, using said circuitry, a percentage of unchanged actor relationships based on the total number of unchanged actor relationships and a total number of the actor relationships; and
calculating, using said circuitry, the functional model stability metric for the second state of the use-case diagram as a ratio of the percentage of unchanged use-case properties from the first state to the second state plus the percentage of unchanged actor relationships from the first state to the second state to a total number of the first plurality of use cases plus a total number of the first plurality of actors in the first state of the use-case diagram.

11. The method of claim 10, wherein the identifying the one or more relationship properties includes identifying a generalization relationship when a client use case is a specialization of a master use case, and the client use case uses the master use case and a change to the master use case causes a change to the client use case.

12. The method of claim 10, wherein the identifying the one or more relationship properties includes identifying an include relationship when a master use case object is inserted into a client use case, and the master use case can be accessed without a need for the client use case.

13. The method of claim 10, wherein the identifying the one or more relationship properties includes identifying an extend relationship when a function is extended from a first use case to a second use case, and the first use case and the second use case are client use cases and a change to one of the first use case or the second use case affects another of the first use case or the second use case.

14. The method of claim 10, wherein the tracking the transformation in the one or more use-case properties and the tracking the transformation in the one or more actor relationships are implemented via tracking changes to a client role of the first plurality of use cases and a client role of the first plurality of actors, respectively, from the first state of the use-case diagram to the second state of the use-case diagram, and a change to one of the master roles causes a change to a respective client role.

15. The method of claim 10, further comprising: transforming the second state of the use-case diagram from a model level to a source code level.

16. A method of computing a behavioral model stability metric, the method comprising:
obtaining, using circuitry, a first state of a sequence diagram including a first plurality of message participants and a second state of the sequence diagram including a second plurality of message participants;
identifying, using said circuitry, one or more message properties for the first state of the sequence diagram and the second state of the sequence diagram;
tracking, using said circuitry, a transformation in the one or more message properties for a message type, a message order, and a message caller from the first state of the sequence diagram to the second state of the sequence diagram;
calculating, using said circuitry, a total number of unchanged message properties for the message type, the message order, and the message caller from the first state of the sequence diagram to the second state of the sequence diagram;
calculating, using said circuitry, a combined percentage of unchanged message properties as a ratio of the total number of unchanged message properties per a total number of the message properties from the first state of the sequence diagram to the second state of the sequence diagram, and
calculating, using said circuitry, the behavioral model stability metric for the second state of the sequence diagram as a ratio of the combined percentage of unchanged message properties from the first state to the second state to a total number of the first plurality of message participants in the first state of the sequence diagram.

17. The method of claim 16, wherein the identifying the one or more message properties includes identifying a synchronous message when a client message participant sends a message to a master message participant and waits for a return message invocation from the master message participant, and a change to the master message participant causes a change to the client message participant.

18. The method of claim 16, wherein the identifying the one or more message properties includes identifying an asynchronous message when a client message participant sends a message to a master message participant and does not wait for a return message invocation from the master message participant, and a change to the client message participant does not cause a change to the master message participant.

19. The method of claim 16, wherein the tracking a transformation in the message property is implemented via tracking a change to a client role of the first plurality of message participants from the first state of the sequence diagram to the second state of the sequence diagram, and a change to a master role of the first plurality of message participants does not cause a change to the client role, and the client role of the first plurality of message participants changes when the master role changes.

20. The method of claim 16, further comprising:
transforming the second state of the sequence diagram from a model level to a source code level.
